(19) United States
(12) Patent Application Publication
(10) Pub. No.: US 2017/0200357 A1
(43) Pub. Date: Jul. 13, 2017

(54) THEFT DETERRENT TAG

(71) Applicant: USS Technologies, LLC, Rancho Cucamonga, CA (US)

(72) Inventors: Adel Sayegh, Rancho Cucamonga, CA (US); Marc Trincale, Rancho Cucamonga, CA (US); Alejandro Molina, Rancho Cucamonga, CA (US); Michael Sayegh, Rancho Cucamonga, CA (US)

(21) Appl. No.: 15/404,150

(22) Filed: Jan. 11, 2017

Related U.S. Application Data
(60) Provisional application No. 62/277,268, filed on Jan. 11, 2016.

(51) Int. Cl. G08B 13/24

(52) U.S. Cl. CPC G08B 13/2434

(57) ABSTRACT

The present invention discloses a theft-deterrent tag, comprising a cover assembly that is mechanically moved from open, unlocked position to a closed position in relation to a lock mechanism assembly without use of tools, with the cover assembly locked with the lock mechanism assembly at an adjustable holding force or pressure.

### CROSS-REFERENCE TO RELATED APPLICATIONS

This Application claims the benefit of priority of co-pending U.S. Utility Provisional Patent Application 62/277,268, filed Jan. 11, 2016, the entire disclosure of which is expressly incorporated by reference in its entirety herein.

All documents mentioned in this specification are herein incorporated by reference to the same extent as if each individual document was specifically and individually indicated to be incorporated by reference.

It should be noted that throughout the disclosure, where a definition or use of a term in any incorporated document(s) is inconsistent or contrary to the definition of that term provided herein, the definition of that term provided herein applies and the definition of that term in the incorporated document(s) does not apply.

### BACKGROUND OF THE INVENTION

Field of the Invention

One or more embodiments of the invention relate to theft deterrent tags and, more particularly, a theft deterrent tag with form-factor adapted for protection of small, fragile (or delicate) merchandise.

Description of Related Art

Conventional theft deterrent tags are well known and have been in use for a number of years. Regrettably, most conventional theft deterrent tags are bulky, which makes it inconvenient (if not difficult) to “try-on” a wearable article with a mounted tag such as a pair of glasses.

Further, most conventional theft deterrent tags do not provide “benefit-denial” protection mechanism. Lack of benefit-denial mechanism in conventional theft deterrent tags means that the article cannot be damaged if the theft deterrent tag is tampered and article removed. In other words, unauthorized removal of the theft deterrent tag from the article would not cause any damage to the article and therefore, such tampering would not deny would be thief the benefit of an undamaged article. Benefit-denial mechanisms incorporated in theft deterrent tags would damage the article if theft deterrent tag was tampered and hence, denying would be thief the benefit of having an undamaged article.

Additionally, most conventional theft deterrent tags require a dedicated tool to engage and disengage an article to be protected. In particular, the use of tool to engage the theft deterrent tag with an article is labor intensive and may also damage the article due to operator error (e.g., exerting too much pressure on the tools to secure the theft deterrent tags onto the article).

Further, most conventional theft deterrent tags are not adjustable to a desired hold pressure to accommodate different sized or shaped articles (for example, eyewear). Although some conventional theft deterrent tags use lanyards that allow for adjustability, the lanyards may easily be severed and the article removed.

Other conventional theft deterrent tags do not incorporate technologies for enhanced protection such as Electronic Article Surveillance (EAS) systems or Radio Frequency Identification (RFID) electronics. This is particularly true for wearable article such as eyewear where the weight of the battery and the electronics within the theft deterrent tag may give the “feeling” that the article itself is heavy on one side (the side at which the tag is mounted on the article). This would negatively affect the “try-on” experience of a potential customer.

Accordingly, in light of the current state of the art and the drawbacks to current theft deterrent tags mentioned above, a need exists for theft deterrent tag that would have a small profile, would not require a tool for engagement with an article, would be adjustable to a desired hold pressure, and would incorporate electronic technologies for enhanced protection, all without affecting the try-on experience of article by users. Further, a need exists for theft deterrent tag that would optionally provide a benefit denial mechanism.

### BRIEF SUMMARY OF THE INVENTION

A non-limiting, exemplary aspect of an embodiment of the present invention provides a surveillance system, comprising:

a cover assembly that is mechanically moved from open, unlocked position to a closed position in relation to a lock mechanism assembly without use of tools, with the cover assembly locked with the lock mechanism assembly at an adjustable holding force or pressure.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1 to 5M are non-limiting, exemplary illustration of a theft deterrent tag and parts thereof in accordance with one or more embodiments of the present invention;

FIGS. 6A to 6C are non-limiting, exemplary illustration of another embodiment of a theft deterrent tag and parts thereof in accordance with one or more embodiments of the present invention;

FIGS. 7A to 7N are non-limiting, exemplary illustration of yet another embodiment of a theft deterrent tag and parts thereof in accordance with one or more embodiments of the present invention;

FIGS. 8A to 8V are non-limiting, exemplary illustration of still another embodiment of a theft deterrent tag and parts thereof in accordance with one or more embodiments of the present invention; and

FIGS. 9A to 16E are non-limiting, exemplary illustration of another embodiment of a theft deterrent tag and parts thereof in accordance with one or more embodiments of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is to be appreciated that certain features of the invention, which are, for clarity, described in the context of separate embodiments, may also be provided in combination in a single embodiment. Conversely, various features of the invention that are, for brevity, described in the context of a single embodiment may also be provided separately or in any suitable sub-combination or as suitable in any other described embodiment of the invention. Stated otherwise, although the invention is described below in terms of various exemplary embodiments and implementations, it should be understood that the various features and aspects described in one or more of the individual embodiments are not limited in their applicability to the particular embodiment with which they are described, but instead can be applied, alone or in various combinations, to one or more of the other embodiments of the invention.

One or more embodiments of the present invention provide a theft deterrent tag that has a small profile, does not require tool for engagement with an article, is adjustable to be mounted onto most types of articles (e.g., different eyewear sizes and shapes) to a desired holding force (or hold pressure), and incorporates electronic technologies for enhanced protection, but without affecting the try-on experience of article by users. Further, one or more embodiments of the present invention provide a theft deterrent tag that provides a benefit denial mechanism.

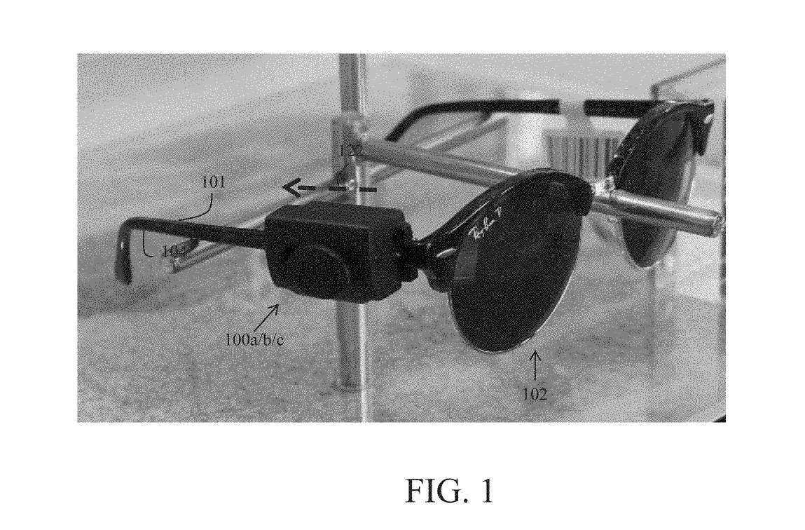

FIG. 1 is non-limiting, exemplary illustrations of theft deterrent tag mounted on an article in accordance with one or more embodiments of the present invention. As illustrated in FIG. 1, theft-deterrent tag 100a has a small, compact form and may easily be connected to a template 104 of an eyewear 102 so that eyewear 102 may be tried-on by users with comfort and without theft-deterrent tag 100a interfering with the try-on experience while eyewear 102 continues to be protected against theft.

In the non-limiting, exemplary embodiments illustrated in FIGS. 1 to 7N theft-deterrent tags 100a, 100b, and 100c are properly mounted onto a right template 104 of eyewear 102 with cover assembly 106 positioned between interior facing side 101 of right template 104 (as illustrated) and the user head profile (not shown) so that eyewear 102 may be tried-on by users with comfort while being protected against theft. When mounting any one of the theft deterrent tags 100a, 100b, and 100c, their respective hinge mechanism 126 is oriented down for ease of mounting.

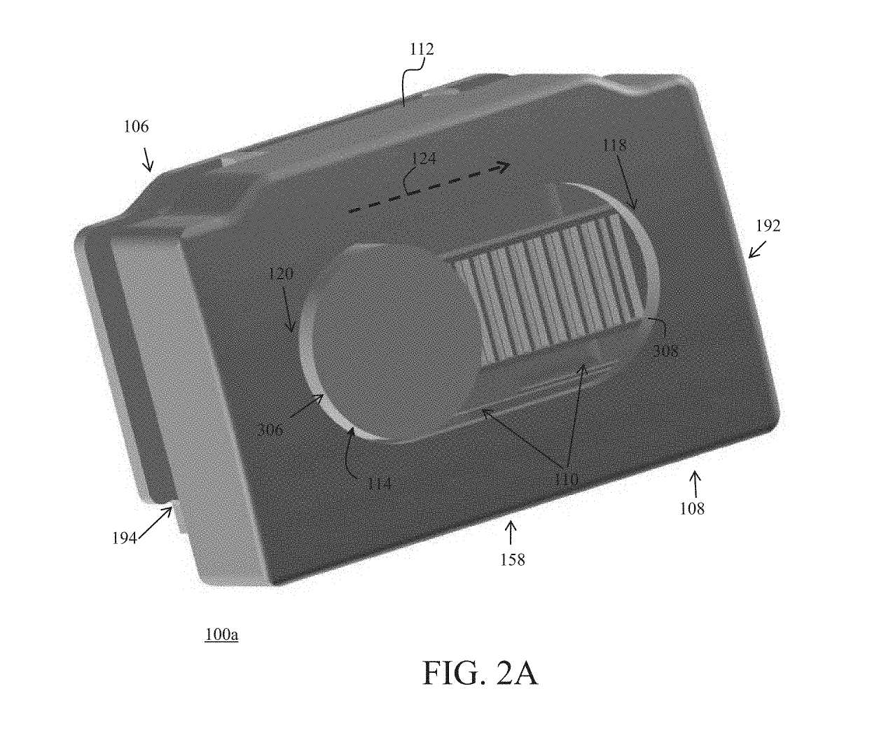

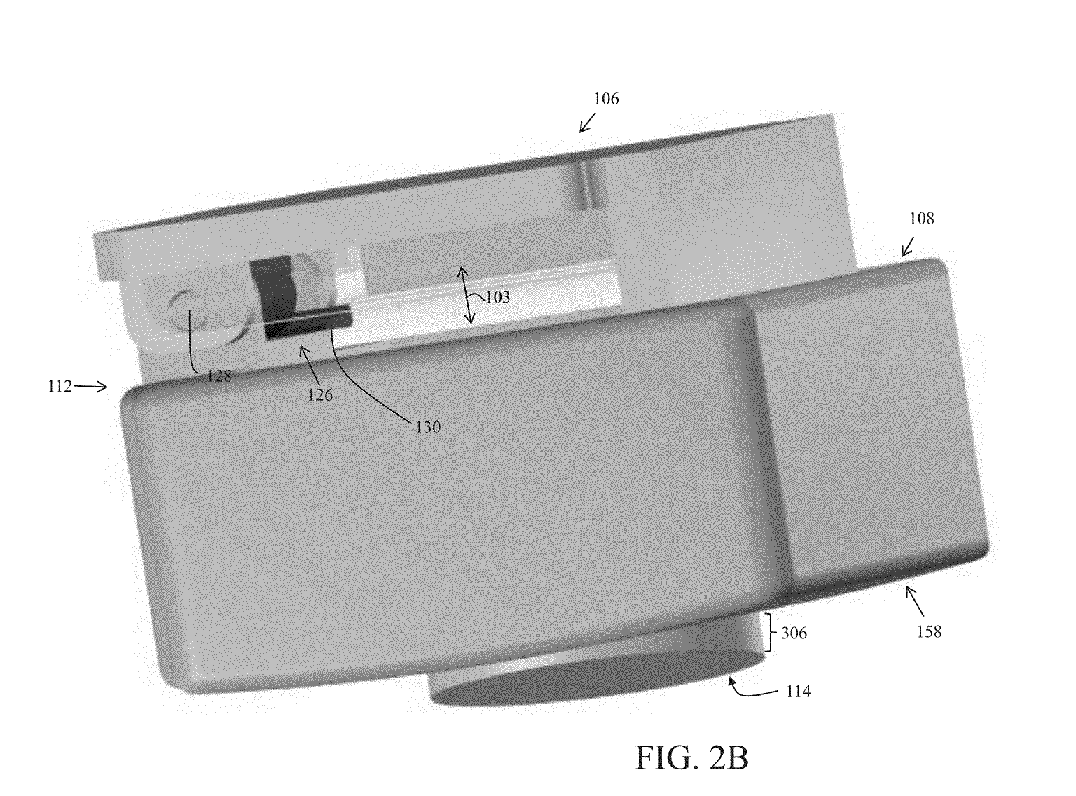

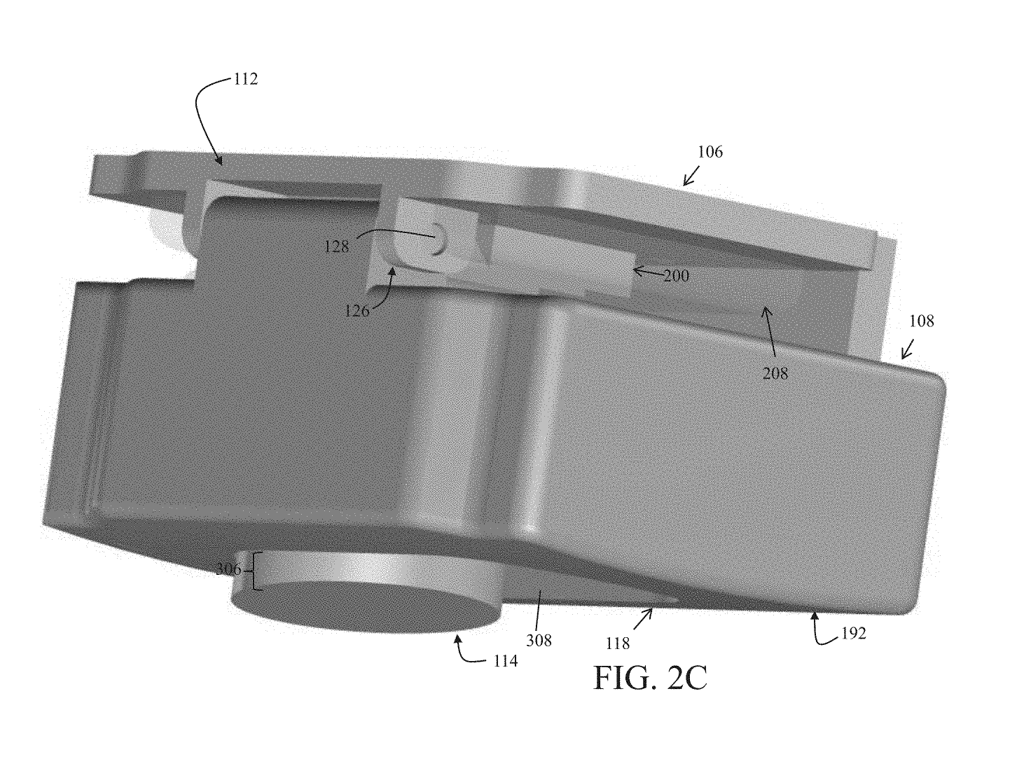

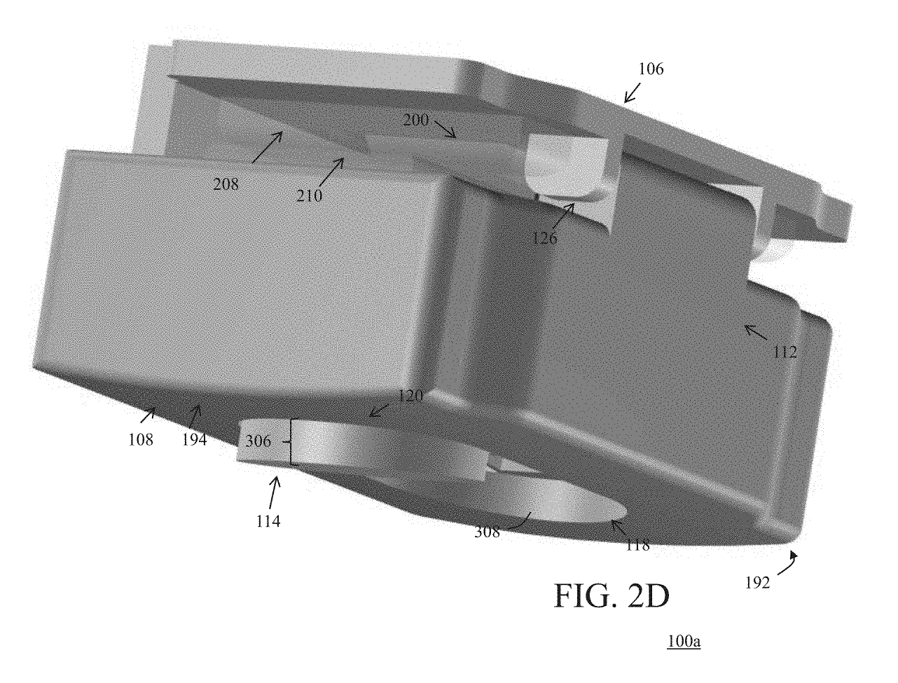

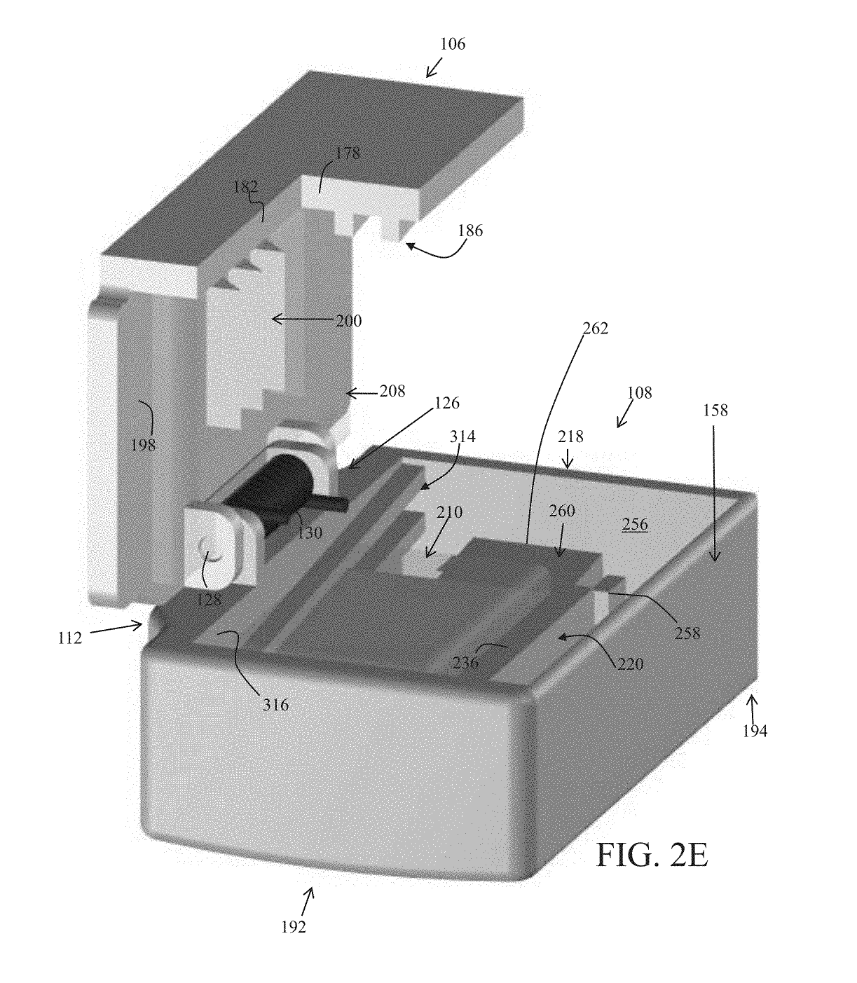

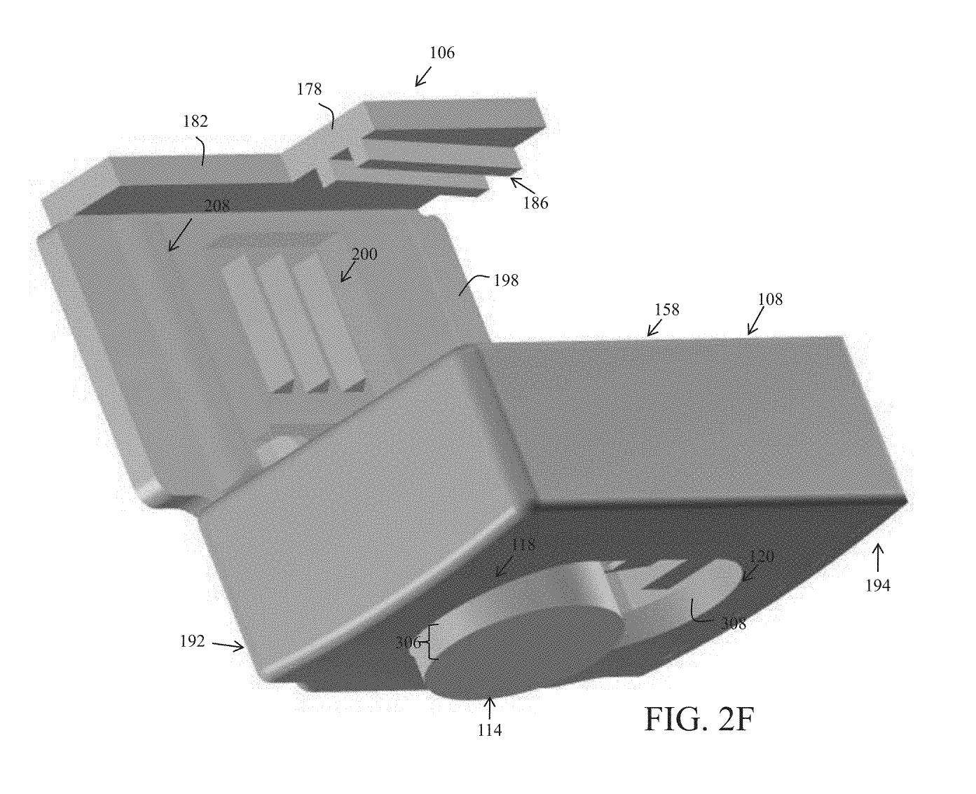

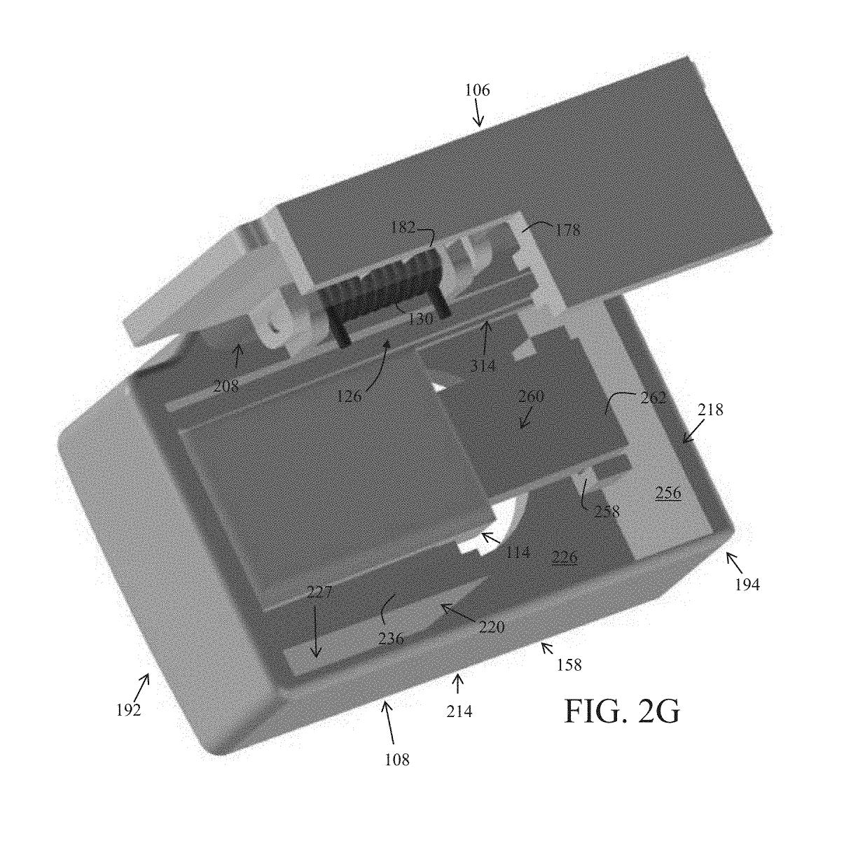

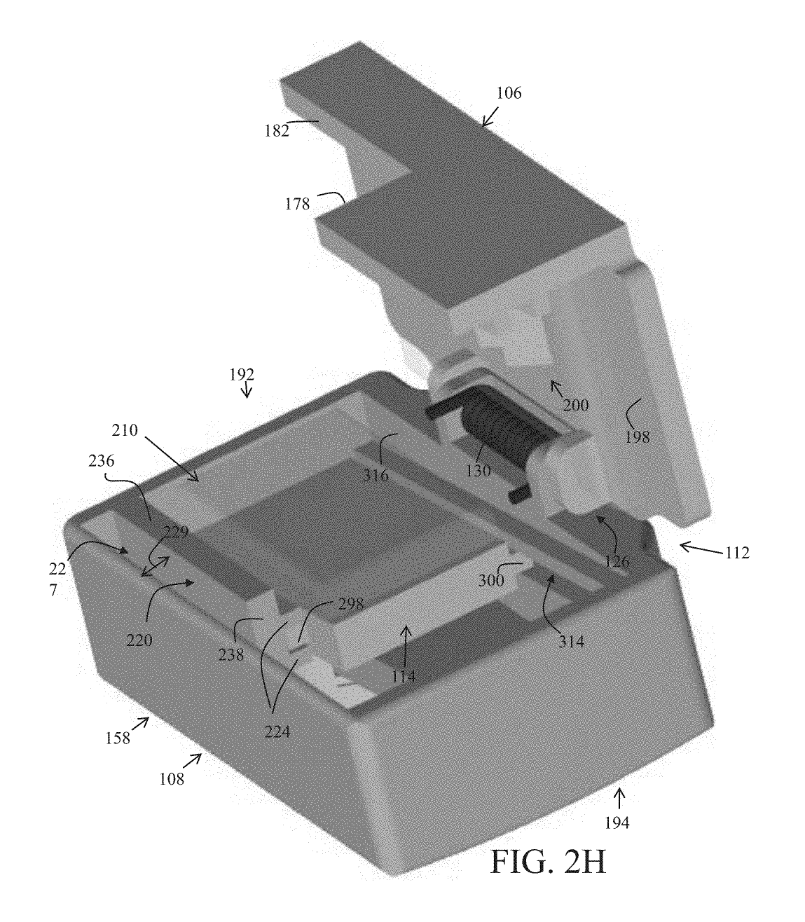

FIGS. 2A to 2J are non-limiting, exemplary illustrations of the various perspective views of the theft deterrent tag shown in FIG. 1 in both closed and open positions, but without the eyewear. FIGS. 2A to 2D are non-limiting, exemplary illustrations of the various perspective views of the theft-deterrent tag of FIG. 1 in a closed, locked position in accordance with one or more embodiments of the present invention. FIGS. 2E to 2J are non-limiting, exemplary illustrations of the various perspective views of the theft-deterrent tag of FIGS. 1 to 2D in an open, unlocked position in accordance with one or more embodiments of the present invention.

Theft-deterrent tag 100a is comprised of a cover assembly 106 that is mechanically moved from open, unlocked position (FIGS. 2E to 2J) to a closed, locked position (FIGS. 2A to 2D) in relation to a lock mechanism assembly 108 without use of tools, with cover assembly 106 locked with lock mechanism assembly 108 at an adjustable (or simply desired or selected) holding force by a lock assembly 110.

Once locked, cover assembly 106 may be mechanically unlocked from lock mechanism assembly 108 to an open position using a key (e.g., a well known magnetic detacher). It should be noted that cover assembly 106 is continuously engaged with lock mechanism assembly 108 at a first side (hinge side) 112 of tag 100a at open, closed, and locked positions. Accordingly, while theft deterrent tag 100a is in the open, unlocked position ((FIGS. 2E to 2J), template 104 of eyewear 102 may be positioned in between cover assembly 106 and lock mechanism assembly 108 of theft deterrent tag 100a as shown in FIG. 1. Thereafter, cover assembly 106 may be locked with lock mechanism assembly 108 (detailed below) at a desired holding force (or hold pressure) to secure theft deterrent tag 100a onto article 102.

As illustrated in FIGS. 2A and 2J, cover assembly 106 is locked with lock mechanism assembly 108 at the closed position when a slider mechanism 114 of lock assembly 110 is moved (as shown by arrow 116 in FIG. 2J) from an unlock position 118 from an unlock side 192 of tag 100a (FIG. 2J) to a lock position 120 (FIG. 2A) of a desired holding force at a lock side 194 of tag 100a. Desired holding force places a generally commensurate holding pressure on article 102 positioned in between cover assembly 106 and lock mechanism assembly 108.

A forced removal of article 102 from theft deterrent tag 100a by gripping eyewear 102 to pull out template 104 from in between cover assembly 106 and lock mechanism assembly 108 in direction 122 shown in FIG. 1 would move slider mechanism 114 of lock assembly 110 further towards lock position 120 of a greater holding force, which, in turn, would place a generally commensurate greater holding pressure on article 102 (or template 104) positioned in between cover assembly 106 and lock mechanism assembly 108. The holding force and the generally corresponding holding pressure increase as sliding mechanism 114 of lock assembly 110 is continuously moved from unlock position 118 to lock position 120. In other words, the holding force is maintained and is increased as sliding mechanism 114 of lock assembly 110 is continuously moved in one direction 116 from unlock position 118 to lock position 120, with the holding force released by a well known key (a magnetic detacher—not shown).

As detailed below, cover assembly 106 is locked with lock mechanism assembly 108 at the closed position when slider mechanism 114 of lock assembly 110 is moved in a first direction 116 (FIG. 2J) from unlock position 118 to lock position 120 of the selected holding force, but cannot be moved back in a second direction 124 (FIG. 2A), opposite first direction 116. A key (e.g., well known magnetic detacher) must be used (brought near slider mechanism 114) to free lock assembly 110 to allow slider mechanism 114 to move in second direction 124, from lock position 120 to unlock position 118, releases the holding force.

FIG. 2K is a non-limiting, exemplary illustration of the isometric exploded view of the theft-deterrent tag of FIGS. 1 to 2J in accordance with one or more embodiments of the present invention. The exploded view shown in FIG. 2K illustrates disassembled, separated components that show the cooperative working relationship, orientation, positioning, and an exemplary manner of assembly of the various components of the theft deterrent tag 100a in accordance with one or more embodiments of the present invention, with each component detailed below.

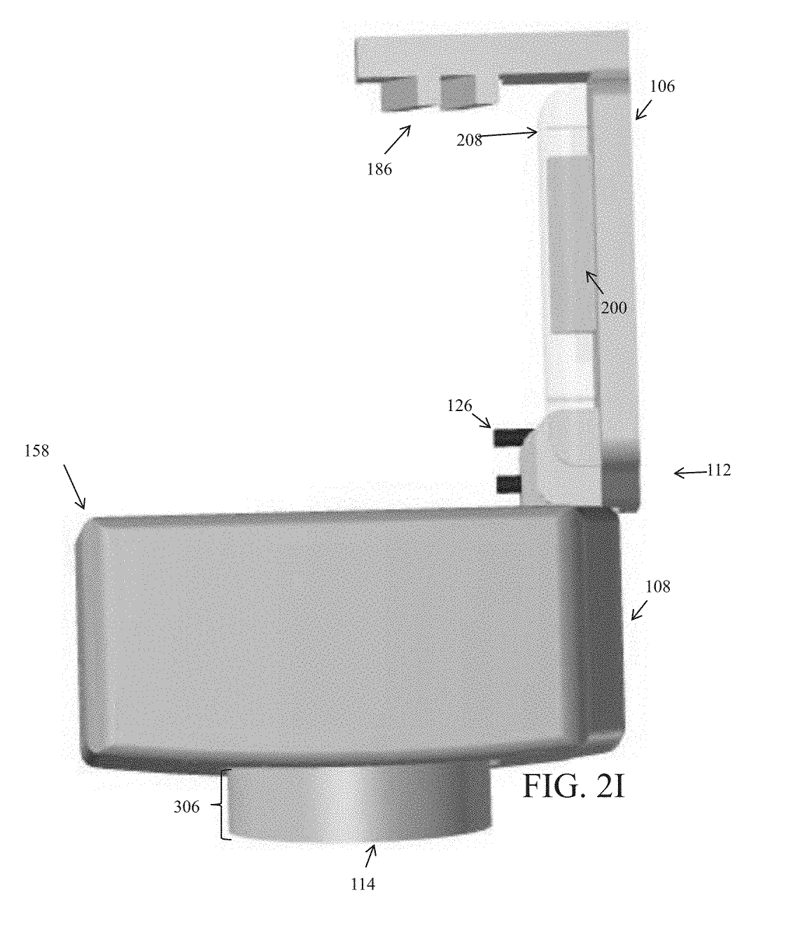

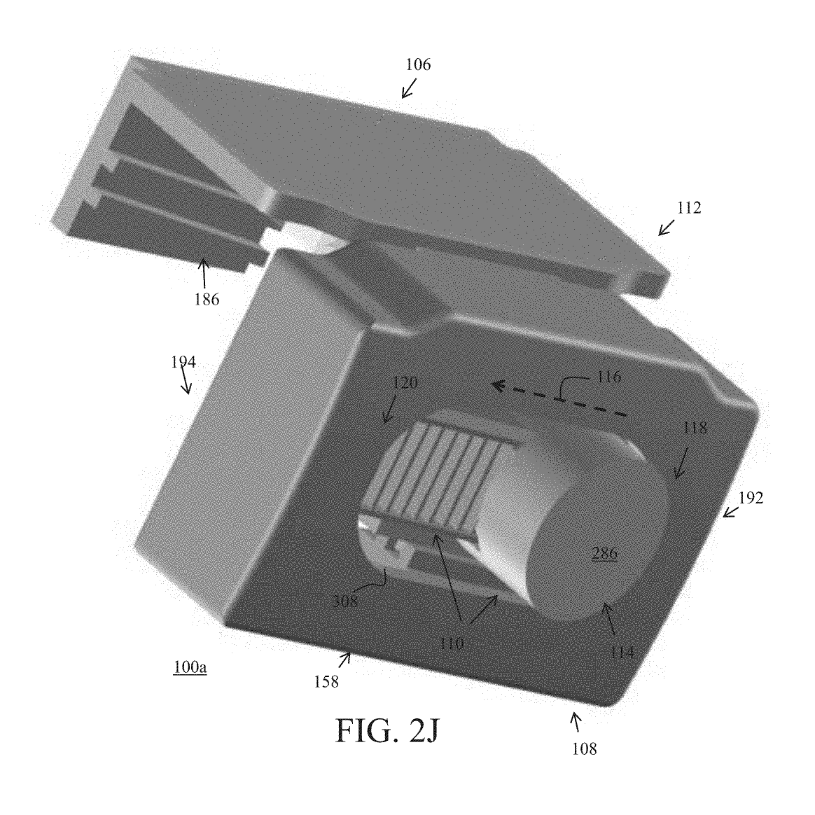

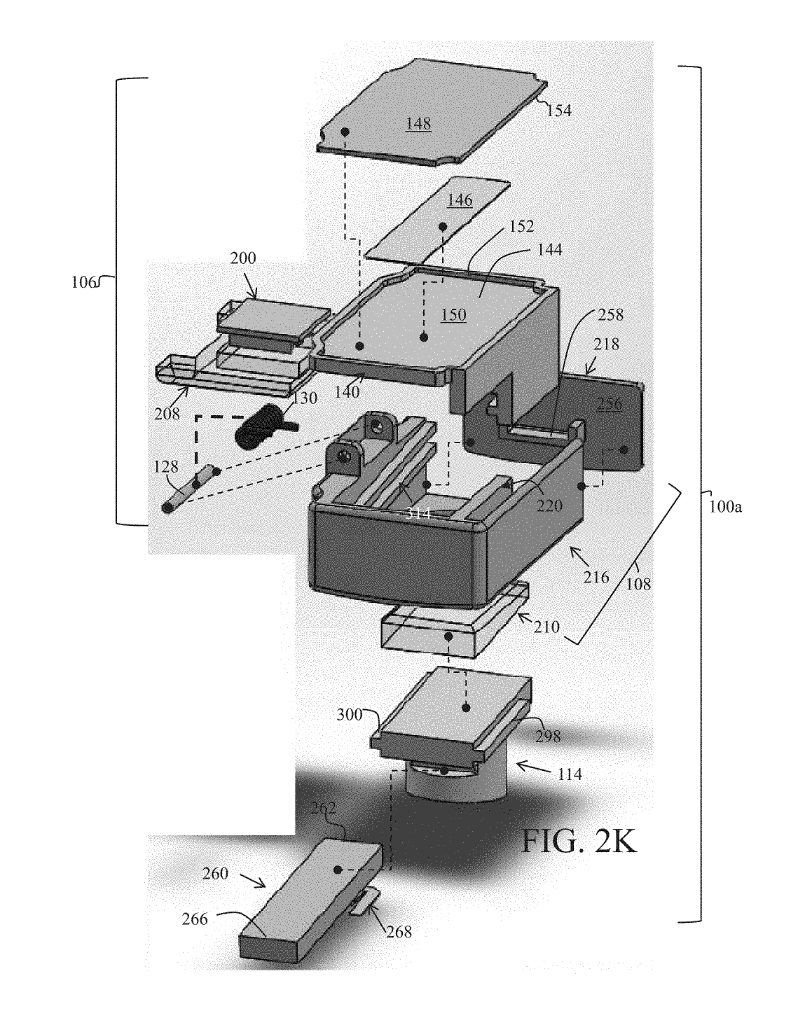

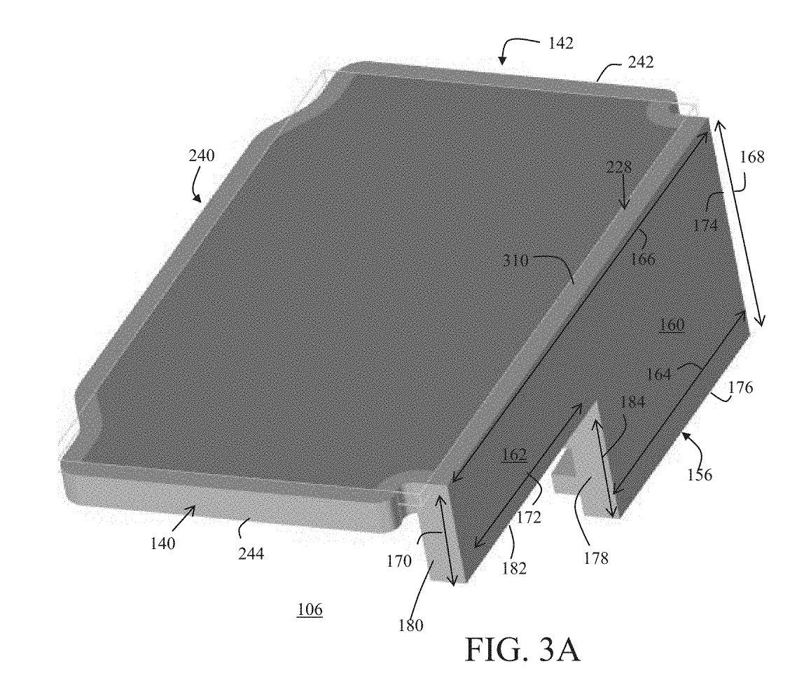

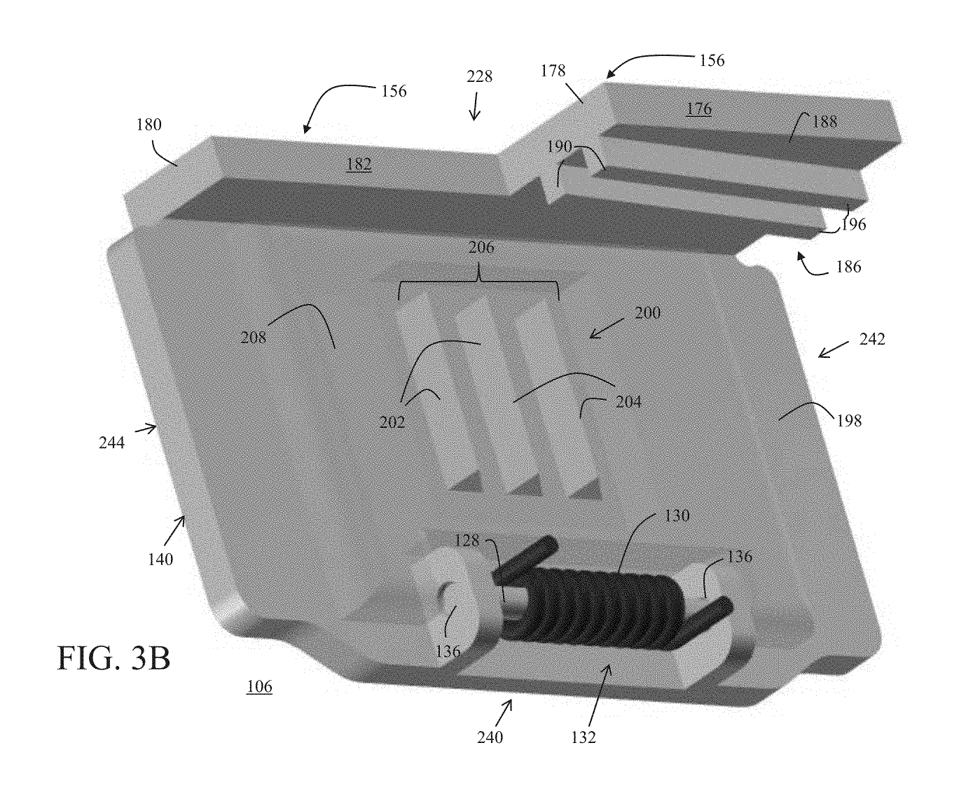

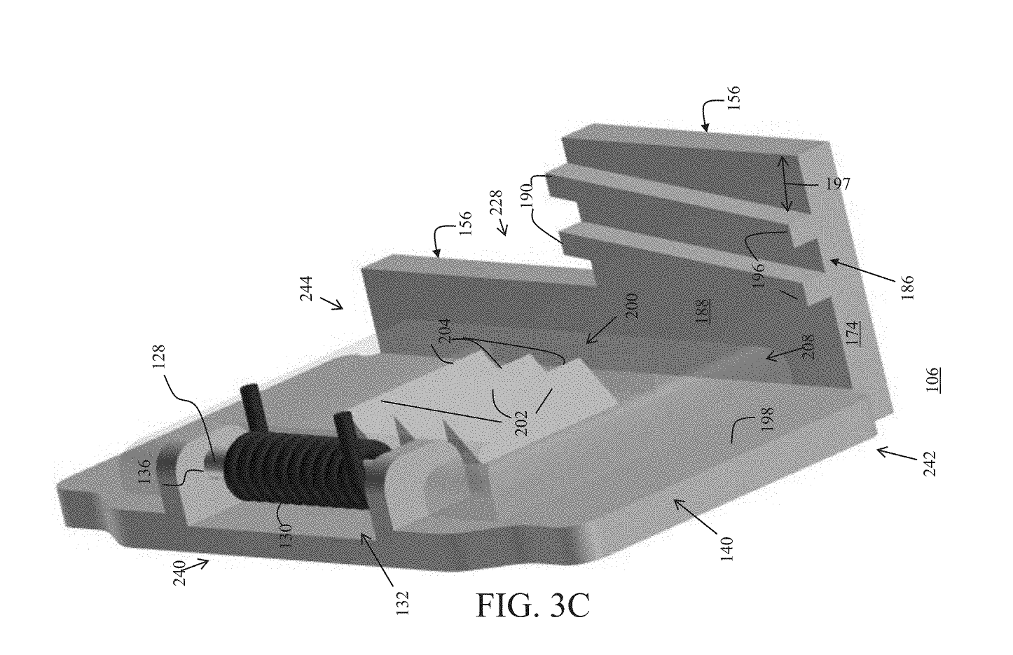

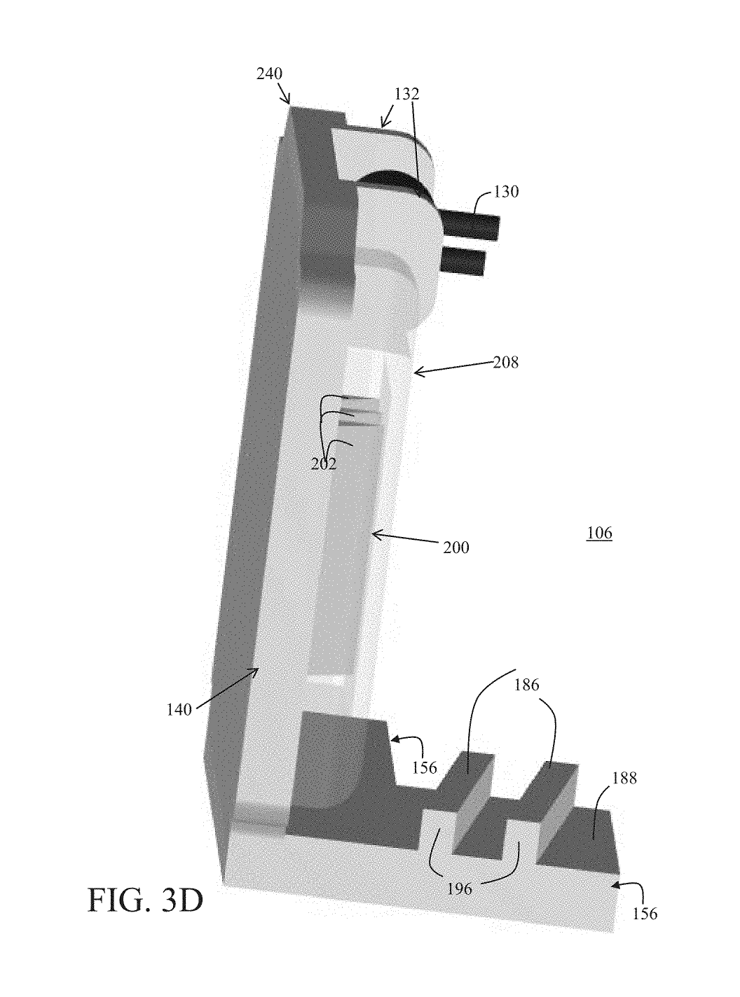

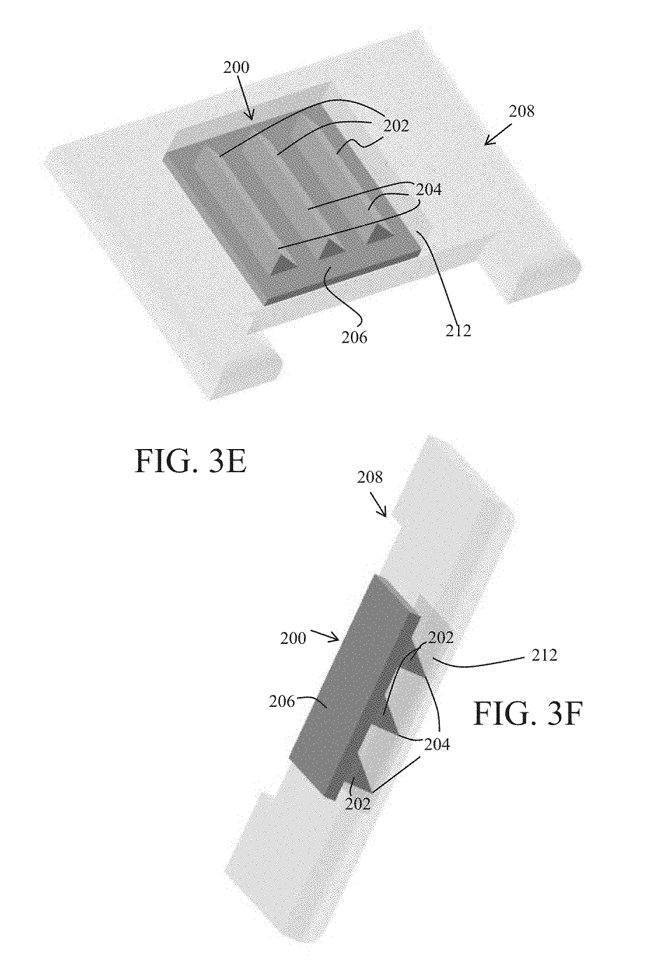

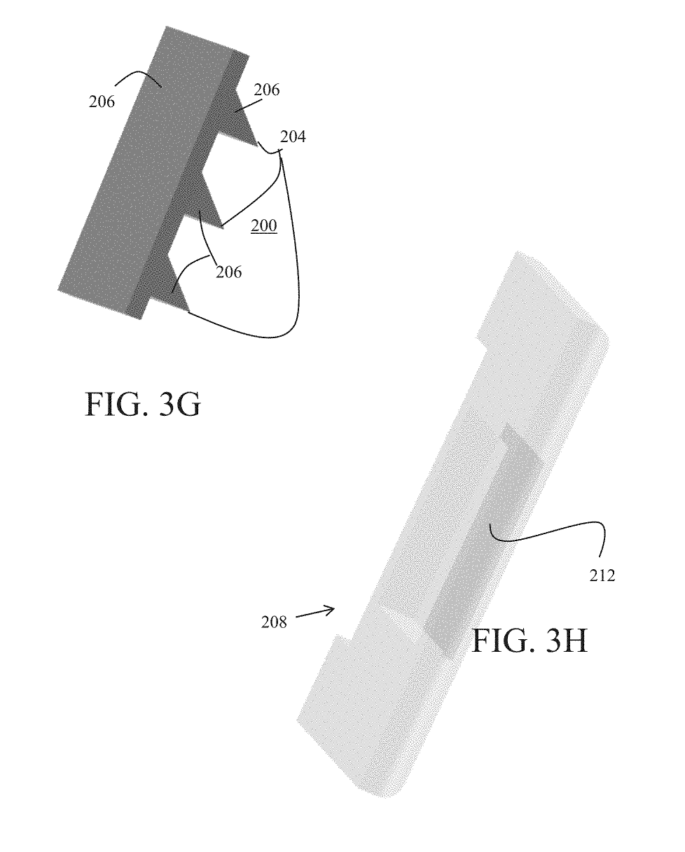

FIGS. 3A to 3H are non-limiting, exemplary illustrations of the various perspective views of cover assembly of the theft deterrent tag shown in FIGS. 2A to 2K in accordance with one or more embodiments of the present invention. As illustrated in FIGS. 1 to 3H, cover assembly 106 is comprised of a first (or hinge) side 240, a second or interlocking side 228, lock side 242, and unlock side 244, corresponding to first side 112, second side 158, lock side 194, and unlock side 192 of tag 100a.

Cover assembly 106 is engaged with lock mechanism assembly 108 at a first (or hinge) side 112 of tag 100a at open, closed, and locked positions by a well known hinge mechanism 126. Therefore, force must be applied to cover assembly 106 to move it to a closed position in relation to lock mechanism assembly 108.

Hinge mechanism 126 is comprised of a pin 128 and a biasing mechanism in a form of a resilient members 130 associated with cover assembly hinge structure 132 and lock mechanism assembly hinge structure 134. Resilient member 130 is in a form of a torsion spring that biases cover assembly 106 to the open position. Pin 128 is inserted into sets of openings 136 and 138 that define respective cover assembly hinge structure 132 and lock mechanism hinge structure 134.

Cover assembly 106 is comprised of a lid 140 that has a top side (i.e., the exterior facing side) 142 that includes a compartment 144 (best shown in FIG. 2K), with one or more electronic modules (e.g., EAS, RFID, etc.) 146 that are housed within compartment 144. Cover assembly 106 further includes a cover 148 that covers over compartment 144 for protecting one or more electronic modules 146 so that the electronic modules 146 are not exposed and are hidden.

An electronic article surveillance (EAS) module may comprise of one or more marker circuits (which are well known) that may respond to specific types of electronic surveillance signals of different types of well known EAS systems, non-limiting examples of which may include Magnetic, Acousto-Magnetic (AM), Radio Frequency (RF), Microwave, etc. For example, a marker circuit may comprise a ferrite coil antenna that includes an inductor L and capacitor C (e.g., an LC tank) for radio frequency (RF) systems, amorphous metals for Magnetic systems, magnetostrictive and or ferromagnetic amorphous metals for use with acousto-magnetic (AM) systems, or non-linear elements such as a diode for Microwave systems. It should be noted that several marker circuits of different types may be used within the same theft deterrent tag, with each tuned (or adapted) to a different resonant frequency and or system for activation of different types of EAS systems. A non-limiting example of a resonant marker circuit (with passive LC tank) is detailed in U.S. Pat. No. 7,336,180 to Sayegh et al., the entire disclosure of which is incorporated by reference herein in its entirety.

As further best shown in FIG. 2K, compartment 144 is comprised of a recessed base 150 of about 1 mm to about 4 or 5 mm in depth surrounded by protruded periphery 152 that extends perpendicular from recessed base 150. Recess base 150 depth (or overall compartment 144 volume) may be varied to accommodate and securely house various types of electronics modules 146.

Protruded periphery 152 define a continuous flange along a periphery of the top side 142 of the lid 140, delimiting a perimeter of recessed base 150 and defining the wall of the compartment 144. Periphery edges 154 of cover 148 are commensurately configured to engage protruded periphery 152 of top side 142 of lid 140. Cover 148 may be coupled with top side 142 of lid 140 using any well known technique, for example by sonic welding.

Referring back to FIGS. 3A to 3H, cover assembly 106 further includes an engagement wall 156 that extends generally perpendicular from second side (or engagement or interlock side) 228 of lid 140 of cover assembly 106 (second side 158 of tag 100a). Engagement-wall 156 is comprised of an interlocking portion 160 and a covering portion 162, forming a somewhat generally “L” shape-type wall comprised of two generally polygonal planes 160 and 162 as shown with six sides.

First side 310 of engagement wall 156 is the same as second side 228 of lid 140, with length 166. Parallel first side 310, are second and third sides 176 and 182 with respective lengths 164 and 172 that when combined equal length 166 of first side 310. A fourth side 174 of engagement wall 156 is has a length 168, which is parallel fifth and sixth sides 178 and 180 with respective lengths 184 and 170 that when combined equal length 168.

Interlocking portion 160 has a first set of parallel engagement bars 186 for locking cover assembly 106 with lock mechanism assembly 108. First set of parallel engagement bars 186 are positioned on an interior facing side 188 of interlocking portion 160 of engagement-wall 156.

First set of parallel engagement bars 186 define a set of interlocking guide rails that are sloped at an angle, with ends 196 a distance 197 away from side 176. A first end 190 of interlocking guide rails 186 from unlock side 192 of theft deterrent tag 100a is at a lower elevation and a second end 196 of the interlocking guide rails 186 near lock side 194 of theft deterrent tag 100a is at a higher elevation. As detailed below, the sloped angle of interlocking guide rails 186 requires a progressively added force to move slider mechanism 114 to locking side 194 and hence, generating a progressively increasing holding lock pressure between cover assembly 106 and lock mechanism assembly 108.

Cover assembly 106 further includes a benefit-denial mechanism 200 that is positioned between cover assembly 106 and lock mechanism assembly 108, positioned on an interior facing side (bottom side) 198 of lid 140 of cover assembly 106. Benefit denial mechanism 200 discourages would be theft of article 102 and tampering with and unauthorized removal of article 102.

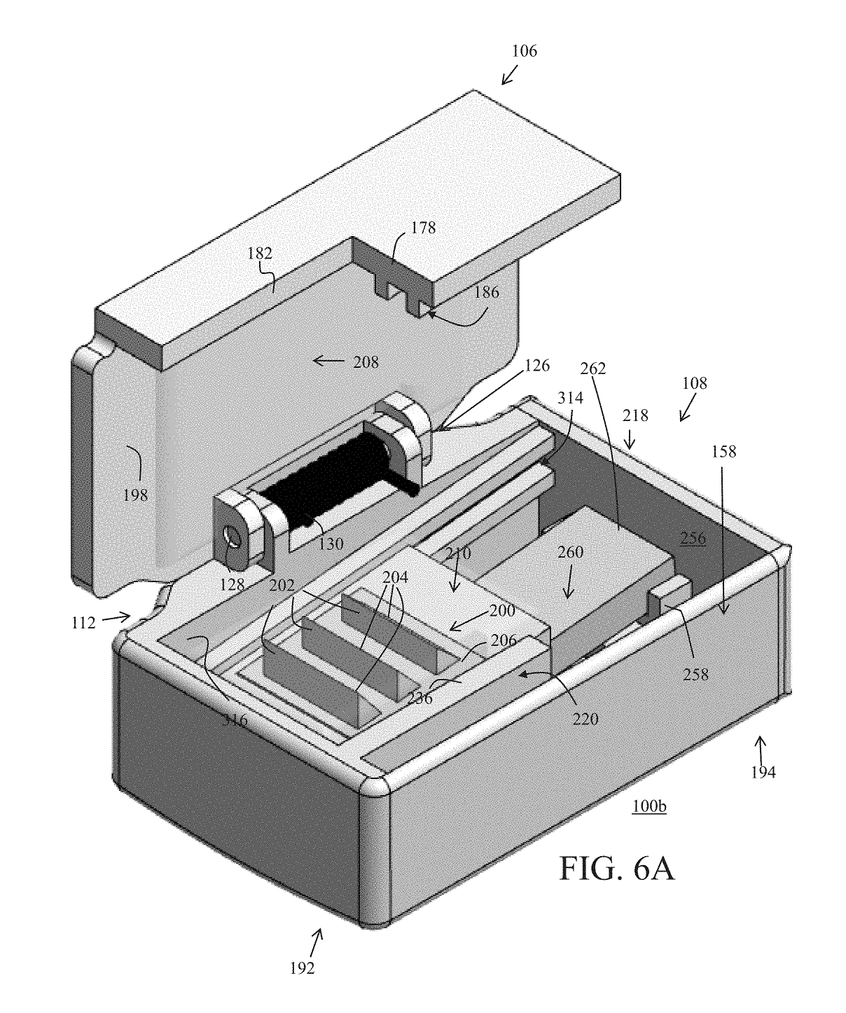

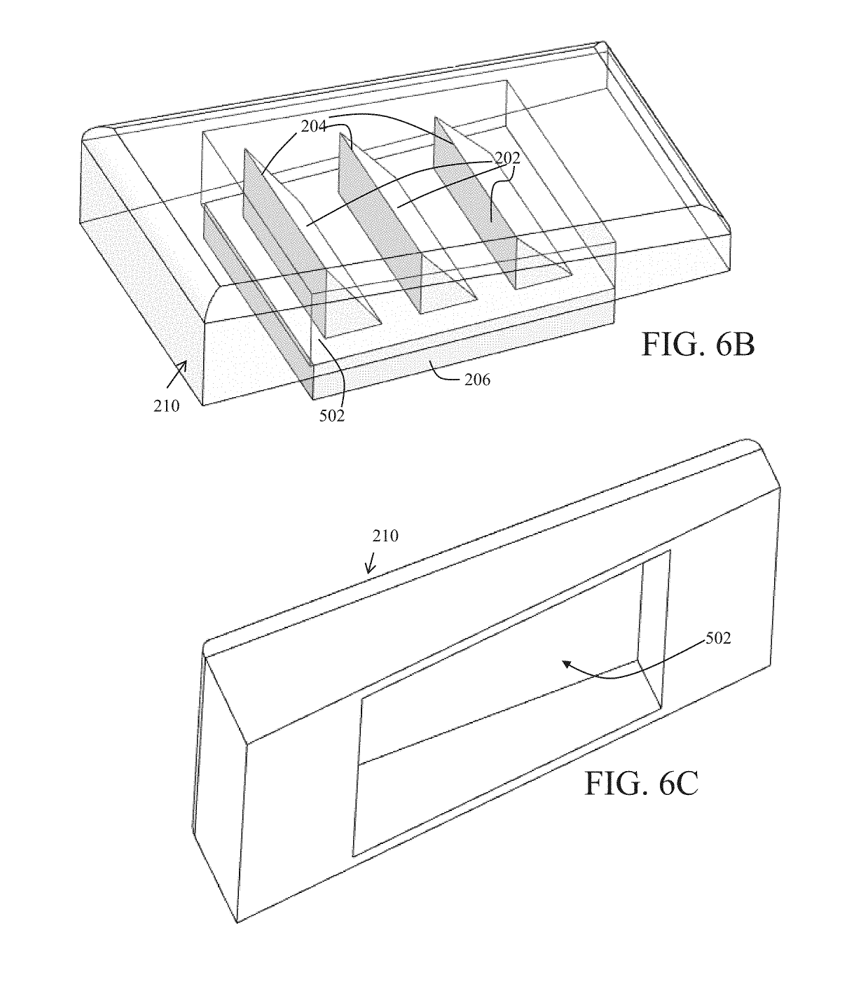

As detailed below, configuration and positioning of benefit denial mechanism 200 in relation to lid 140 and lock mechanism assembly 108 may be reversed or varied. That is, benefit denial mechanism 200 may be positioned and associated with lock assembly 110 within lock mechanism assembly 108 instead (FIGS. 6A to 6C) or, both cover assembly 106 (as illustrated) and lock mechanism assembly 108.

Benefit-denial mechanism 200 includes a set of protuberances 202 with sharp edges 204 collectively forming a serrated platform 206 that damages (e.g., scratch) article 102 if article 102 is forcefully removed (templates 104 are forcefully pulled out) from theft-deterrent tag 100a. As best illustrated in FIG. 2K, a first and a second protective member 208 and 210 associated with respective cover assembly 106 and lock mechanism assembly 108 protect article 102 against potential damage (e.g., scratches).

Theft deterrent tag 100a includes first and second protective member 208 and 210 associated with respective cover assembly 106 and lock assembly 110 of lock mechanism assembly 108. In general, template 104 of eyewear 102 may be securely positioned between cover assembly 106 and lock mechanism assembly 108, sandwiched between respective first and second protective members 208 and 210 (which may comprise of soft robber, cushion, etc. for example). First and second protective members 208 and 210 prevent the engaging template 104 of eyewear 102 from damage while eyewear 102 is engaged with theft-deterrent tag 100a and further, prevent eyewear 102 from being removed.

One or both of the first and second protective members 208 and 210 may include a piercing portion (extremely thin part) 212 wherein added force to remove article 102 from theft deterrent tag 100a pushes serrated platform 206, penetrating (rupturing) and puncturing through piercing portion 212 to thereby physically contact the article. In the non-limiting, exemplary instance illustrated, first protective member 208 includes a piercing portion 212.

Due to the tight fit of the engaging template 104 in between protective members 208 and 210, if theft deterrent tag 100a is handled (gripped by one hand) and article 102 is pulled by the other hand, the tight fit and tight grip of theft deterrent tag 100a would exert a force on cover assembly 106 and lock mechanism assembly 108 to enable serration platform 206 to push through and rupture piercing portion 212, enabling serrated sharp edges 204 to physically and mechanically contact the engaging template 104 of article 102. As article 102 is pulled to be removed from theft deterrent tag 100a, serrated edges 204 (which are sharp and pointy) contact article 102 and damage it. In other words, while theft-deterrent tag 100a is not tampered, article 102 is protected against theft and physically against damage by first and second protective members 208 and 210. However, if theft deterrent tag 100a is tampered and article 102 is forcefully removed, article 102 becomes damaged by sharp edges 204.

As indicated above, a forced removal of article 102 from theft deterrent tag 100a by gripping eyewear 102 to pull out template 104 from in between cover assembly 106 and lock mechanism assembly 108 in direction 122 shown in FIG. 1 would move slider mechanism 114 of lock assembly 110 further towards lock position 120 of a greater holding force, which, in turn, would place a generally commensurate greater holding pressure on article 102 (or template 104) positioned in between cover assembly 106 and lock mechanism assembly 108. This added force would exert an added pressure which would also enable serration platform 206 to quickly push through and rupture piercing portion 212, enabling serrated sharp edges 204 to more strongly physically and mechanically contact the engaging template 104.

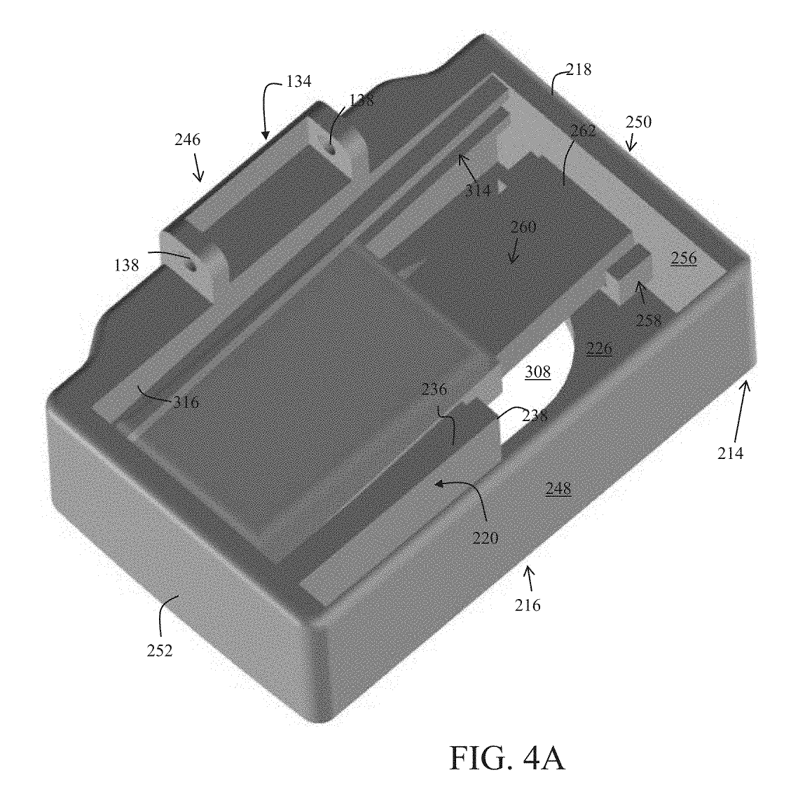

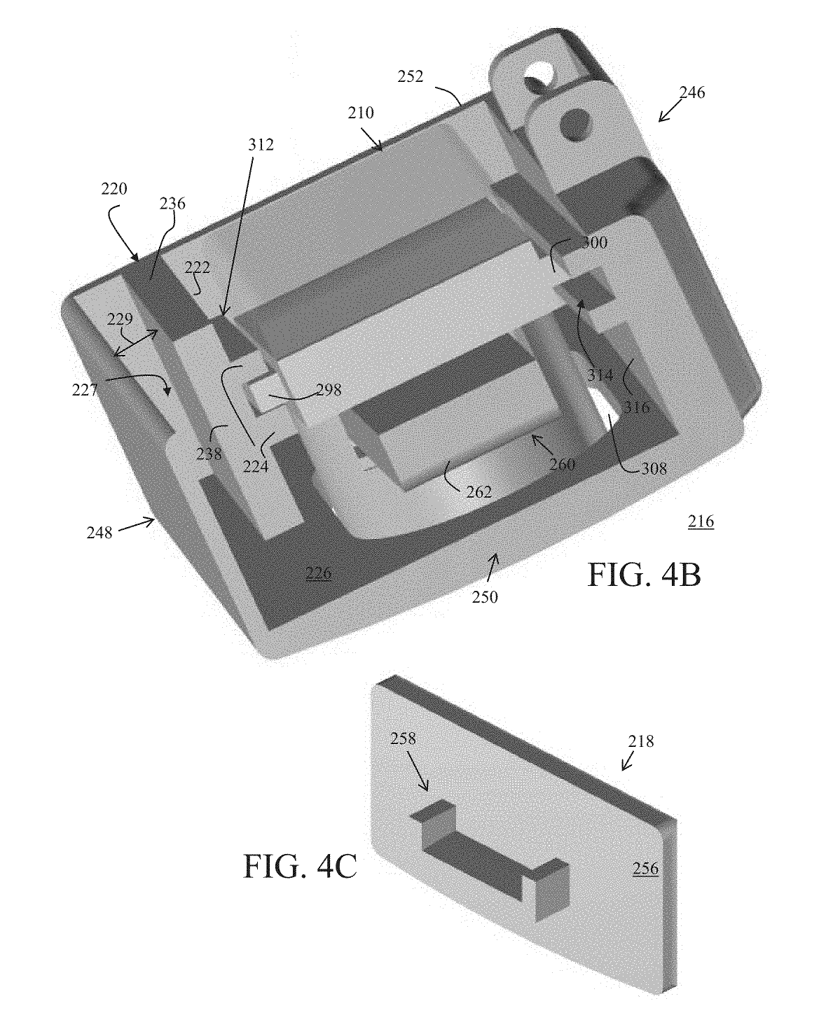

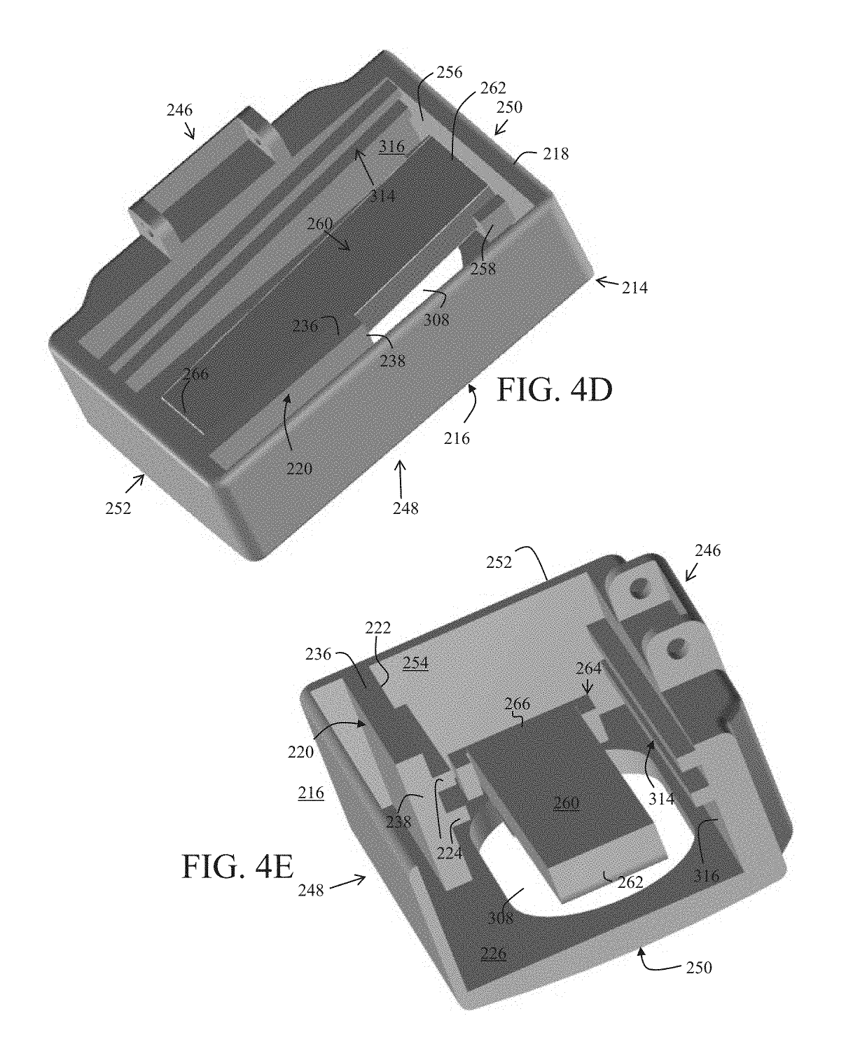

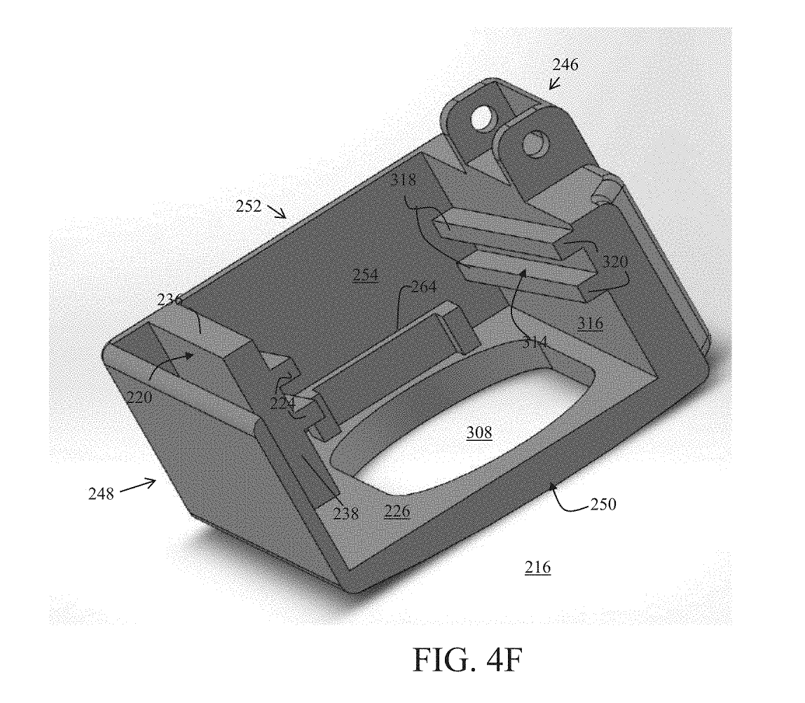

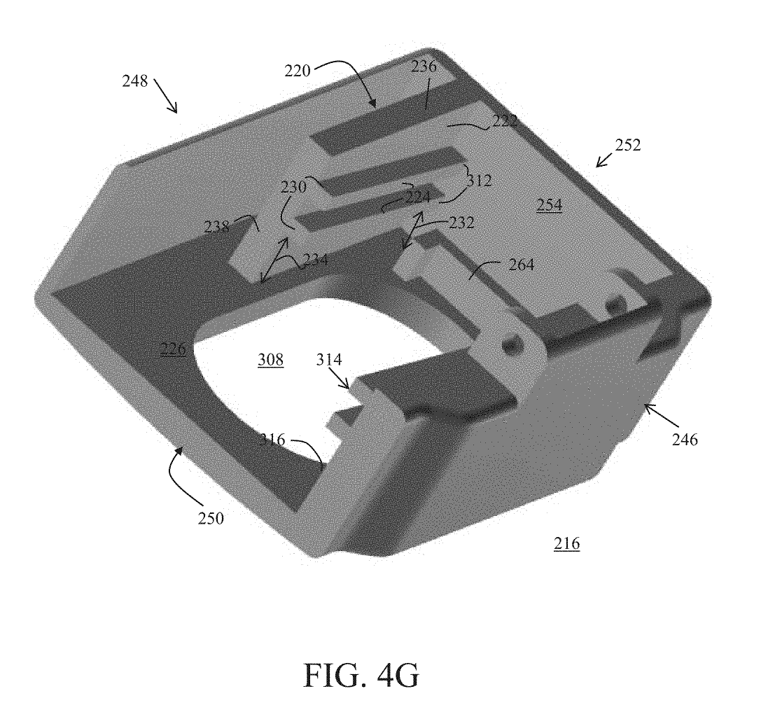

FIGS. 4A to 4G are non-limiting, exemplary illustrations of the various perspective views of lock mechanism assembly and lock assembly of the theft deterrent tag shown in FIGS. 1 to 3H in accordance with one or more embodiments of the present invention. As illustrated in FIGS. 1 to 4G, lock mechanism assembly 108 is comprised of a housing assembly 214 that houses lock assembly 110. Housing assembly 214 has a first (or hinge) side 246, a second or interlocking side 248, lock side 250, and unlock side 252, corresponding to first side 112, second side 158, lock side 194, and unlock side 192 of tag 100a.

Housing assembly 214 is comprised of a first piece 216 and a second piece 218, with first piece 216 having an interior wall 220 at unlock side 192 of theft deterrent tag 100a, a distance 229 (FIG. 4B) away from second (or interlock) side 158 of theft-deterrent tag 100a, defining a space 227. Second piece 218 forms lock side 194 of theft deterrent tag 100a, which may be sonic welded to first piece 216 to form housing assembly 214.

An interior facing side 222 of interior wall 220 includes a second set of parallel engagement bars 224 for supporting lock assembly 110. Second set of parallel engagement bars 224 defines a first set of support guide rails that are sloped at an angle. An unlock end 312 (FIG. 4G) of support guide rails 224 from unlock side 192 of theft deterrent tag 100a is at a lower, first elevation 232 from base 226 of first piece 216, whereas a lock end 230 of support guide rails 224 towards lock side 194 of theft deterrent tag 100a is at a second higher elevation 234 from base 226. A top periphery 236 of interior wall 220 engages third side 182 of engagement-wall 156 and free side 238 of interior wall 220 engages fifth side 178 of engagement wall 156 when cover assembly 108 is in closed position to prevent tampering by blocking insertion of prying tools.

An advantage of having interior wall 220 and positioning it distance 229 away from second or interlocking side 158 of tag 100a is that second side 158 of tag 100a functions as the primary protection to block and prevent insertion of tools into first piece 216 of housing assembly 214 of tag 100a while hiding and blocking access to engaging sides 236/182 and 238/178 of interior wall 220 and engagement wall 156. In other words, engaging sides 236/182 and 238/178 of interior wall 220 and engagement wall 156 are no longer exposed and are hidden and protected behind second side 158 of tag 100a.

Set of interlocking guide rails 186 align with first set of support guide rails 224 when lid 140 is in closed position to form a first part of a continuous, upward sloping rail system from unlock side 192 to lock side 194 of theft deterrent tag 100a at second (or interlocking) side 158 of theft-deterrent tag 100a. Housing assembly 214 further includes a third set of parallel engagement bars 314 defining a second set of support guide rails associated with an interior facing side 316 of first side 246 of first piece 216 of housing assembly 214.

Second set of support guide rails 314 are oriented parallel first set of supporting guide rails 224 and interlocking guide rails 186, with second set of support guide rails 314 forming a second part of the guide rail system. Second set of support guide rails 314 slope from a lower elevation end 318 at unlock side 252 to a higher elevation end 320 at lock side 250, parallel first set of supporting guide rails 224 and interlocking guide rails 186. Second set of support guide rails 314, first set of supporting guide rails 224, and interlocking guide rails 186 define complete guide rail system comprised of two sided guide rails that enable slider mechanism 114 of lock assembly 110 to slide along a linear reciprocating path between guide rails from unlock side 192 to lock side 194 of tag 100a.

As best illustrated in FIGS. 4A to 4C, an interior facing side 256 of second piece 218 (at lock side 250) of housing assembly 214 includes a first support structure 258 in a form of a non-limiting, exemplary support bracket—a first right-angled support projecting from interior facing side 256, at above base 226, which supports to hold a first distal end 262 of lock member 260 of lock assembly 110. As indicated above, second piece 218 may be sonically welded to first piece 216 to form housing assembly 214.

As best illustrated in FIGS. 4E to 4G, an interior facing side 254 of unlock side 252 of first piece 216 of housing assembly 214 includes a second support structure 264 also in a form of a non-limiting, exemplary support bracket—a second right-angled support, projecting from interior facing side 254, at base 226, which supports to hold a second distal end 266 of lock member 260 of lock assembly 110.

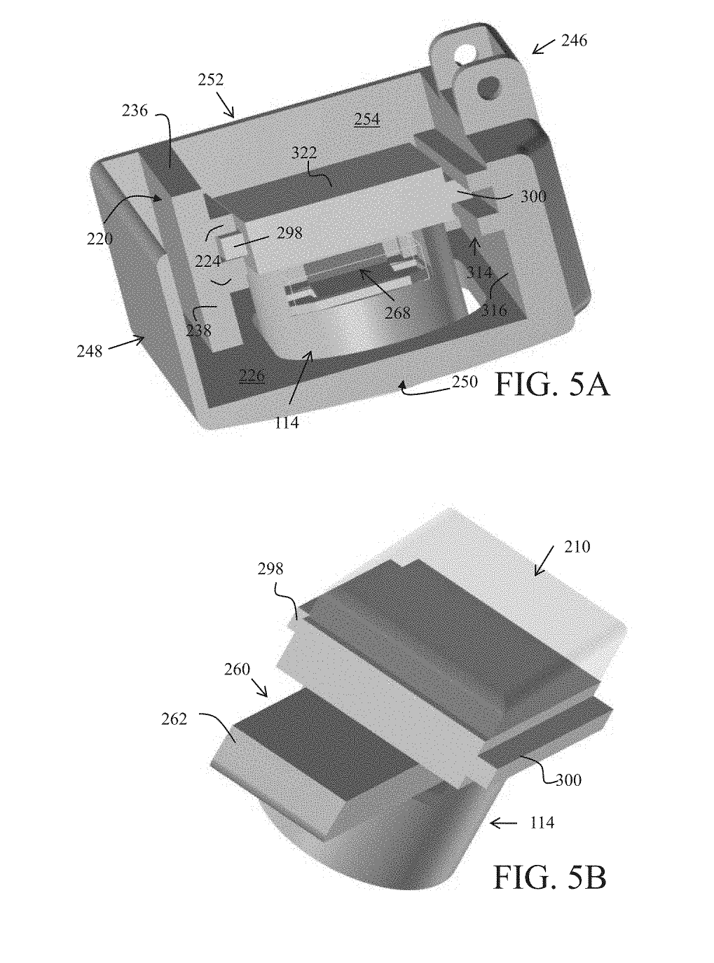

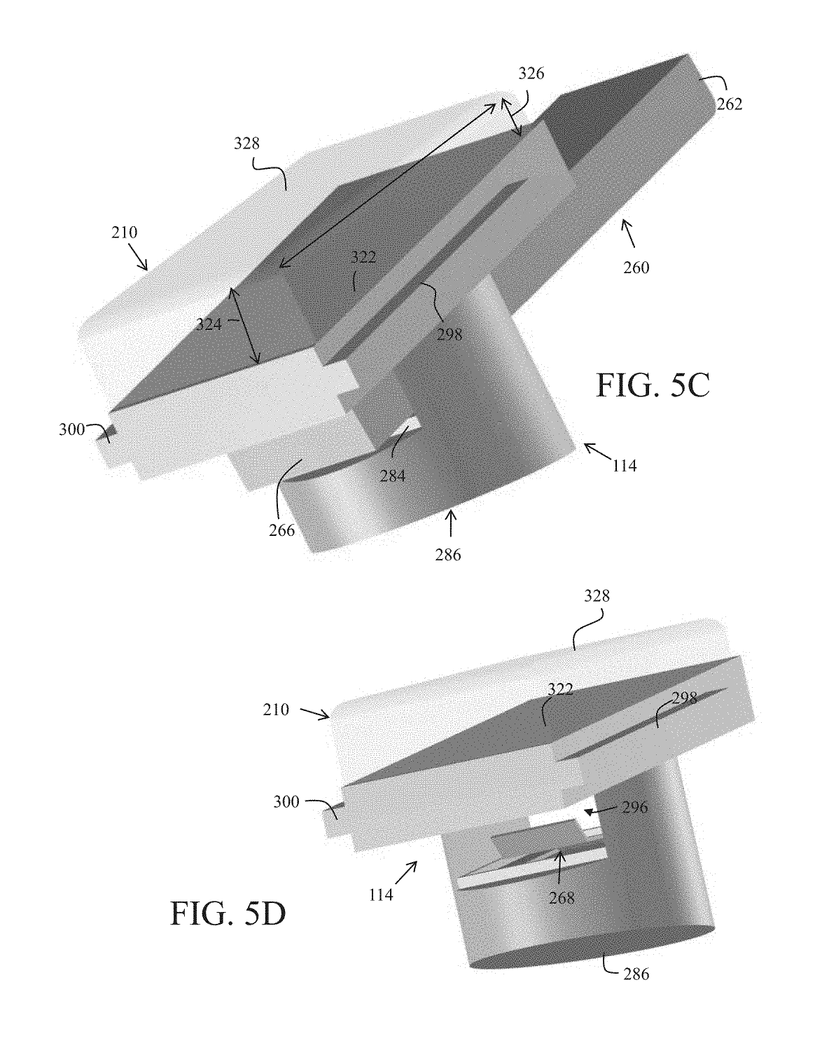

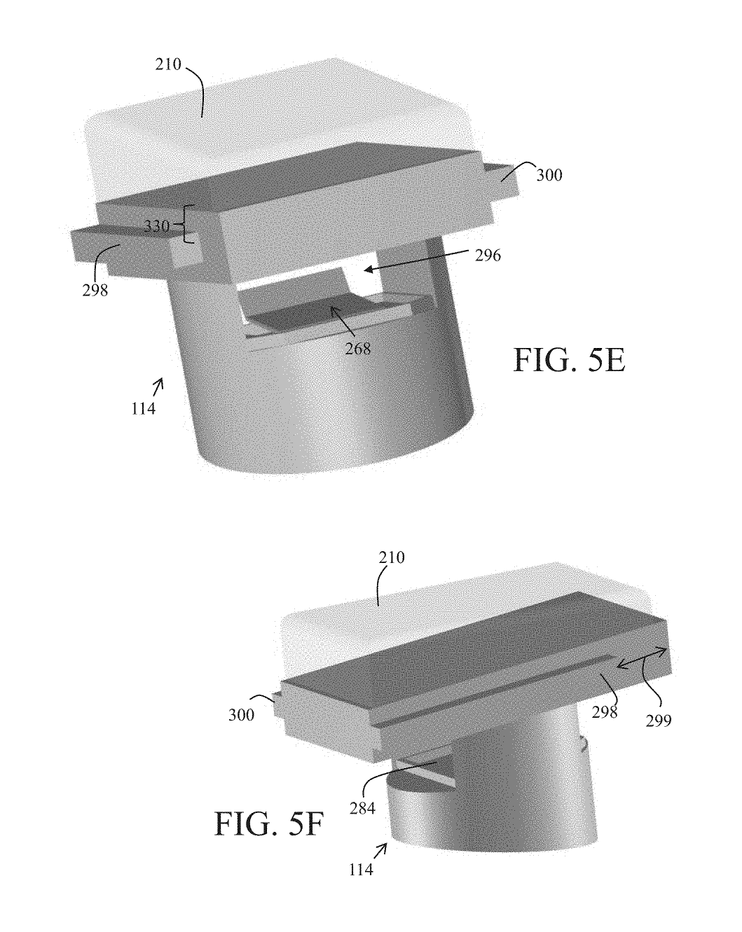

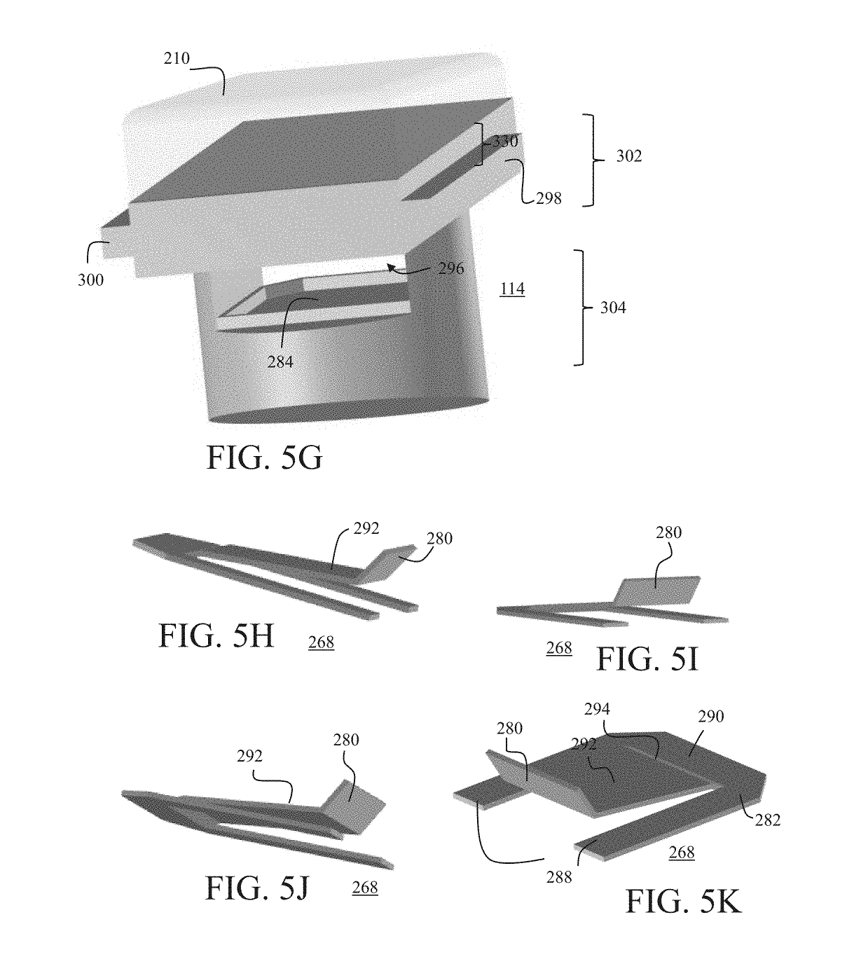

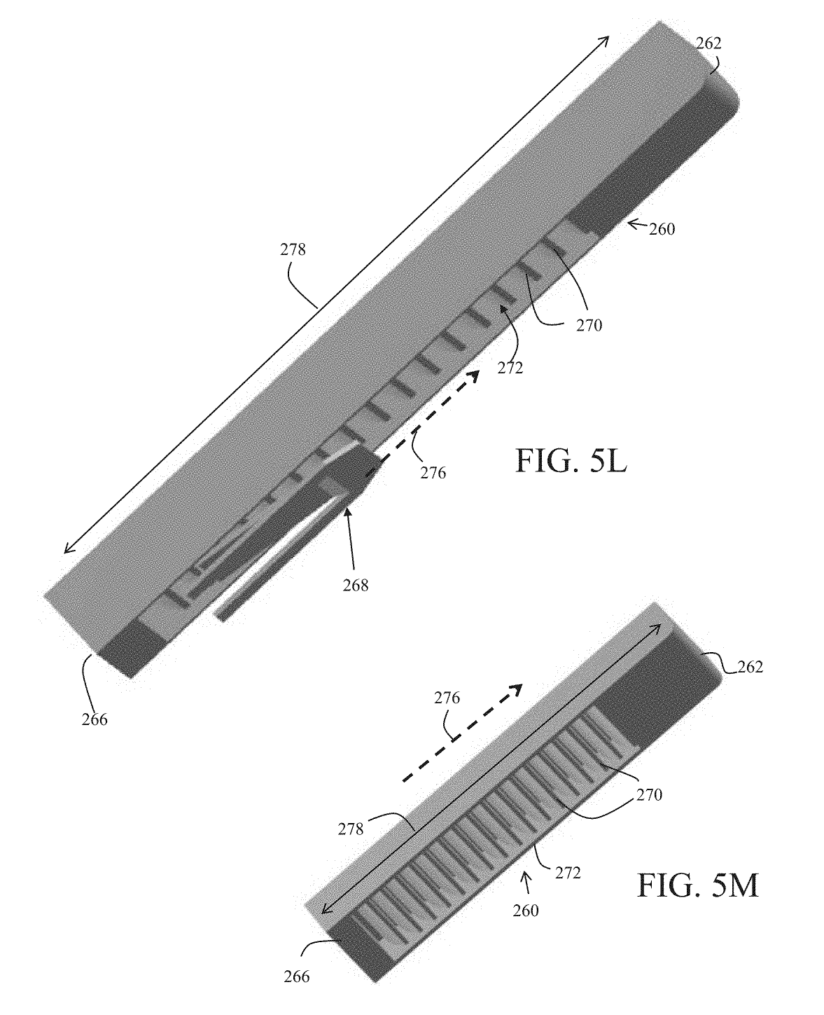

FIGS. 5A to 5M are non-limiting, exemplary illustrations of the various perspective views of lock assembly of the theft deterrent tag shown in FIGS. 1 to 4G in accordance with one or more embodiments of the present invention. As illustrated in FIGS. 1 to 5M, lock assembly 110 is comprised of lock member 260, slider mechanism 114, and a lock mechanism 268.

As best illustrated in FIGS. 5L and 5M, Lock member 260 of lock assembly 110 is comprised of a set of serrations 270. Lock member 206 may comprise of a metallic piece and is fixed onto first and second support structures 258 and 264 and hence, is stationary. First end 262 of lock member 260 is supported by first support structure 258 of second piece 218 of housing assembly 214, and second end 266 that is supported by second support structure 264 on first piece 252 of housing assembly 214.

As indicated above, second support structure 264 projects from interior facing side 254 of unlock side 252 of first piece 216. It should be noted that second support structure 264 is positioned at a lower elevation compared to first support structure 258, commensurate with elevations gained with the sloping rail system.

Lock member 260 further include a first surface 272 that includes engaging elements 270 forming serrations that engage with lock mechanism (or interlock clip) 268 such that movement of interlocking clip 268 in a first direction 276 (unlock side 192 to lock side 194) is allowed at any desired adjustments (pressure) along a longitudinal axis 278 of lock member 260, but reverse movement thereof is not allowed, thereby enabling tag 100a to engage objects of varying sizes under different pressures. The sloping elevated rails (224, 186, and 254) allows for angle of adjustment pressure to accommodate different sizes of eyewear template 104.

Both lock member 260 and interlock clip 268 are metallic that are influenced by a magnetic force from a well known detacher (not shown) to disengage an engagement edge 280 of interlock clip 268 from engagement elements 270. Interlock clip 268 includes a clip-base 282 that is secured within slider compartment 284 (of slider mechanism 114) whereby engagement edge 280 faces serrations (or engagement elements) 270 of lock member 260.

Engagement edge 280 has a slight up angle forcing edge 280 into serrations 270. This locks tag 100a, but allowing slider mechanism 214 to further move to a tighter grip towards lock side 194 of tag 100a. To unlock (release) tag 100a, a magnetic detacher (not shown) is placed on the bottom (exposed side) 286 of slider mechanism 214. Magnetic force lifts the engagement edge 280 out of the teeth (serrations) 270 of lock member 260 to thereby disengage interlock clip 268 from lock member 260 and allowing slider mechanism to freely slide to unlock side 192 of tag 100a.

In this non-limiting, exemplary instance, interlock clip 268 is comprised of a metal tine 292 with engagement edge 280. Tine 292 preferably is lanced from a flat spring metal strip of material (i.e., clip base 282) so as to extend in an outwardly direction towards serrations 270 when fully assembled. The free ends 288 and strip 290 (which form clip base 282) are accommodated within slider compartment 284. Tine 292 is integrally connected to strip 290 by a “living” hinge segment 294, which allows tine 292 to move to engage or disengage from serrations 270.

As further illustrated in FIGS. 1 to 5M, slider mechanism 114 of lock assembly 110 includes a passage-opening 296 that accommodates lock member 260 and enables slider mechanism 114 to slide along lock member 260 from unlock side 192 to lock side 194 of theft deterrent tag 100a. Slider mechanism 114 further includes a compartment 284 within passage opening 296 that houses lock mechanism 274 that engages with serrations 270 of lock member 260.

Slider mechanism 114 is further comprised of longitudinally extending lateral flanges 298 and 300 that form rail engagement portions of the slider mechanism 214. As best illustrated in FIGS. 2G, 2H, 4B, and 5A, lateral flanges 298 and 300 ultimately, respectively engage with first set of support guide rails 224 and interlocking guide rails 186, and second set of support guide rails 314 of theft deterrent tag 100a when cover assembly 106 is closed and locked. That is, when cover assembly 106 is open, lateral flanges 298 and 300 respectively engage with unlock side 192 of first set of support guide rails 224 and second set of support guide rails 314. However, when cover assembly 106 is closed, lateral flanges 298 and 300 enable slider mechanism 114 to slide toward lock side 194 along the rail system, with flange 298 and 300 respectively engaging with first set of support guide rails 224 and interlocking guide rails 186, and second set of support guide rails 314 of theft deterrent tag 100a. Lateral flange 298 has a shorter span indicated by arrow 299 (FIG. 5F) compared to lateral flange 300 to enable full closure of cover assembly 106.

As further illustrated, lateral flanges 298 and 300 protrude from an upper slider engagement body portion 302 (FIG. 5G), with slider mechanism 114 further including a lower knob portion 304 (FIG. 5G), a portion 306 (FIG. 2A) of which extends out of an opening 308 of base 226 of first piece 216 of housing assembly 214 for moving slider mechanism 114 by a user finger.

Upper slider engagement body portion 302 is sloped at a first angle (parallel the rail system), and a free end 286 of knob 304 is sloped at a second angle. It should be noted that if tag 100a is loosely locked and an attempt is made to remove temple 104, the friction between the first and second protective members 208 and 210 and temple 104 will cause slider mechanism 114 to move from unlock side 192 to lock side 194 generating a greater hold pressure.

As illustrated in FIGS. 1 to 5M and FIG. 5C in particular, theft deterrent tag 100a further includes a second protective member 210 that has top surface 328 that has a sloped configuration with at an angle that is the inverse of the sloping angle of the railings (and top 322 of slider mechanism 114). This way, the higher elevation end 324 is oriented at unlock end 192 and lower elevation (thinner part) 326 is at locking end 194—opposite those of the rail systems and top 322 of slider mechanism 114. When fully assembled, sloping top surface 328 becomes horizontally oriented so that it is substantially horizontally flat (non-sloping) from unlock to lock sides when mounted on housing assembly 214. This way, template 104 of eyewear 102 is maintained horizontally flat in between first and second protective members 208 and 210.

FIGS. 6A to 6C are non-limiting, exemplary illustrations of a theft deterrent tag in accordance with another embodiment of the present invention where a benefit denial mechanism is associated with lock mechanism assembly 108 instead of cover assembly 108. Theft deterrent tag 100b illustrated in FIGS. 6A to 6C includes similar corresponding or equivalent components, interconnections, functional, operational, and or cooperative relationships as theft deterrent tag 100a that is shown in FIGS. 1 to 5M, and described above. Therefore, for the sake of brevity, clarity, convenience, and to avoid duplication, the general description of FIGS. 6A to 6C will not repeat every corresponding or equivalent component, interconnections, functional, operational, and or cooperative relationships that has already been described above in relation to tag 100a that is shown in FIGS. 1 to 5M.

As illustrated in FIGS. 6A to 6C, in this non-limiting, exemplary instance, benefit denial mechanism 200 is associated with lock mechanism assembly 108 instead of cover assembly 108. That is, second protective members 210 includes a piercing portion (extremely thin part) 502 wherein added force to remove article 102 from theft deterrent tag 100 pushes serrated platform 206, penetrating (rupturing) and puncturing through piercing portion 502 to thereby physically contact the article.

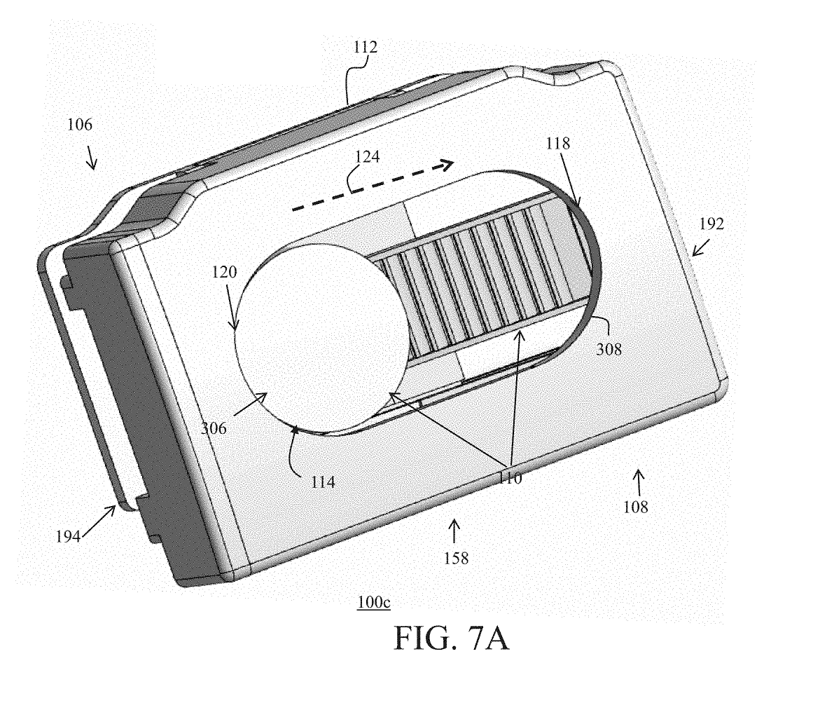

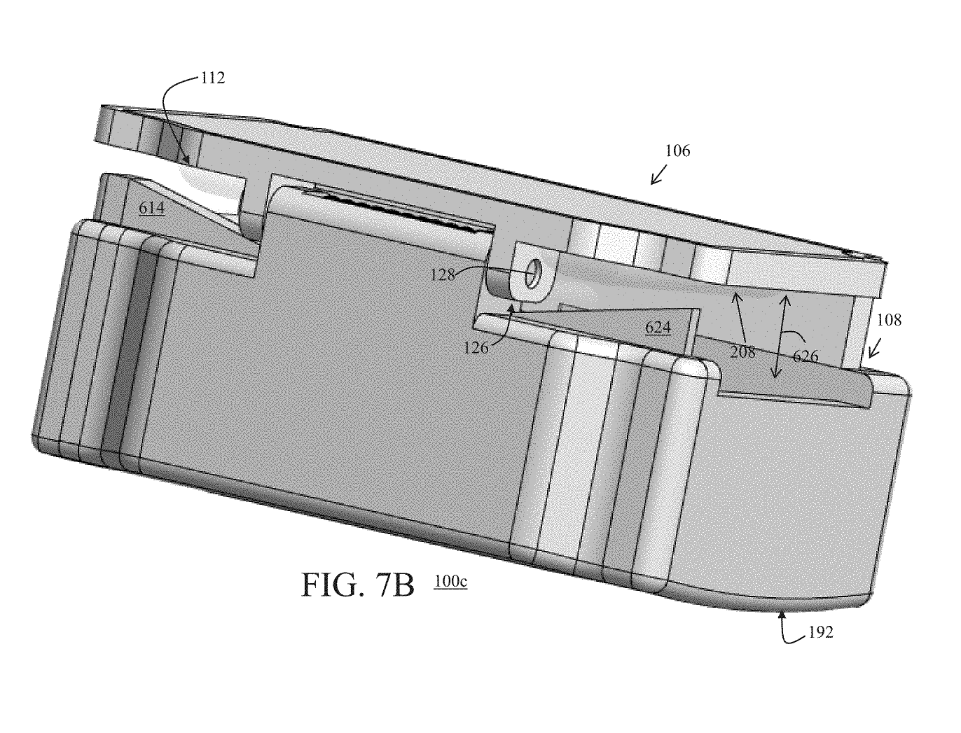

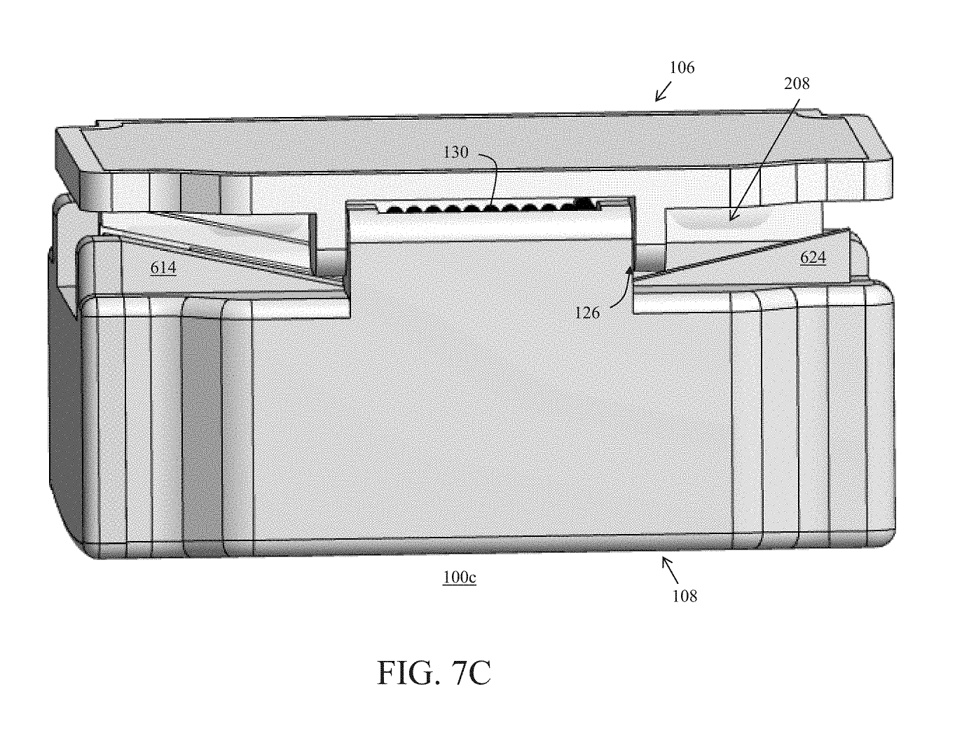

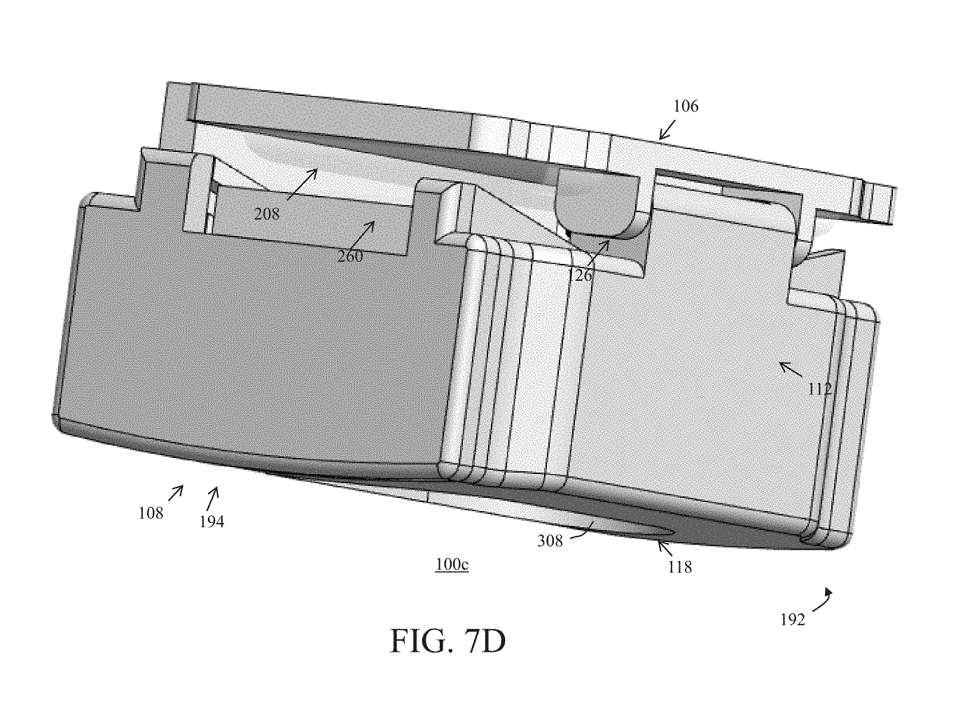

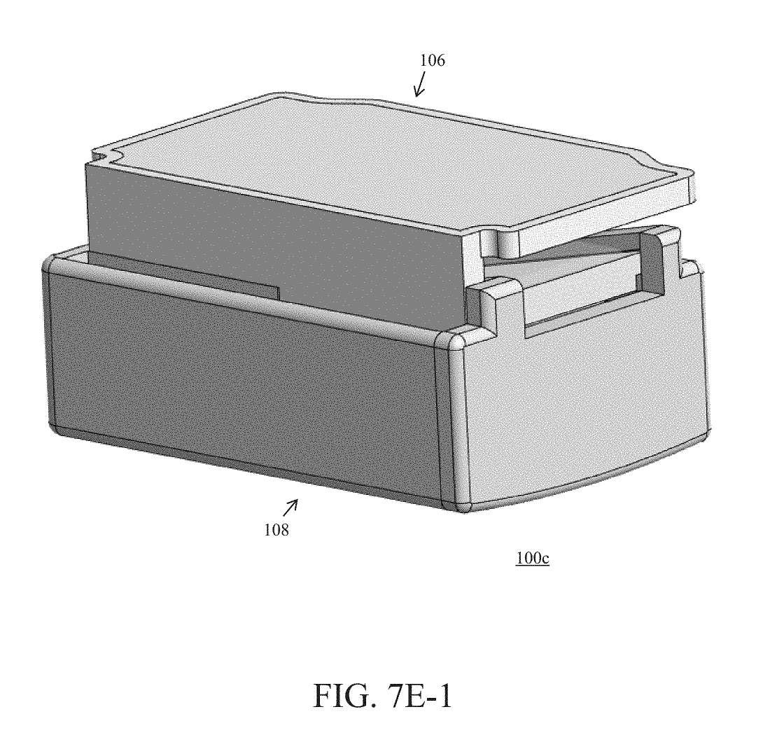

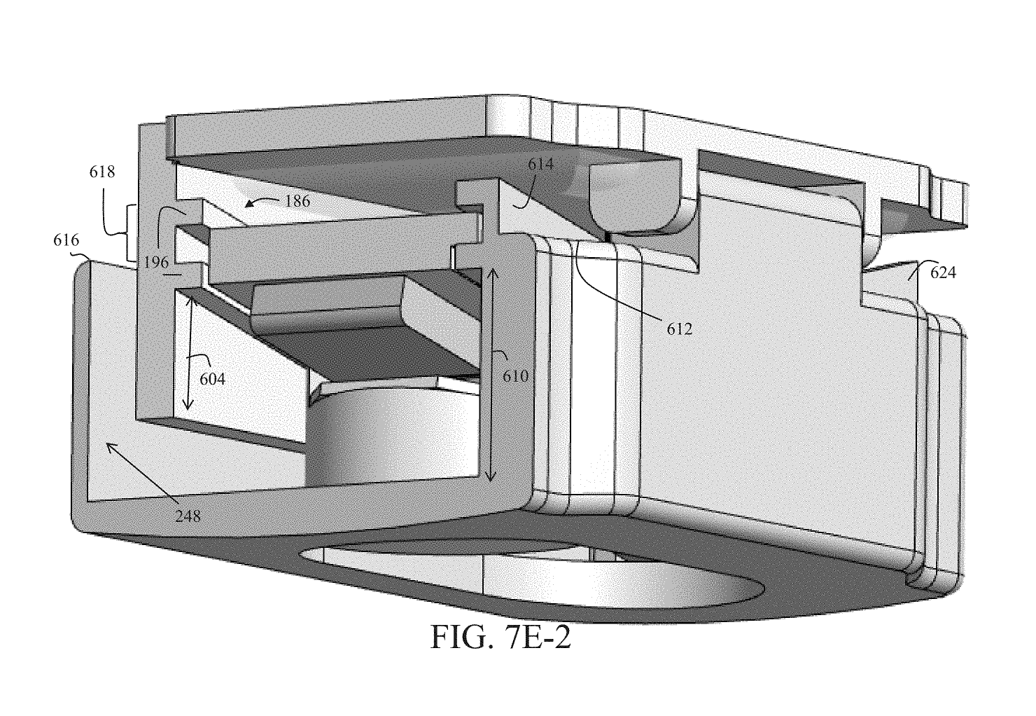

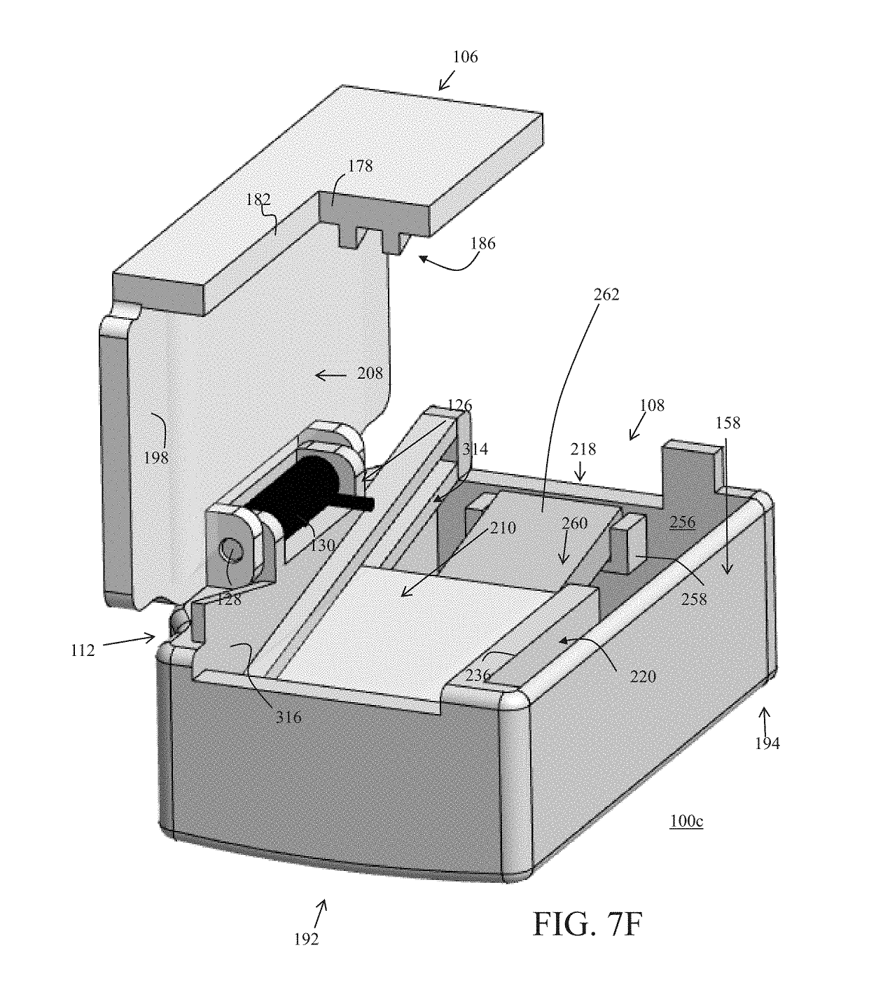

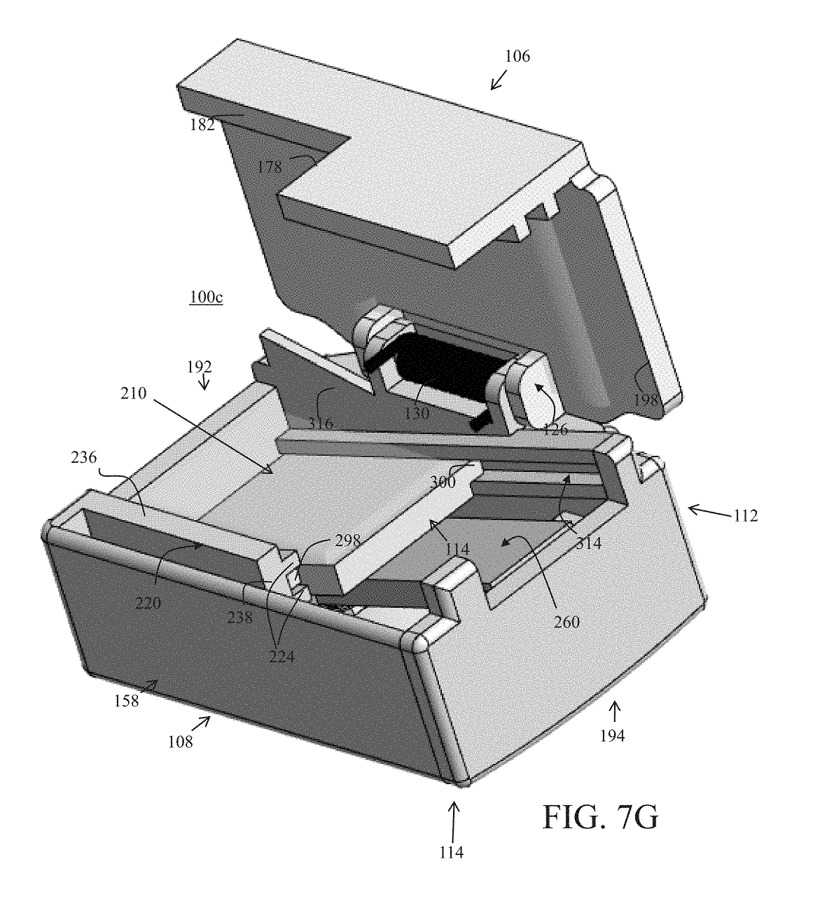

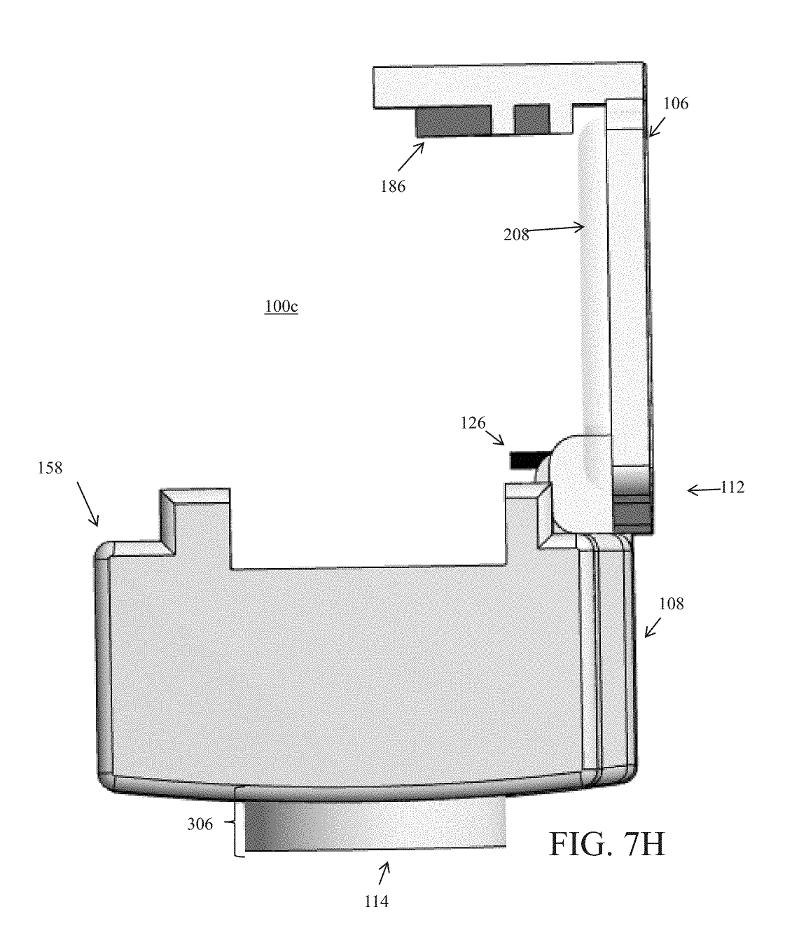

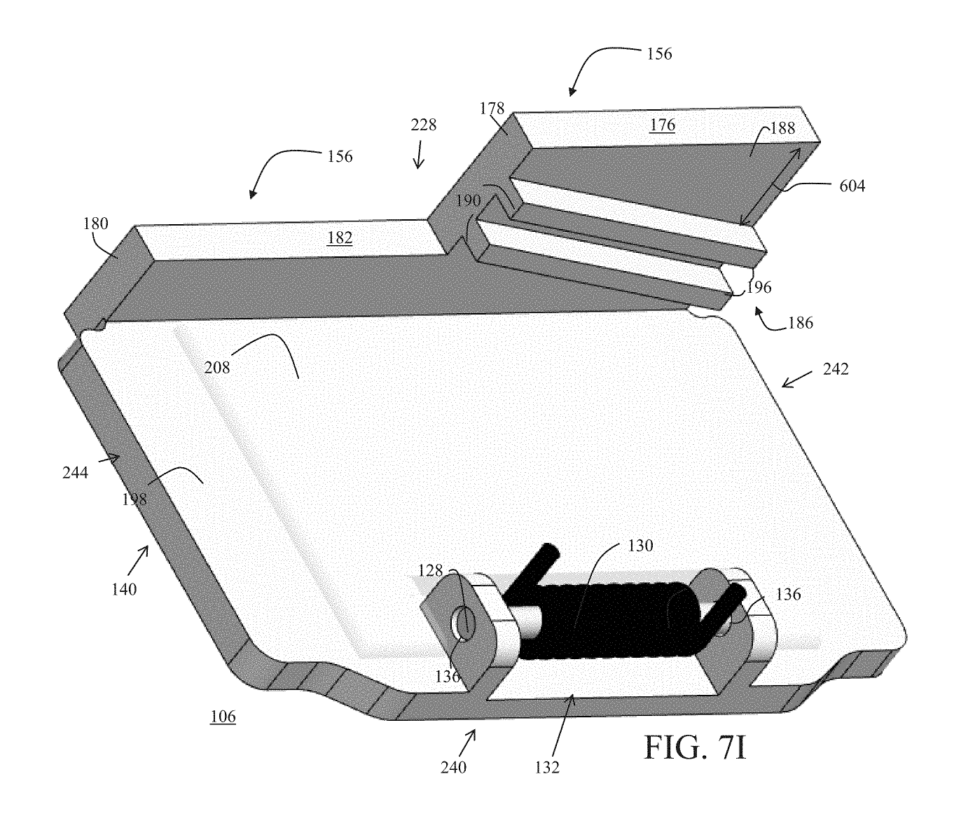

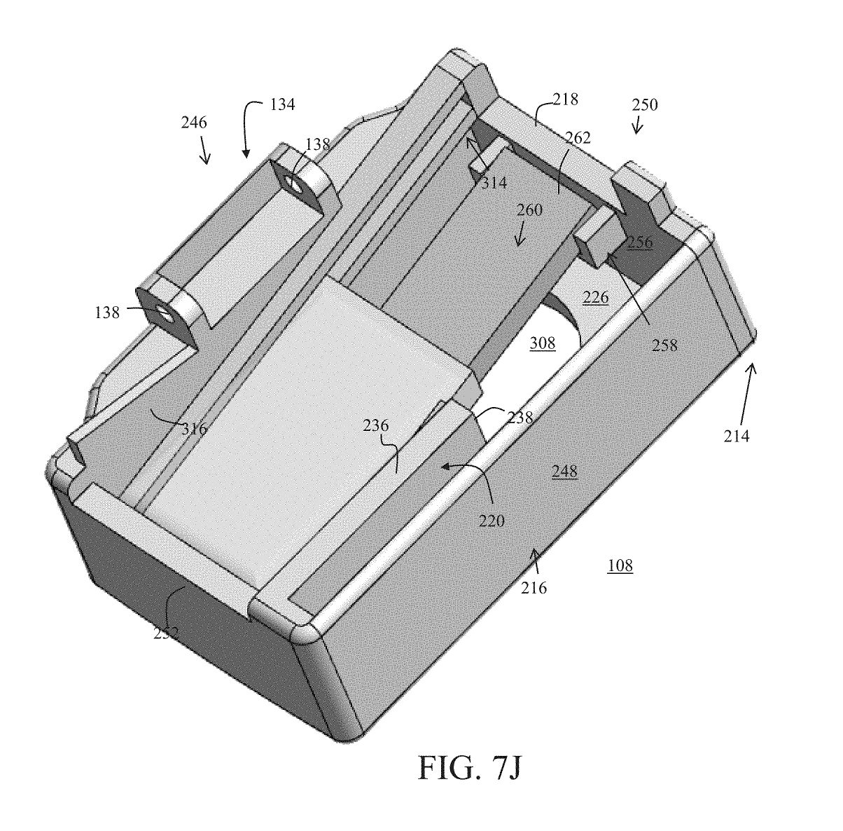

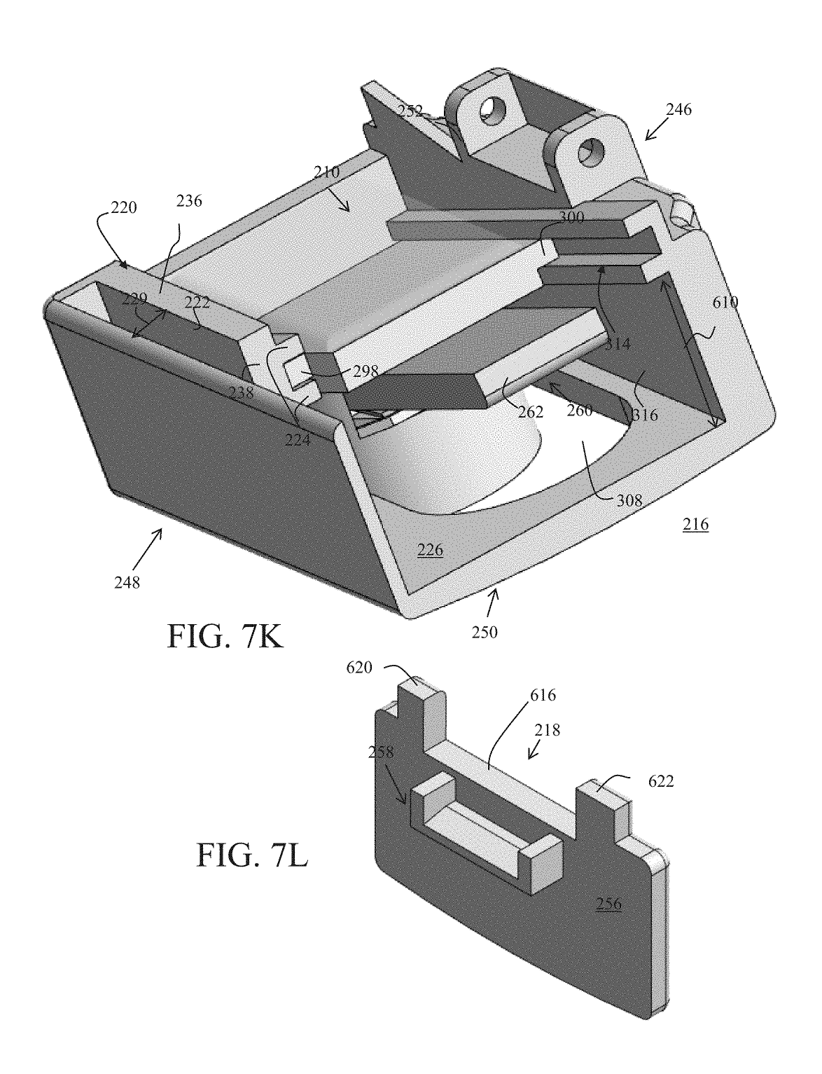

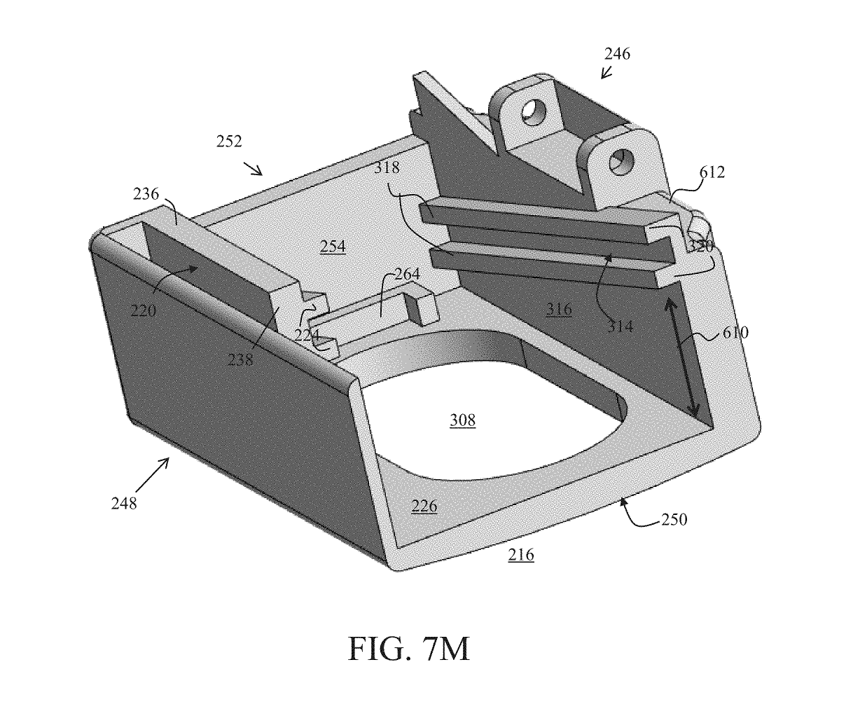

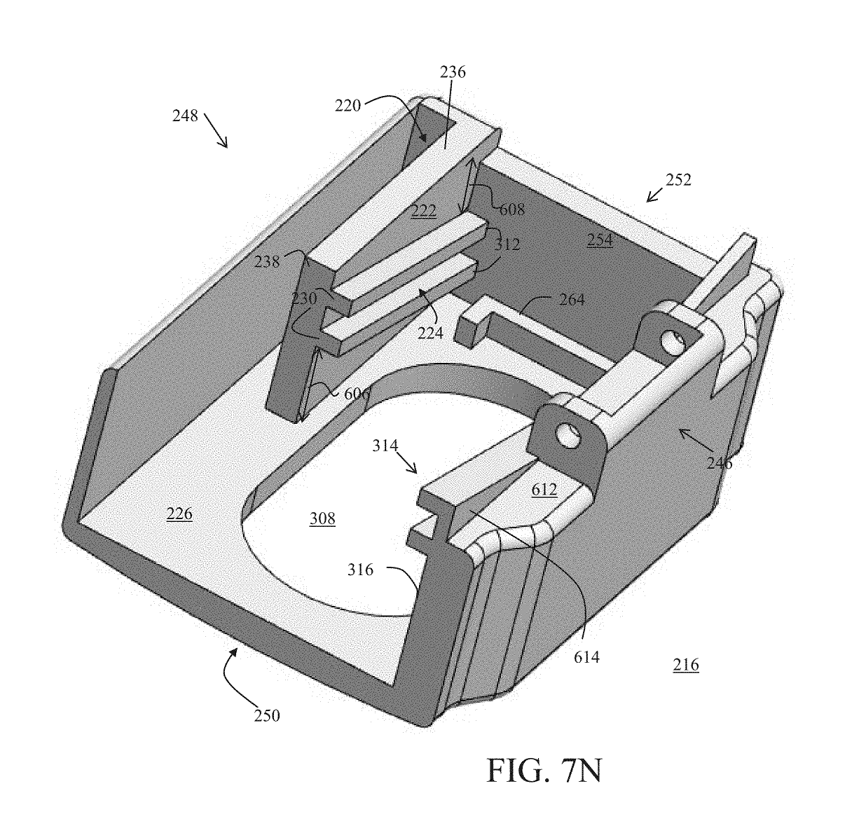

FIGS. 7A to 7N are non-limiting, exemplary illustrations of a theft deterrent tag in accordance with another embodiment of the present invention where the railing system is sloped at a steeper angle (has higher gradient) to thereby enable a greater range of vertical adjustment (or locking range) between cover assembly and lock mechanism assembly as detailed below. Theft deterrent tag 100c illustrated in FIGS. 7A to 7N includes similar corresponding or equivalent components, interconnections, functional, operational, and or cooperative relationships as theft deterrent tags 100a and 100b that are shown in FIGS. 1 to 6C, and described above. Therefore, for the sake of brevity, clarity, convenience, and to avoid duplication, the general description of FIGS. 7A to 7N will not repeat every corresponding or equivalent component, interconnections, functional, operational, and or cooperative relationships that has already been described above in relation to tags 100a and 100b that are shown in FIGS. 1 to 6C.

As illustrated best illustrated in FIG. 7I, first set of parallel engagement bars 186 defining the set of interlocking guide rails are sloped at a greater angle (gradient), with ends 196 a distance 604 away from side 176, which is a greater span than that of distance 197 (FIG. 3C). In other words, first end 190 of interlocking guide rails 186 from unlock side 192 of theft deterrent tag 100c is at a much lower elevation and second end 196 of the interlocking guide rails 186 near lock side 194 of theft deterrent tag 100c is at a much higher elevation.

As detailed below, the greater sloped angle (higher gradient) of rail system provides a higher adjustable range of vertical locking positions (adjustable range of vertical spans) 626 (FIG. 7B) between cover assembly 106 and that of lock mechanism assembly 108 when cover assembly 106 is in a fully closed and locked position. For example, in theft deterrent tags 100a and 100b (FIGS. 1 to 6C), adjustable range of vertical span 106 (FIG. 2B) between cover assembly 106 and lock mechanism assembly 108 when cover assembly 106 is in a fully locked position may range from 0 mm to about 2.5 mm, whereas adjustability range of vertical span 626 for theft deterrent tag 100c is from 0 mm to about 4 mm. This greater range of adjustable locking position allows for securing eyewear 102 with much greater range of thicker (bulkier) templates 104.

As further illustrated in FIG. 7N, interior facing side 222 of interior wall 220 includes second set of parallel engagement bars 224 that define first set of support guide rails that are sloped at a greater angle (greater gradient), with ends 230 a distance 606 away from base 226, which is a greater span than that of distance 234 (FIG. 4G). That is, unlock end 312 of support guide rails 224 from unlock side 192 of theft deterrent tag 100c is at a much lower, first elevation 608 from base 226 of first piece 216, whereas lock end 230 of support guide rails 224 towards lock side 194 of theft deterrent tag 100c is at second, much higher elevation 606 from base 226 to match that of interlocking guide rails 186 when cover assembly is closed in relation to lock mechanism assembly to provide a continuous rail system for locking.

As best illustrated in FIG. 7M, housing assembly 214 for this embodiment also includes third set of parallel engagement bars 314 defining second set of support guide rails associated with interior facing side 316 of first side 246 of first piece 216 of housing assembly 214. Second set of support guide rails 314 are oriented parallel first set of supporting guide rails 224 and interlocking guide rails 186, with second set of support guide rails 314 forming second part of the guide rail system. Second set of support guide rails 314 slope from lower elevation end 318 at unlock side 252 to a much higher elevation end 320 (as shown by span 610) at lock side 250, parallel first set of supporting guide rails 224 and interlocking guide rails 186.

The greater elevation span 610 of second set of support guide rails 314 causes higher elevation end 320 thereof to partially extended above edge 612 of first or hinge side 246 of housing assembly 214, indicated by reference 614. When in closed position, the same occurs for cover assembly 106. That is, as illustrated in FIGS. 7D and best shown in 7E-2, greater elevation span 604 causes higher elevation end 196 of interlocking guide rails 186 to also partially extend above edge 616 of second or interlocking side 248 of housing assembly 214, indicated by reference 618. Partial extensions 614 and 618 are covered over by respective flanges 620 and 622 of edge 618 of second piece 218 otherwise, ends 196 and 320 would remain exposed even when cover assembly 106 is in a fully closed and locked position. Extended part 624 of above edge 612 of first or hinge side 246 of housing assembly 214 is for further protection against prying and tampering as well as for aesthetics.

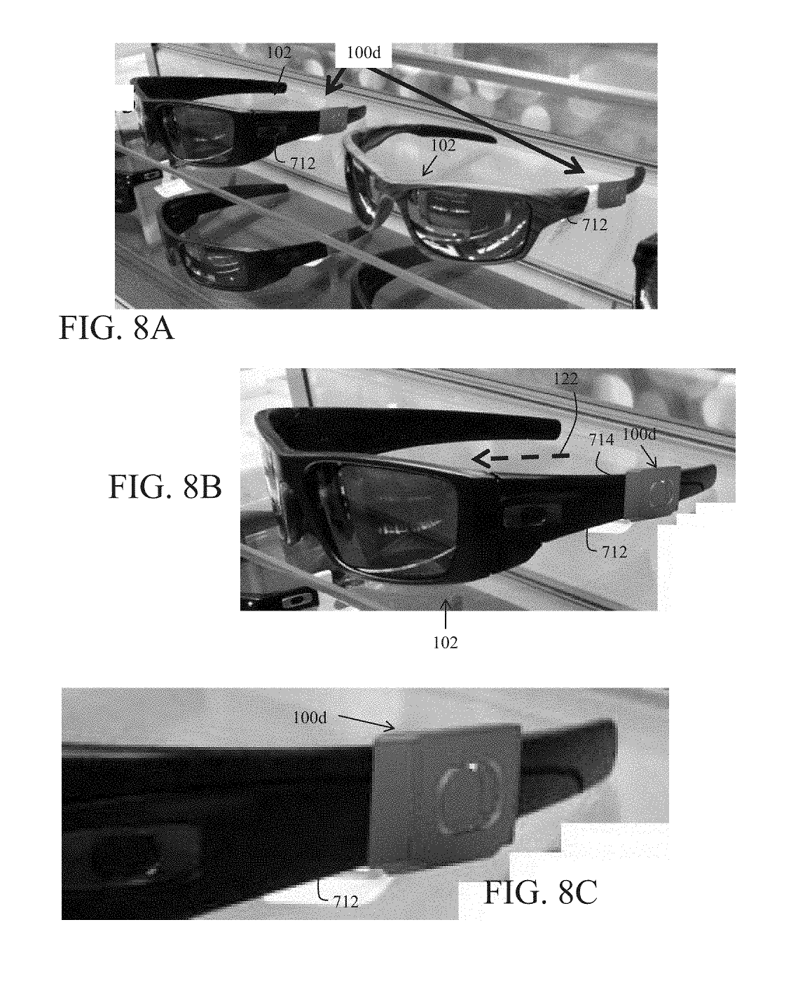

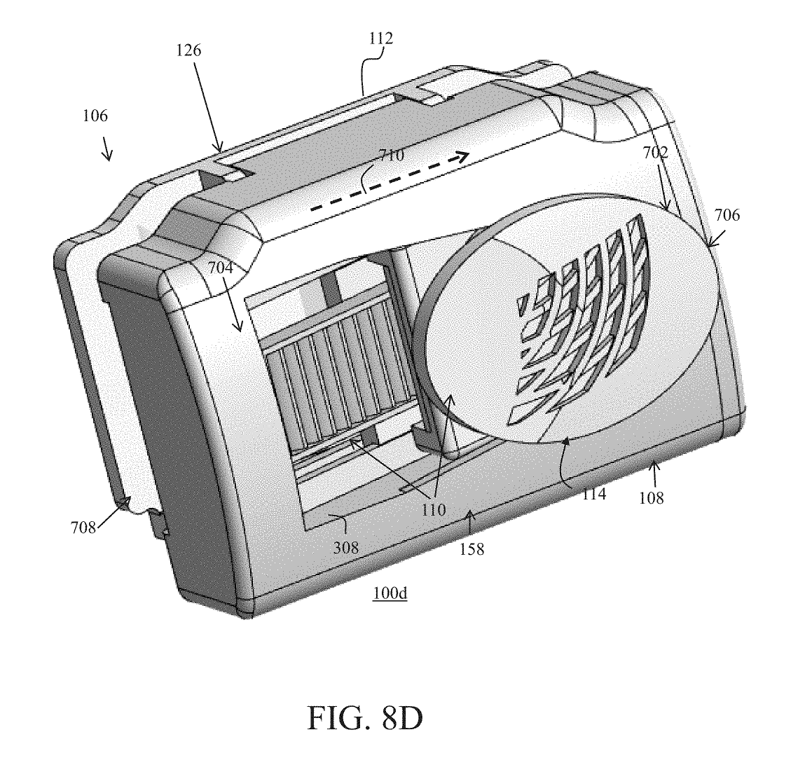

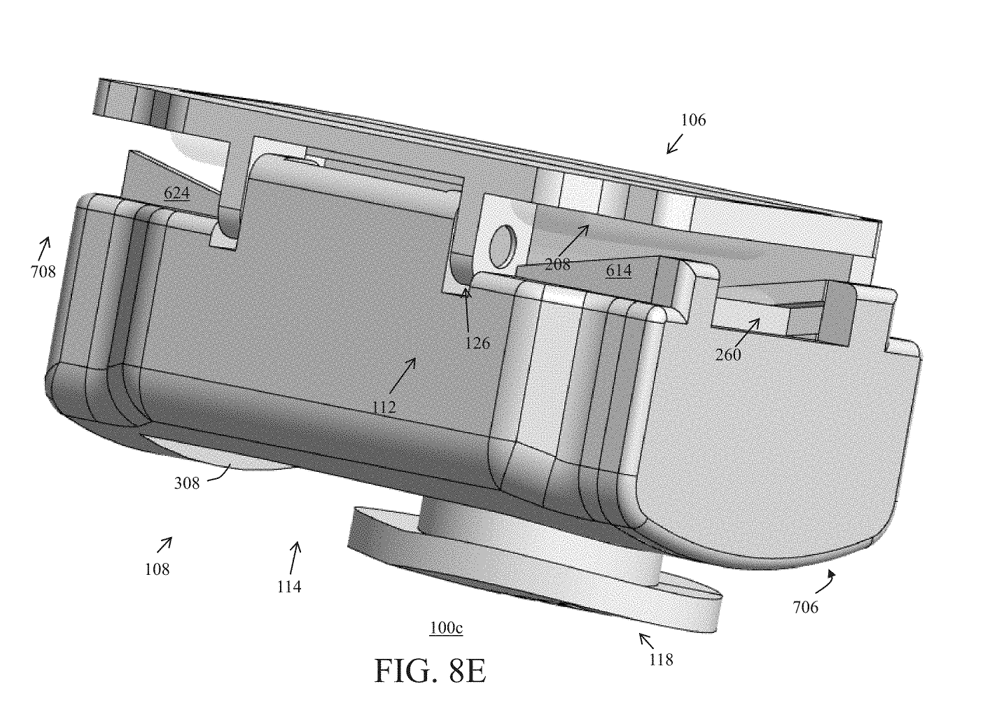

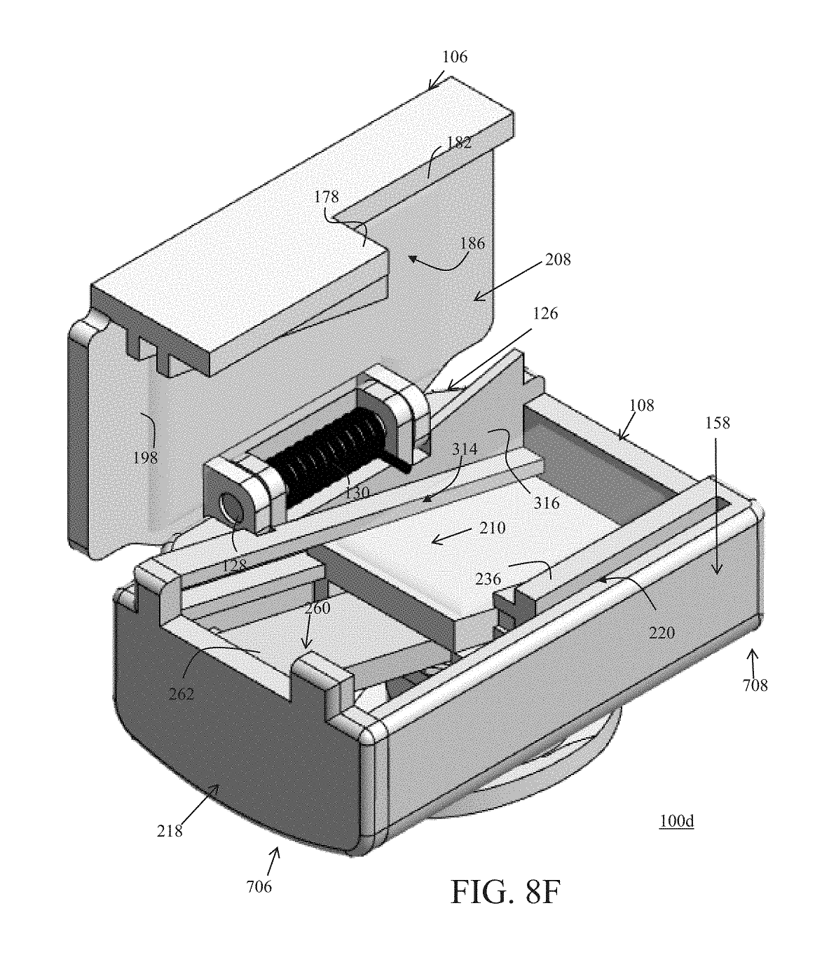

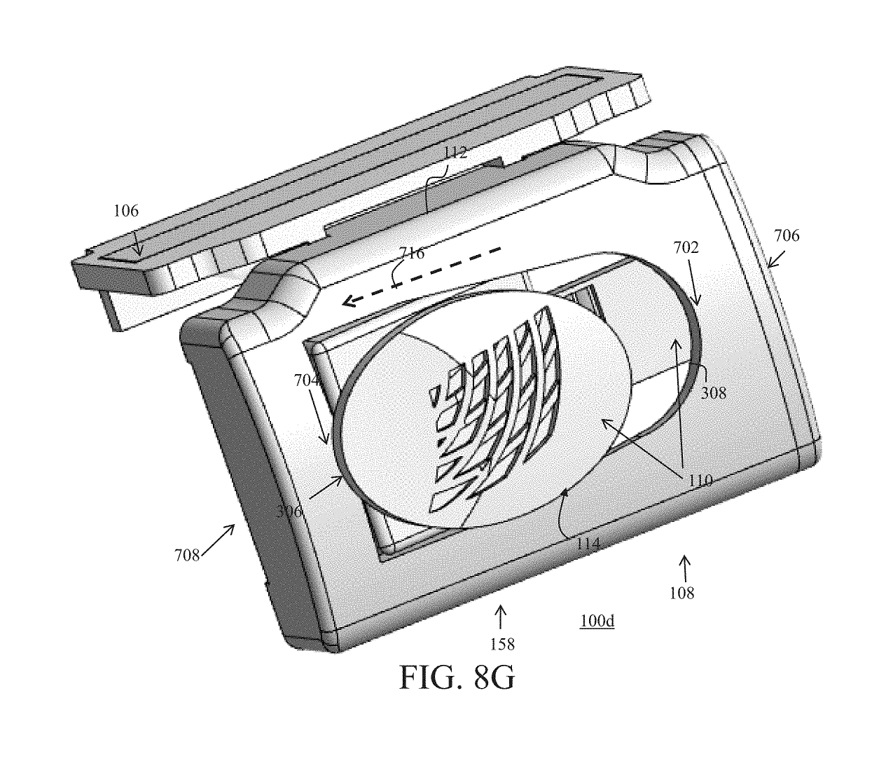

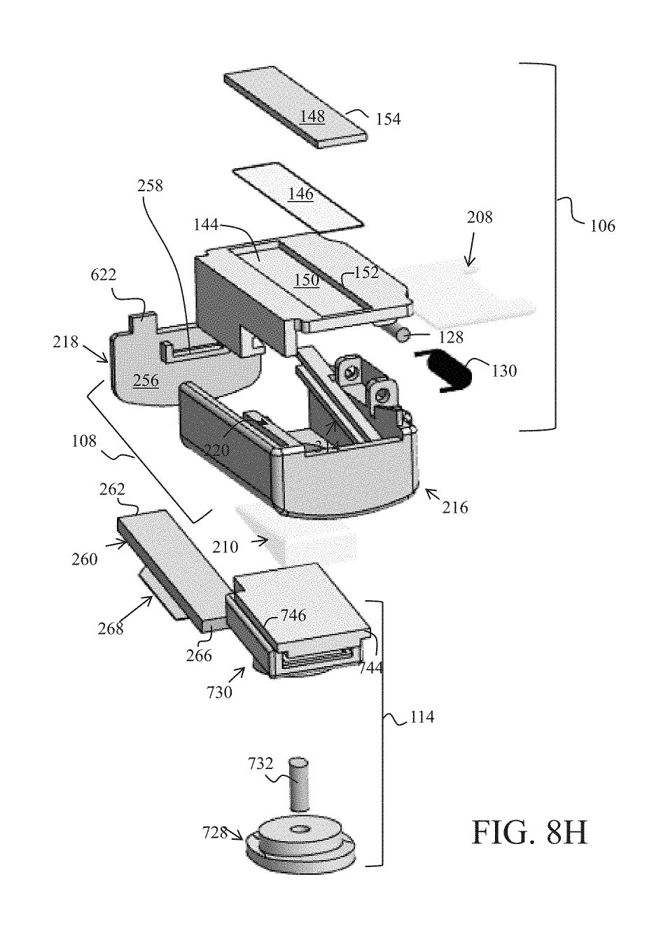

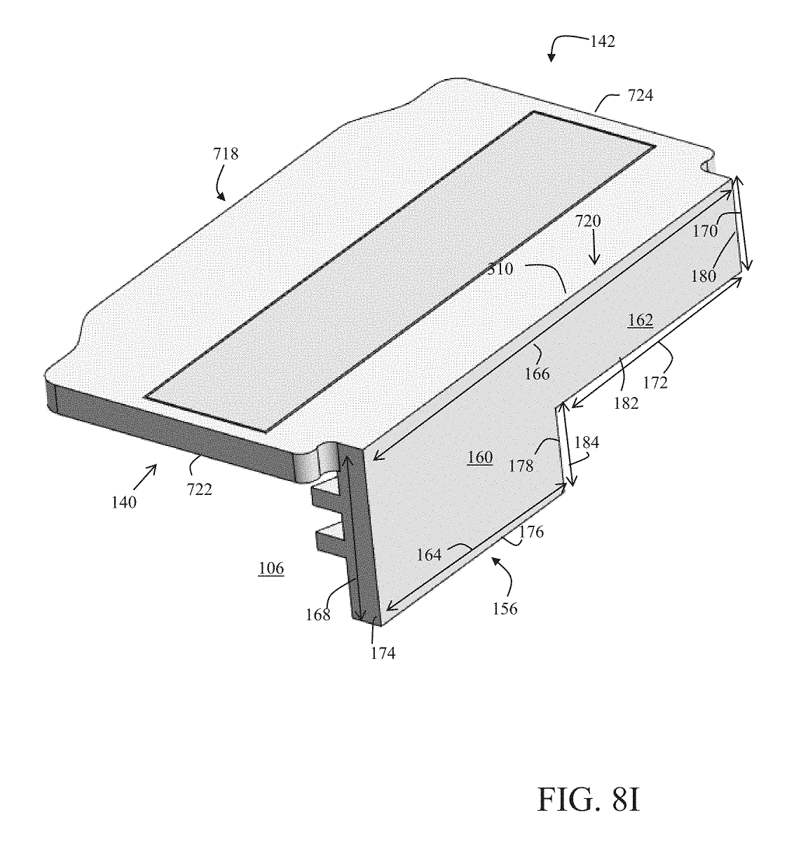

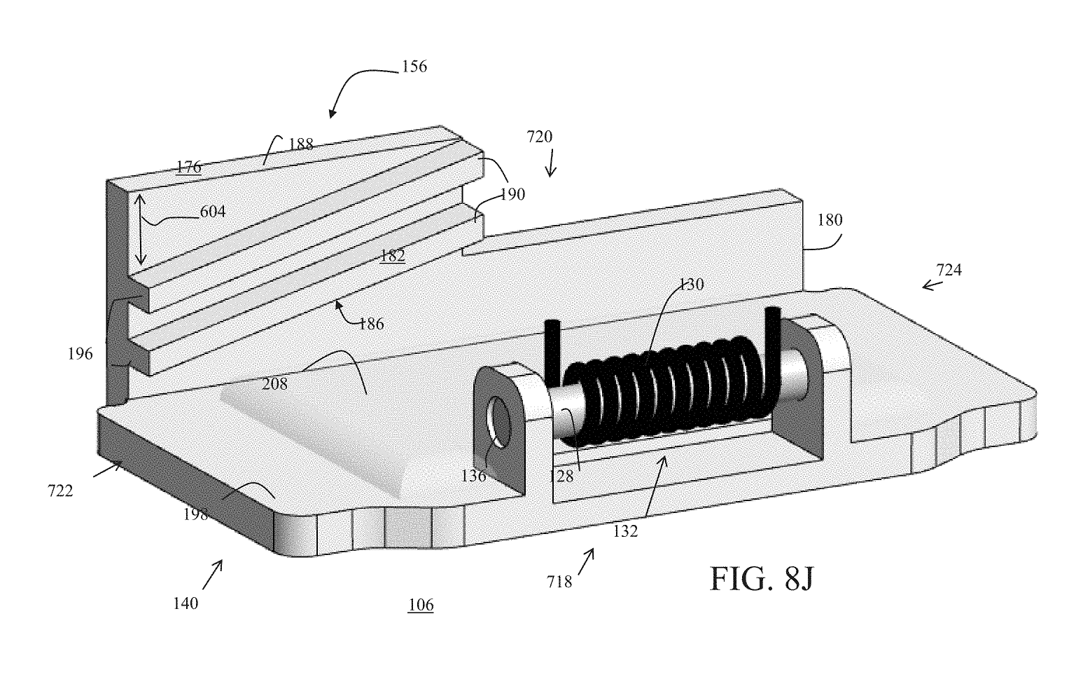

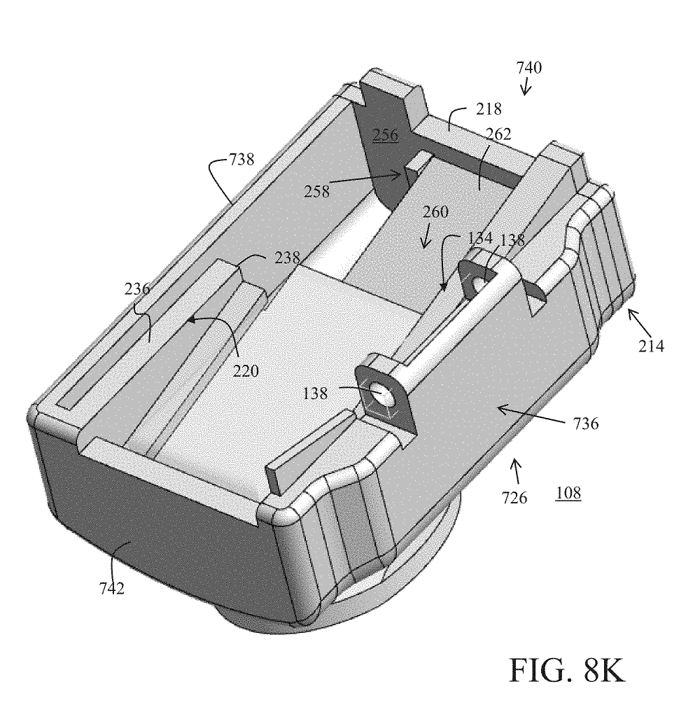

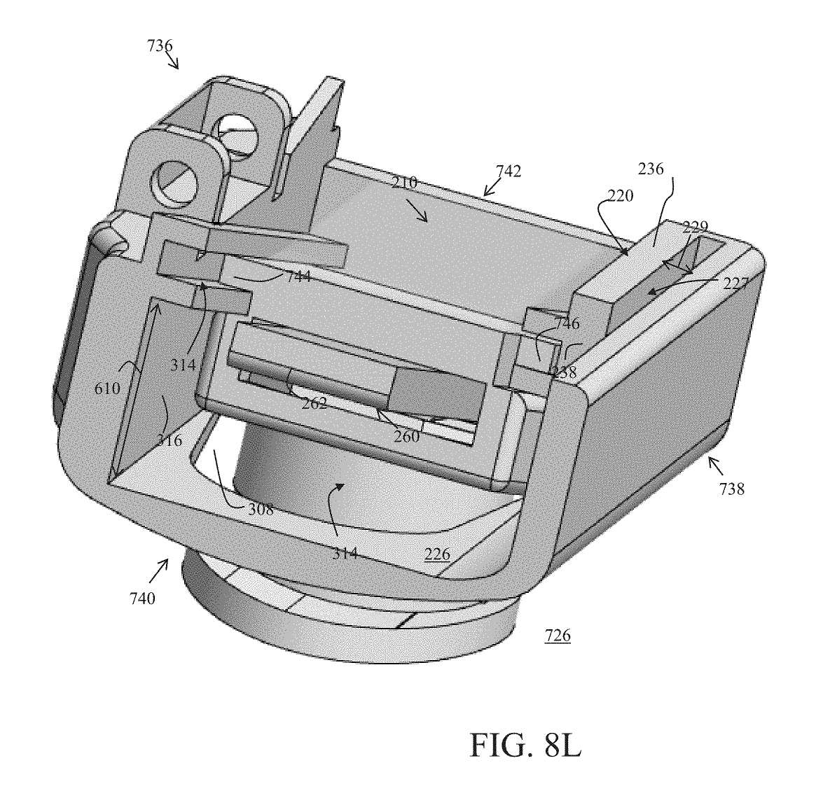

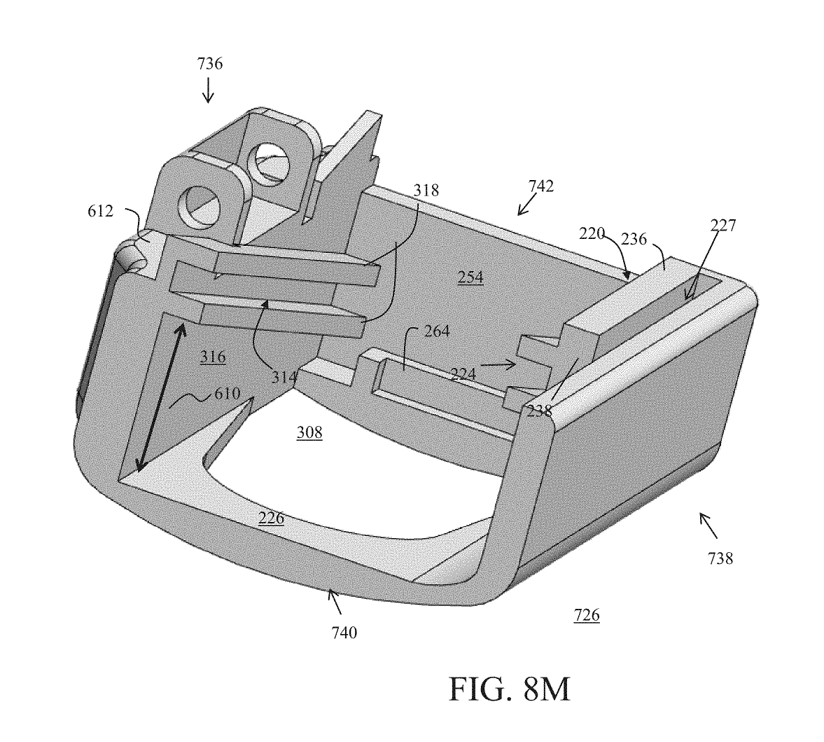

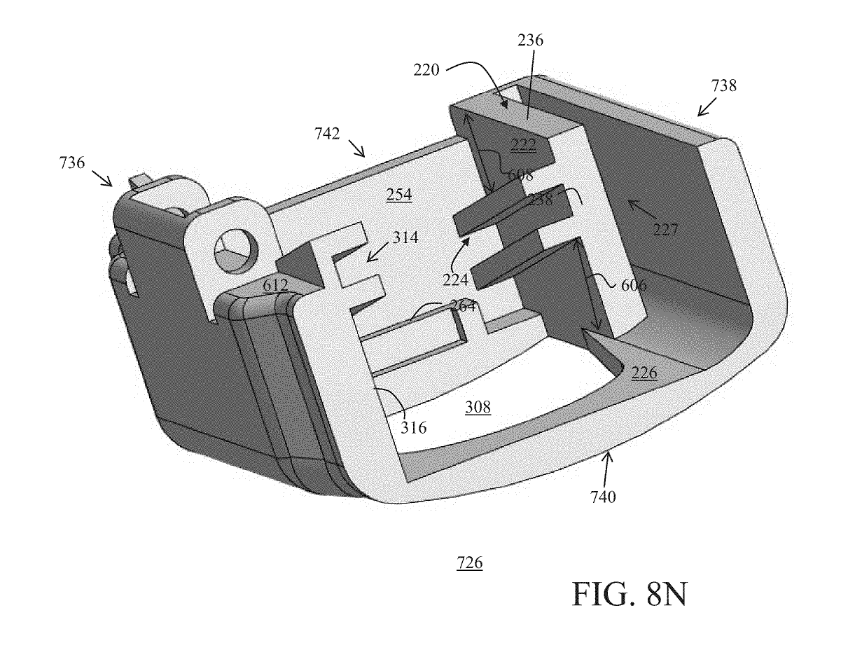

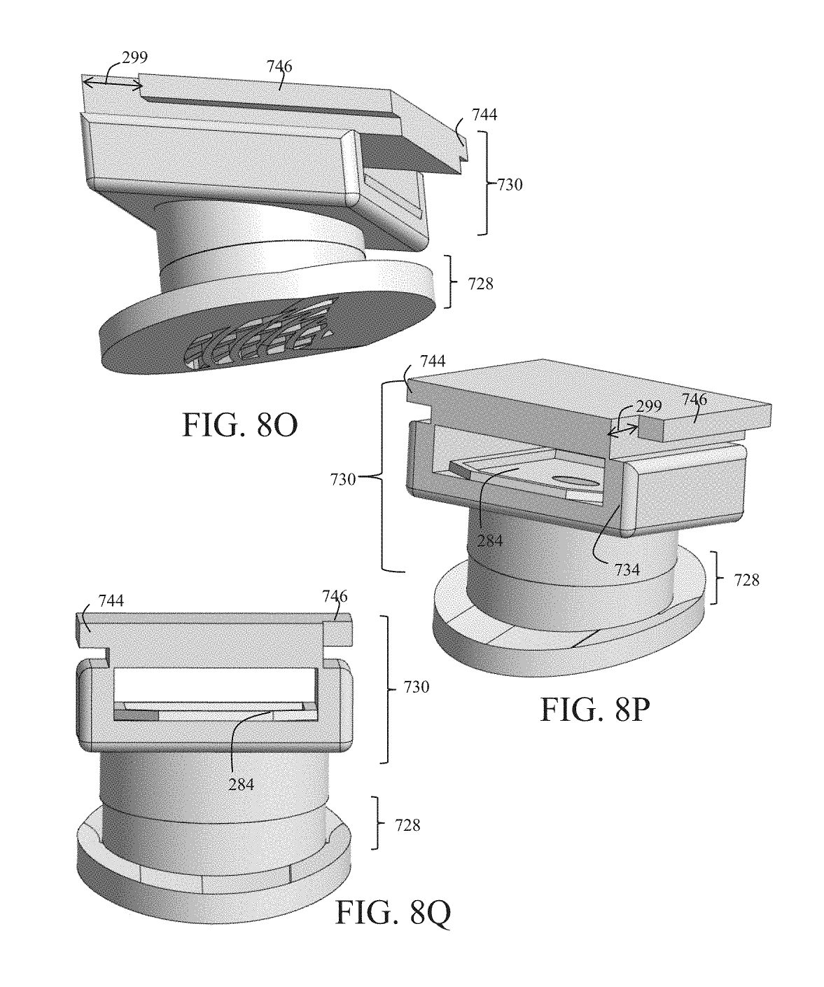

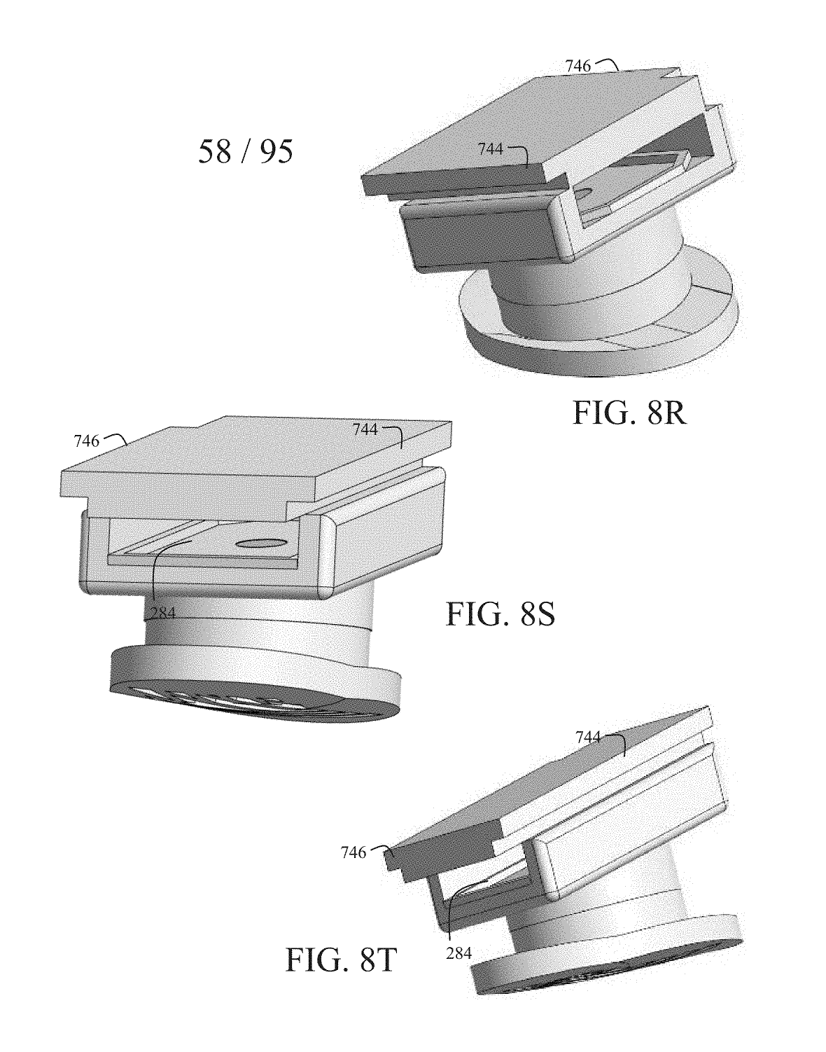

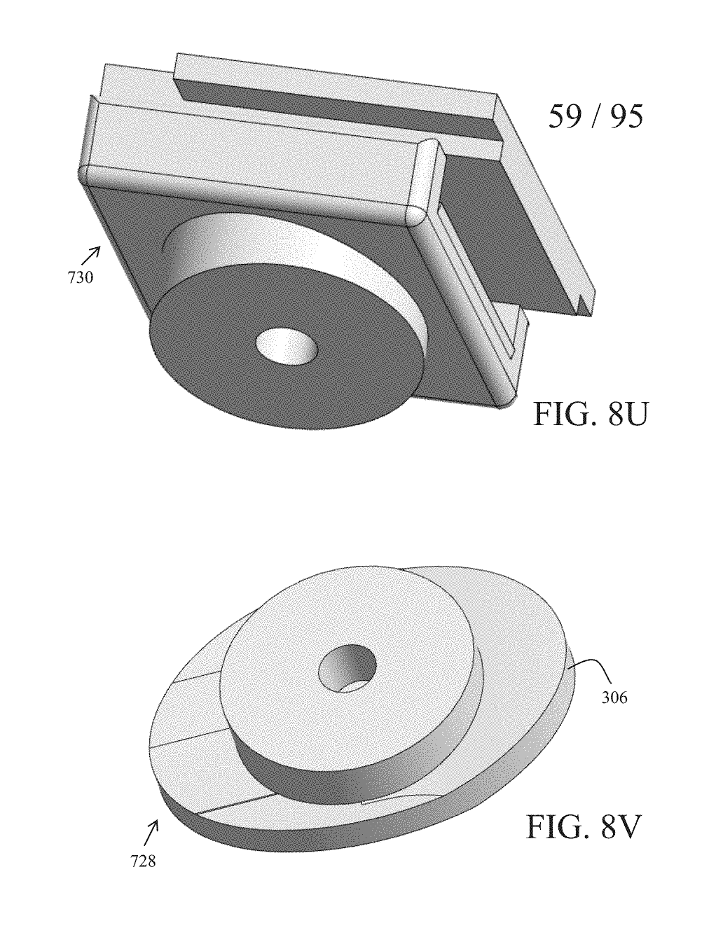

FIGS. 8A to 8V are non-limiting, exemplary illustrations of a theft deterrent tag in accordance with another embodiment of the present invention with lock side in the opposite position compared to theft deterrent tags 100a, 100b, and 100c. Theft deterrent device 100d illustrated in FIGS. 8A to 8V includes similar corresponding or equivalent components, interconnections, functional, operational, and or cooperative relationships as theft deterrent tags 100a, 100b, and 100c that are shown in FIGS. 1 to 7N, and described above. Therefore, for the sake of brevity, clarity, convenience, and to avoid duplication, the general description of FIGS. 7A to 7N will not repeat every corresponding or equivalent component, interconnections, functional, operational, and or cooperative relationships that has already been described above in relation to tags 100a, 100b, and 100c that are shown in FIGS. 1 to 7N.

In general, a preferred method of mounting a theft deterrent tag is on a left side template 712 of eyewear 102 (as opposed to right side template 104 shown in FIG. 1 for tags 100a, 100b, and 100c). Further, mounting of the tag is easier if hinge mechanism 126 is oriented to the bottom as illustrated in FIGS. 8A to 8C while cover assembly 106 is still maintained on interior facing side of left side template 712. Accordingly and as detailed below, theft deterrent tag 100d shown in FIGS. 8A to 8C locks in the opposite direction to meet the specific orientation and positioning of tag 100d to be mounted onto left side template 712 of eyewear 102 while maintaining self-locking feature (when eyewear is tampered to be forcefully pulled out of tag 100d, as detailed above in relation to tags 100a, 100b, and 100c).

Juxtaposing tag 100d illustrated in FIG. 8D with tag 100a in FIG. 2A and tag 100c in FIG. 7A where the tags are illustrated in the same orientation where their respective hinge mechanism 126 are shown on top provides a quick comparison of the lock position of their respective slider mechanism 114. As illustrated, tags 100a, 100b, and 100c lock at position 120 (towards the left side of the figure) and tag 100d shown in FIG. 8D locks at the opposite position 702 (towards the right side of the figure). In other words, lock position 702 at lock side 706 of tag 100d is at unlock position 118 at unlock side 192 of tags 100a, 100b, and 100c. Additionally, unlock position 704 (FIG. 8G) at unlock side 708 of tag 100d is at lock position 120 at lock side 194 of tags 100a, 100b, and 100c. As best illustrated in FIG. 8G, tag 100d is unlock when slider mechanism 114 is moved in the direction illustrated by arrow 716 to unlock position 704 at unlock side 708 of tag 100d.

The change in or (switching of) the lock position (or direction of travel of slider mechanism 114 as shown by arrow 710 to the changed lock position 702) enables tag 100d to be mounted onto left side template 712 of eyewear 102. Further, this change in lock position also enables hinge mechanism 126 to be oriented down (as shown in FIGS. 8A to 8C) and cover assembly 106 to be positioned at interior side 714 of left template 712. In general, since in retail price tags are placed on the left side, it is preferred to position a theft deterrent tag on the left side template 712 of eyewear 102 and hence, the use of theft deterrent tag 100d is preferred. It should be noted that although not shown, the optional benefit denial mechanism 200 illustrated in the previous embodiments may also be used in this non-limiting, exemplary embodiment.

As illustrated in FIGS. 81 and 8J, cover assembly 106 is comprised of a first (or hinge) side 718, a second or interlocking side 720, lock side 722, and unlock side 724, corresponding to first side 112, second side 158, lock side 706, and unlock side 708 of tag 100d. Juxtaposing lid 140 of tag 100d with those of tags 100a, 100b, and 100c would quickly show that the lock and unlock sides are in opposite positions and further, the set of interlocking guide rails 186 have an opposite slope orientation compared where tag.

As illustrated in FIGS. 8K to 8N, first piece 726 of housing assembly 214 is similar to first piece 216 of housing assembly 214 with the exception that various parts of first piece 726 are the inverse of various parts of first piece 216. That is, various parts of first piece 726 are positioned or switched to opposite or reverse sides of the various parts of first piece 216. This results in theft deterrent tag 100d operating similar to tags 100a, 100b, and 100c but allowed tag 100d be mounted on left side template 712 of eyewear instead of right side template 104. For example, juxtaposing lock mechanism assembly 108 shown in FIGS. 8K for tag 100d with those illustrated in FIGS. 4A, 6A, and 7J of tags 100a, 100b, and 100c would quickly reveal that lock mechanism assembly hinge structures 134 although identical for both first piece 726 and first piece 216, are positioned in the opposite sides of the respective first pieces 726 and 216. As another example, juxtaposing first piece 726 of lock assembly 214 of tag 100d shown in FIGS. 8K to 8N with first piece 216 of lock assembly 214 of tags 100a, 100b, and 100c shown in FIGS. 4A to 5A, 6A, and 7J to 7N would also quickly show that the set of interlocking guide rails 186, first set of support guide rails 224, and second set of support guide rails 314 are sloped in the opposite orientation for tag 100d. That is, although for all tags 100a, 100b, 100c, and 100d the higher elevated ends of the rails are at the lock side, since the lock side for the tag 100d is in the opposite end (compared with tags 100a, 100b, and 100c), the higher elevated ends of the rails for tag 100d are flipped (inversed) compared to tags 100a, 100b, and 100c. Rails of theft deterrent tag 100d have the same elevated or degree of slope or gradient as those shown for tag 100c. As illustrated in FIGS. 8K to 8N, first piece 726 of housing assembly 214 of tag 100d is comprised of a first (or hinge) side 736, a second or interlocking side 738, lock side 740, and unlock side 742, corresponding to first side 112, second side 158, lock side 706, and unlock side 708 of tag 100d.

As best illustrated in FIGS. 8O to 8V, theft deterrent tag 100d also includes slider mechanism 114, which is comprised of a bottom piece 728, a top piece 730, and a connector 732 (best show in FIG. 8H) in a form of a non-limiting, exemplary dowel that connects bottom piece 728 to top piece 730. Bottom piece 728 (the grip part) is generally made wider and longer (compared to slider mechanism 114 of tags 100a, 100b, and 100c) for a better grip. Accordingly, slider mechanism 114 of tag 100d is divided into bottom and top pieces 728 and 730 for assembly onto tag 100d otherwise, bottom piece 728 would not fit through opening 308 of first piece 726 of housing assembly 108 of tag 100d. In general, bottom piece 728 of slider mechanism 114 is connected with top piece 730 by dowel 732 after all other components of tag 100d are fully assembled. A non-limiting example of connecting (assembling) slider mechanism pieces is by sonic welding of the pieces.

As further illustrated in FIGS. 8O to 8V, top piece 730 is similar to top portion 302 of slider mechanism 114 of tags 100a, 100b, and 100c, but with portion indicated as 330 (FIGS. 5E and 5G) removed, providing greater vertical space between cover assembly 106 and lock mechanism assembly 108 for tag 100d. The removal of portion 330 also reduces the overall height of slider mechanism (reducing the overall thickness of the tag 100d by about 1 mm) and also reduces the overall weight of tag 100d. Juxtaposing FIGS. 8O to 8V with FIGS. 5B to 5G would quickly reveal that lateral flanges 744 and 746 of tag 100d provide the same function for operating slider mechanism 114 of tag 100d as with previously disclosed flanges 298 and 300, with flange 744 having longer span 299, the same as flange 300 (but in opposite position).

Walls 734 of compartment 284 for housing clip 268 is bulked laterally (which would not affect the overall height of slider mechanism 114 of tag 100d), but improve the overall structural integrity of the slider by improving its strength. This way, a smaller-form or shape of tag 100d is achieved, which is also lighter in weight and would not contact users face whey trying on an eyewear 102 with the mounted tag 100d.

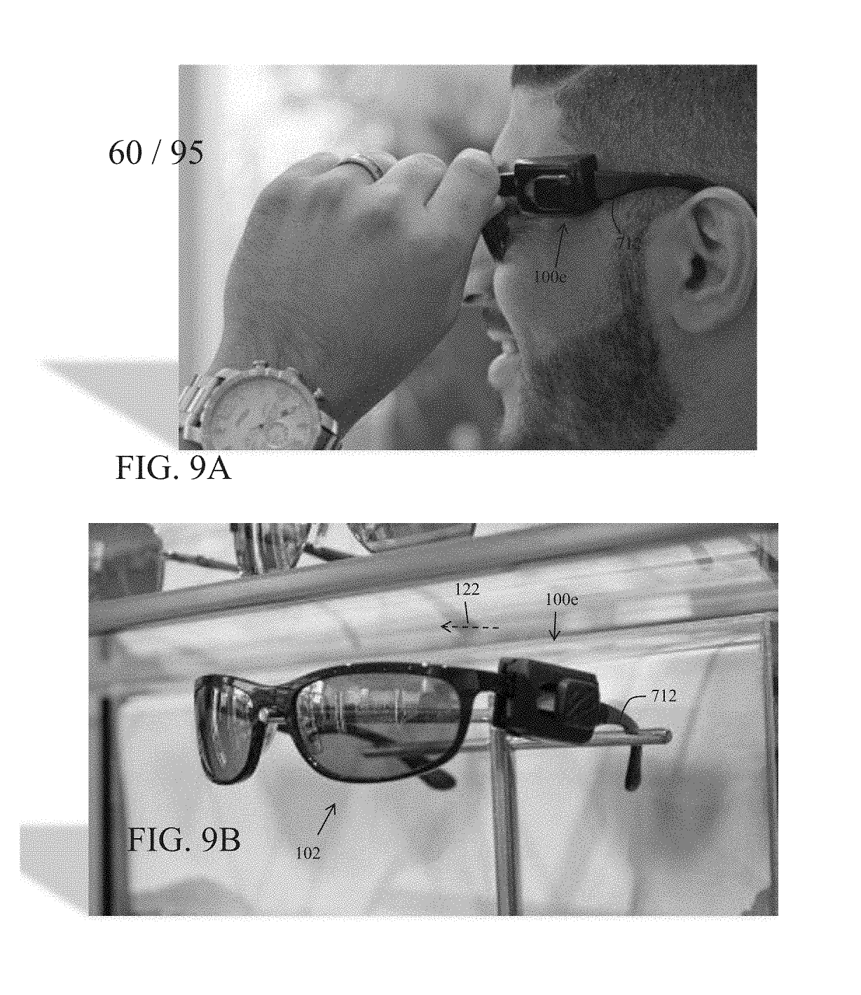

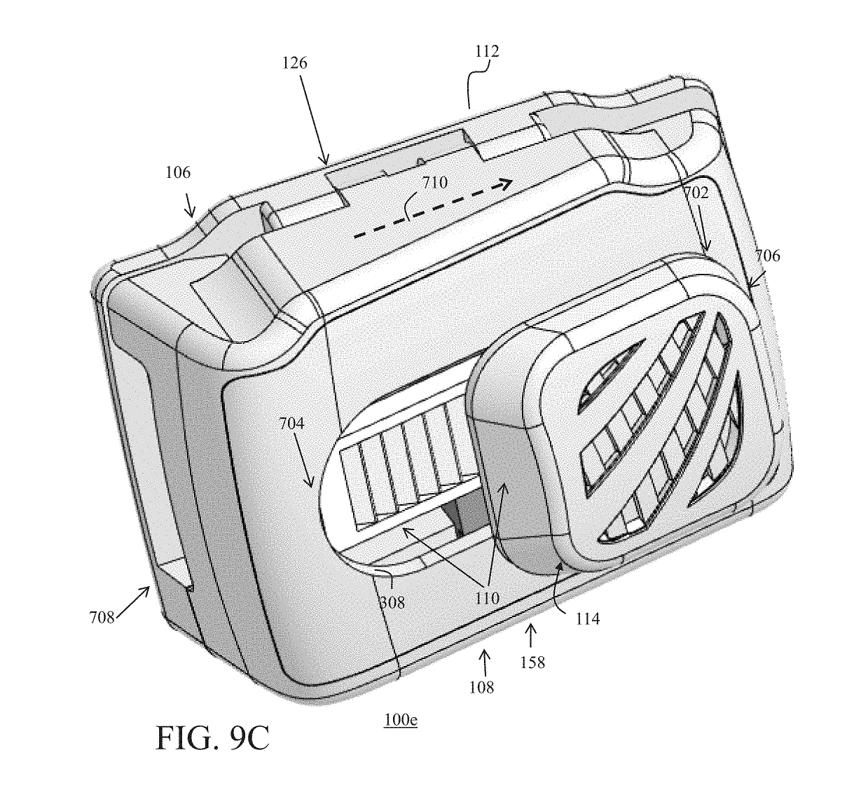

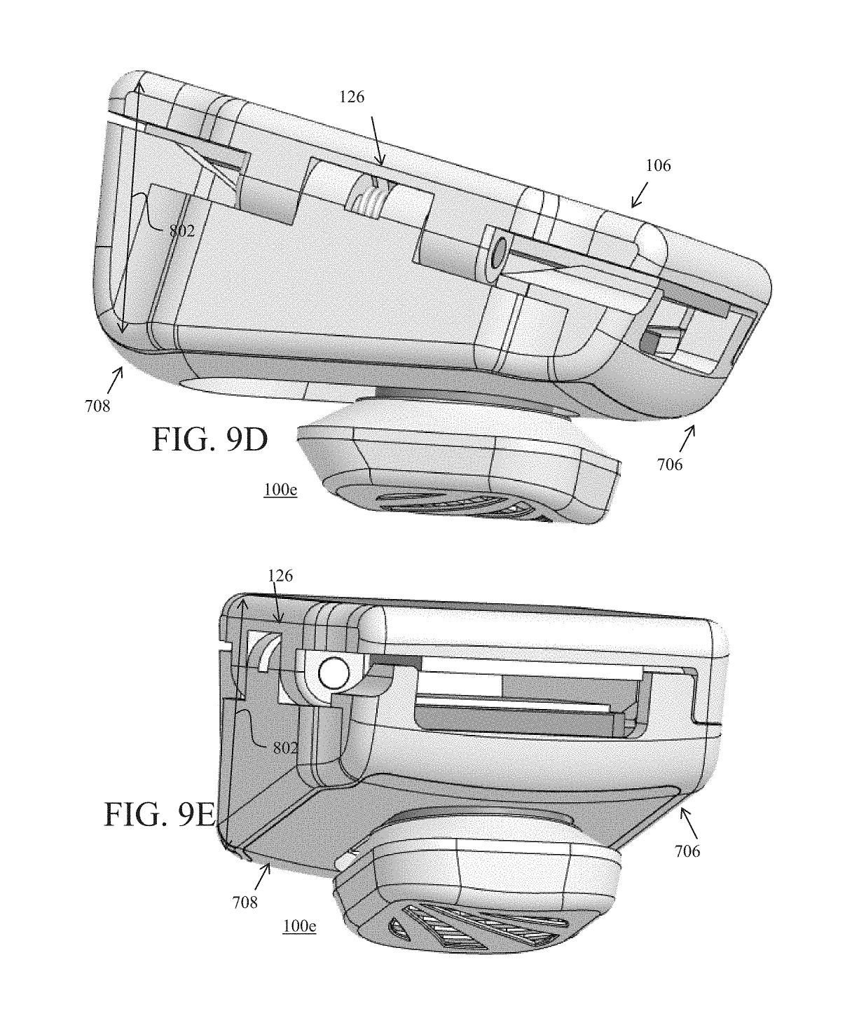

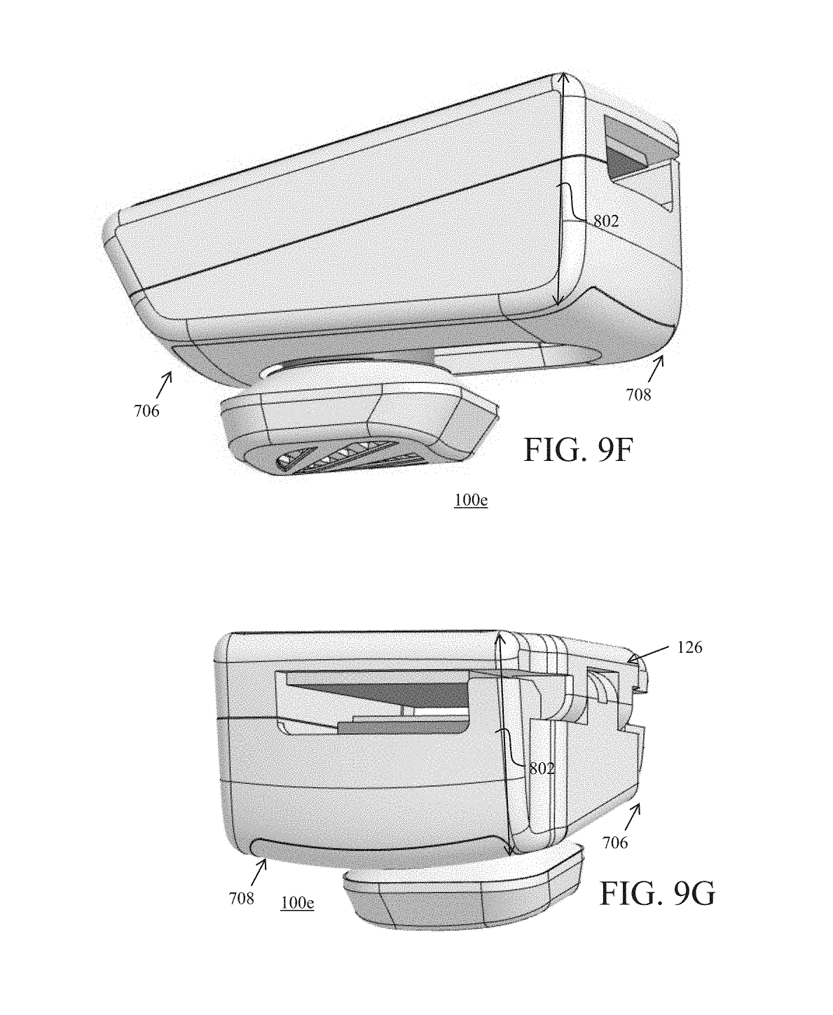

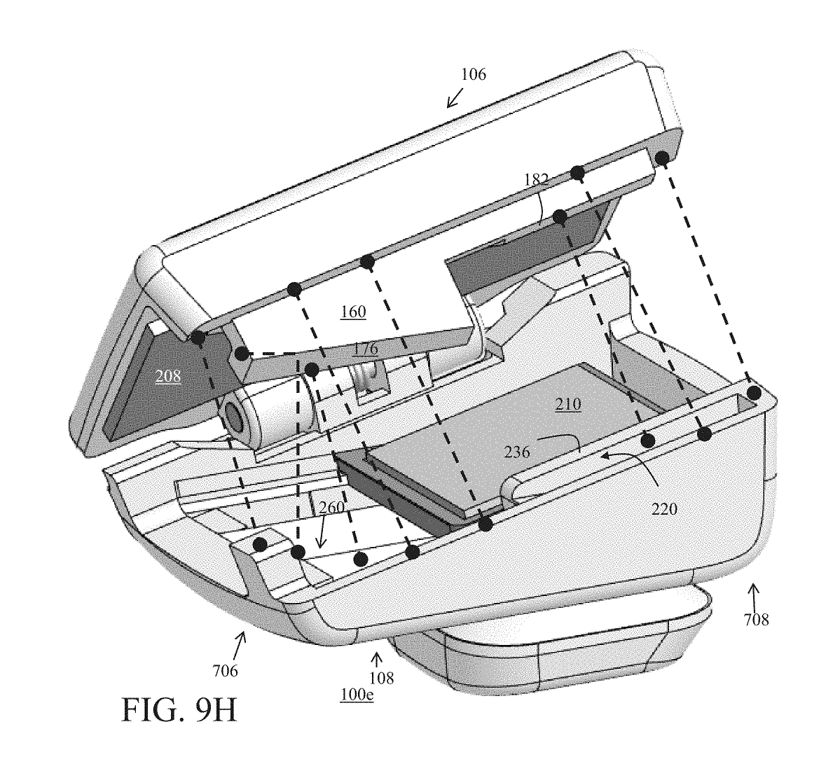

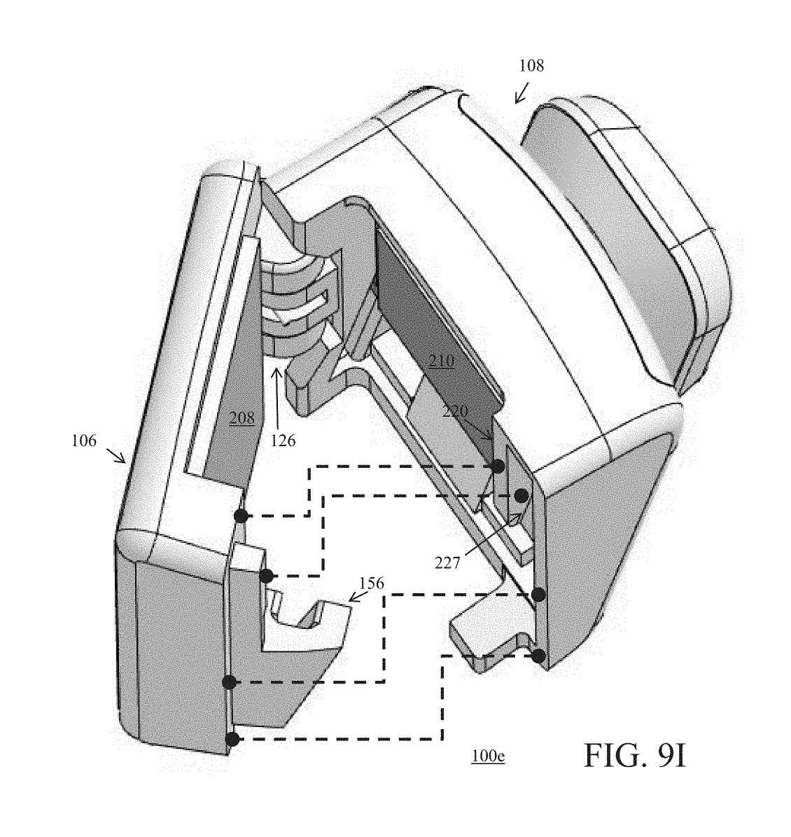

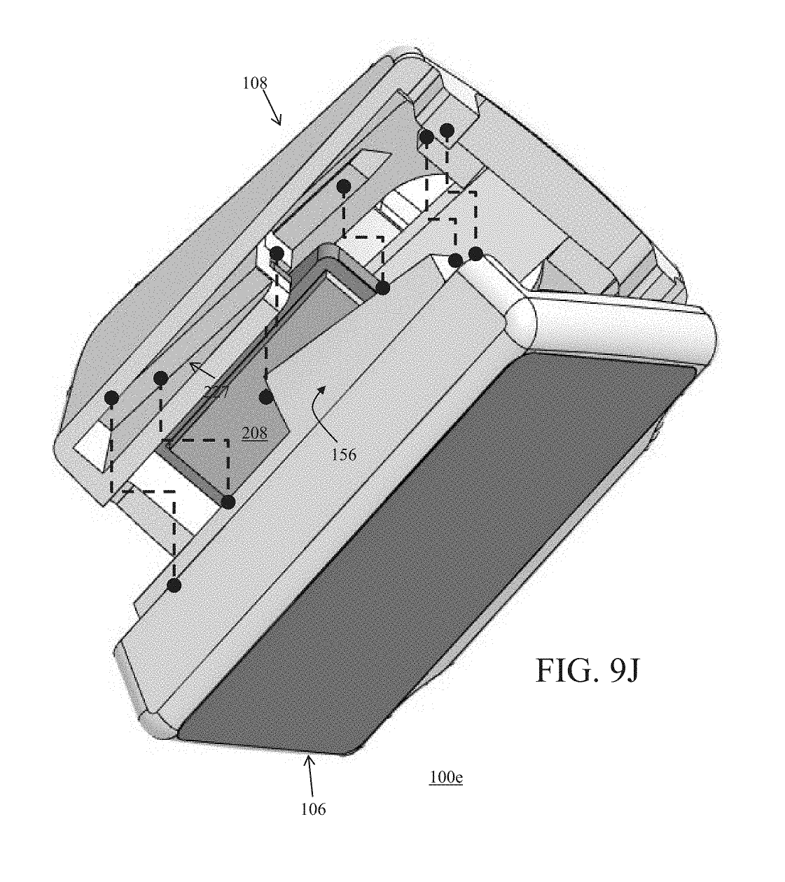

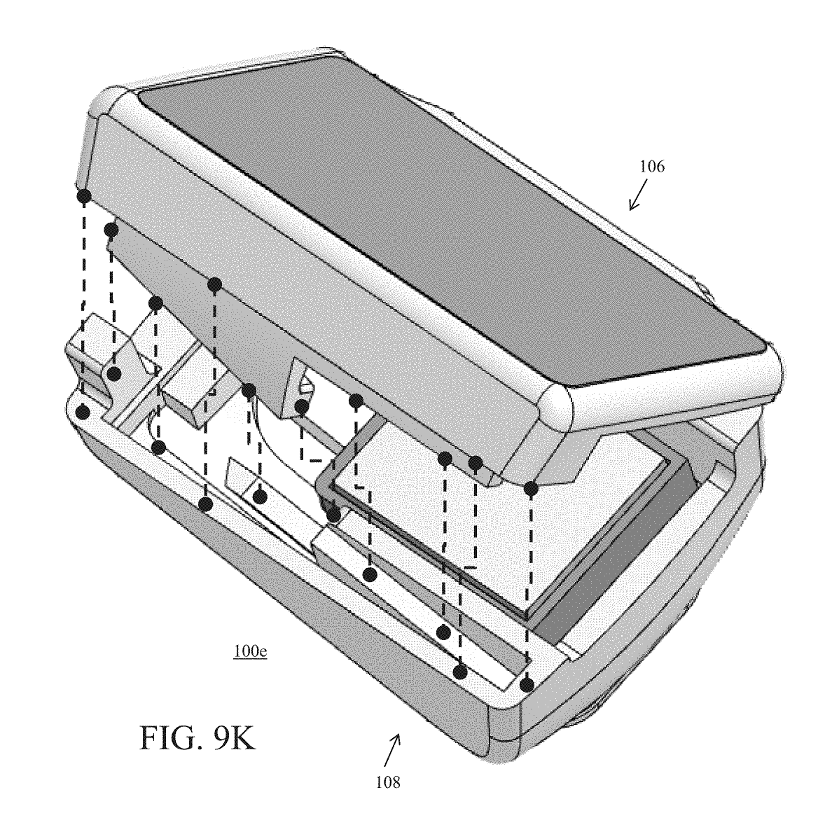

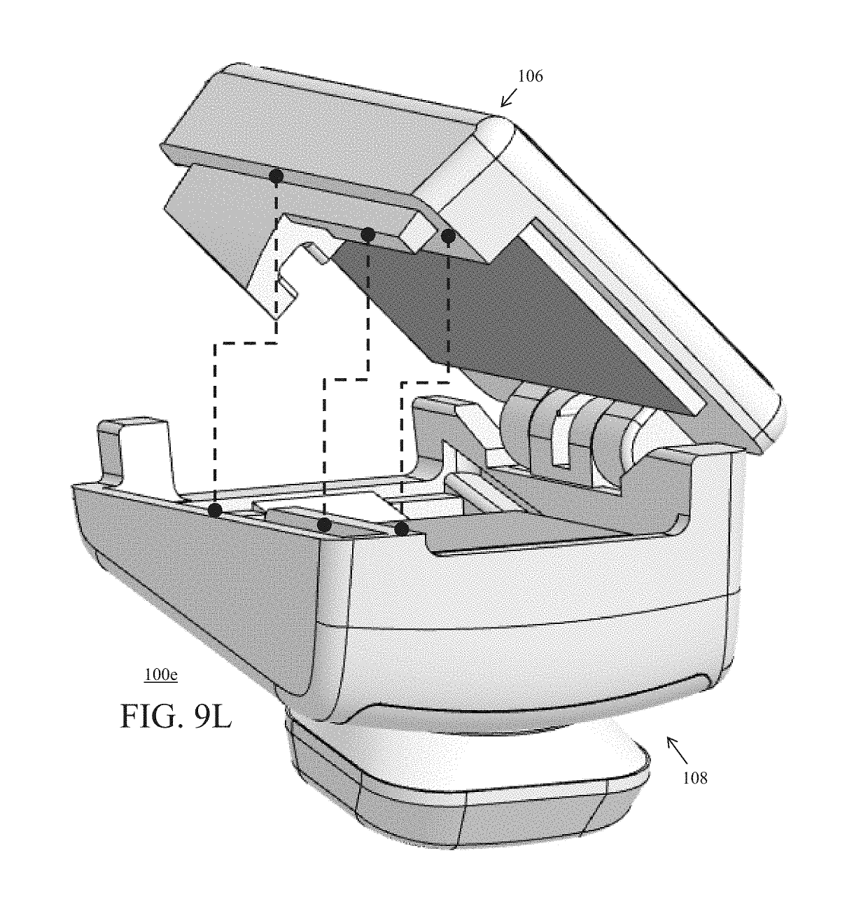

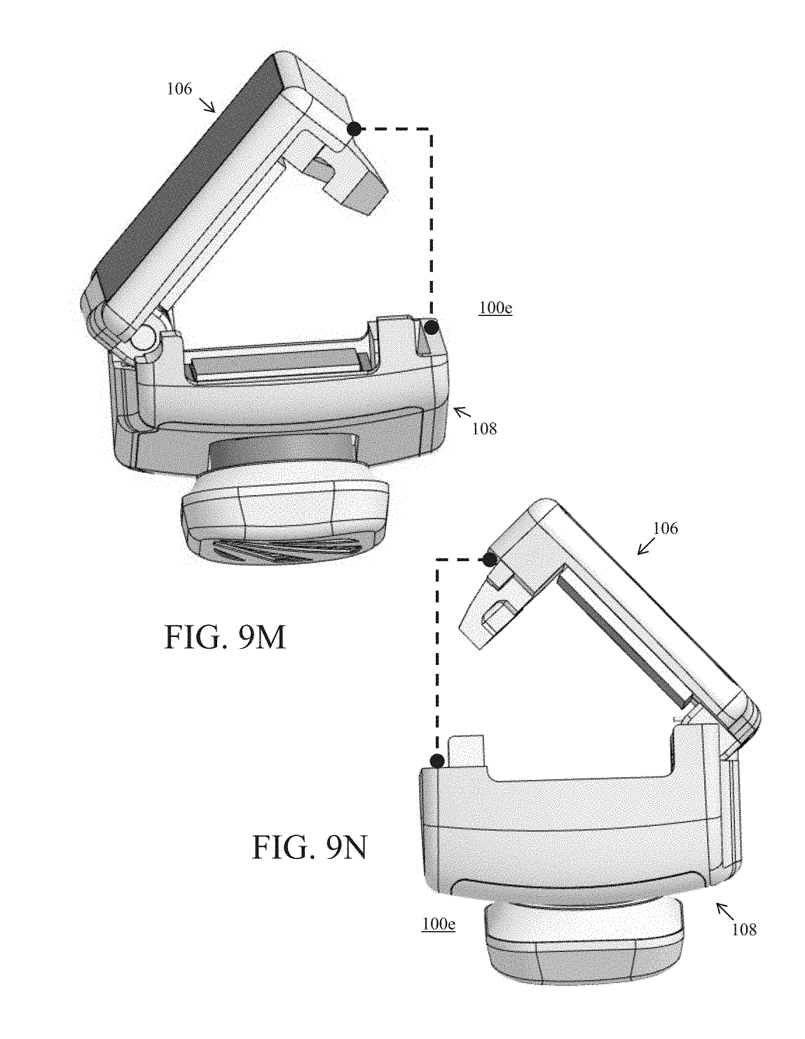

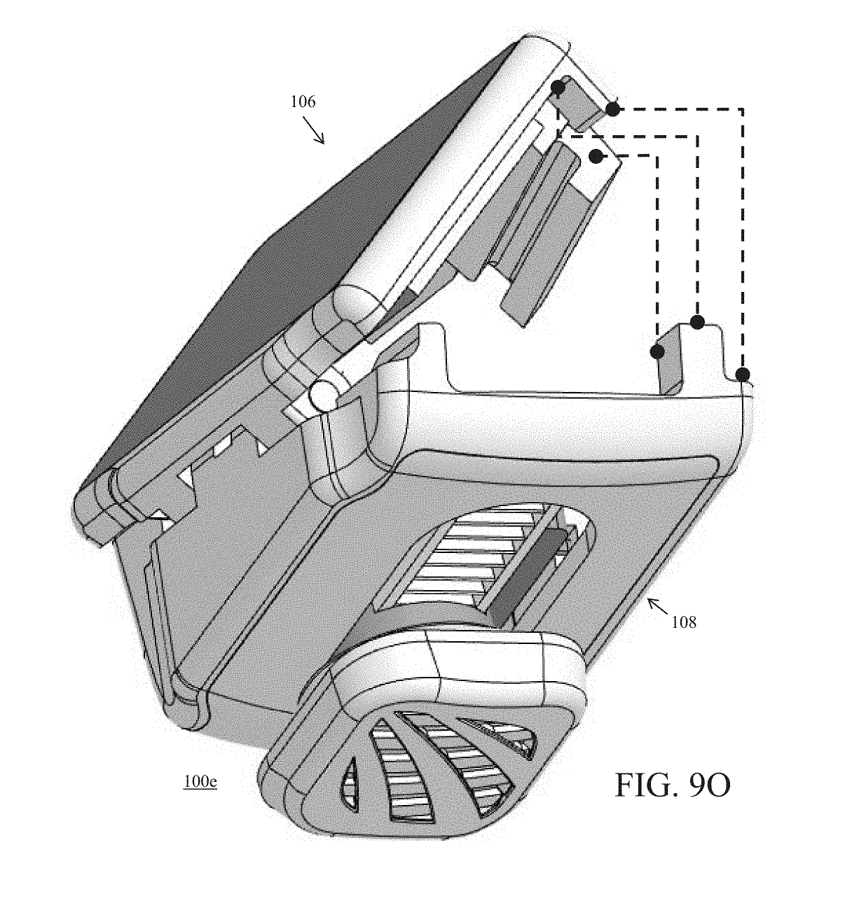

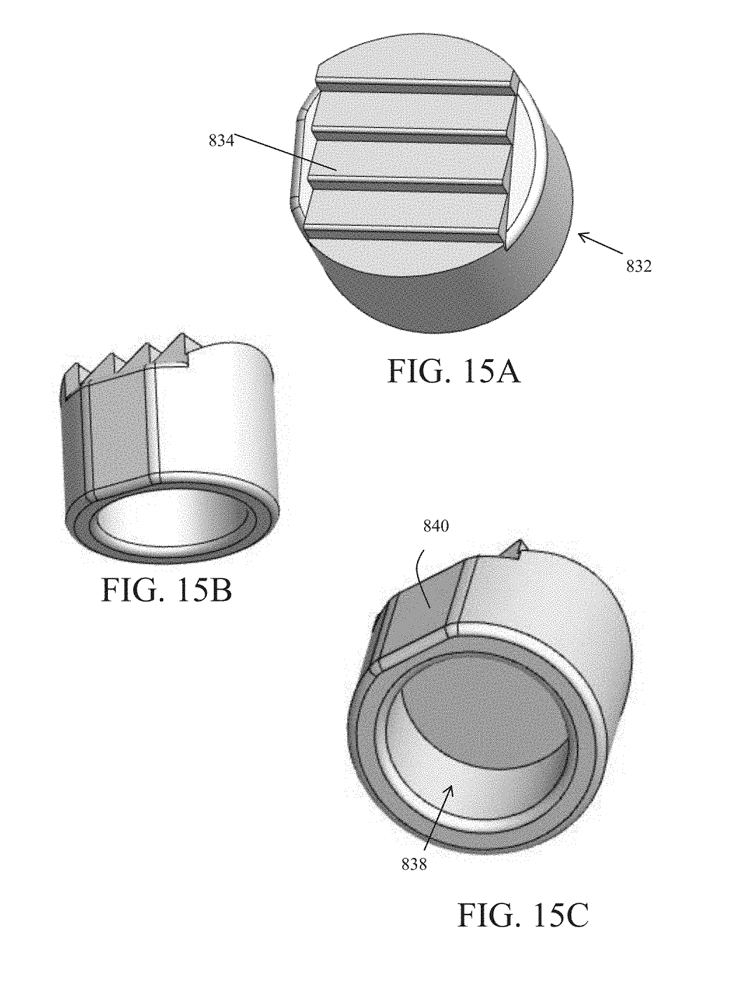

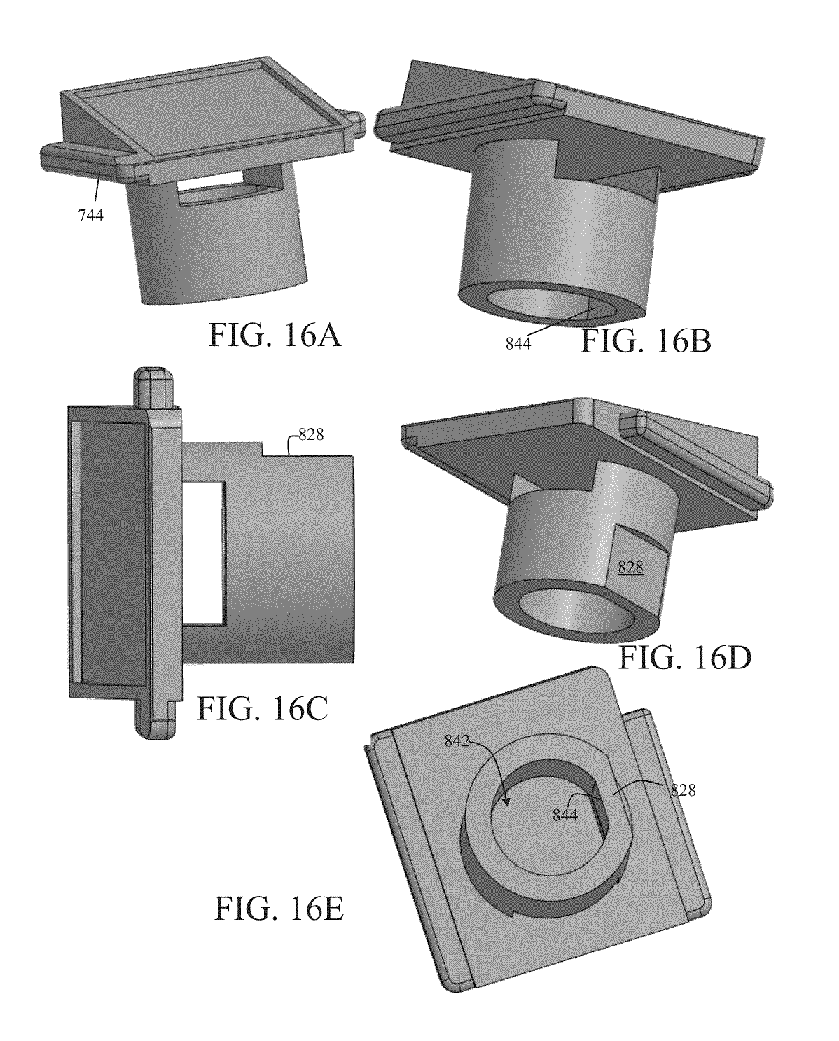

FIGS. 9A to 16E are non-limiting, exemplary illustrations of a theft deterrent tag 100e in accordance with another embodiment of the present invention include modification for a more efficient and streamlined manufacturing and molding processes of tag 100e, in addition to further reducing weight and ease of mounting and dismounting of tag 100e from eyewear 102. Theft deterrent device 100e illustrated in FIGS. 9A to 16E includes similar corresponding or equivalent components, interconnections, functional, operational, and or cooperative relationships as theft deterrent tags 100a, 100b, 100c, and 100d that are shown in FIGS. 1 to 8V, and described above. Therefore, for the sake of brevity, clarity, convenience, and to avoid duplication, the general description of FIGS. 9A to 16E will not repeat every corresponding or equivalent component, interconnections, functional, operational, and or cooperative relationships that has already been described above in relation to tags 100a, 100b, 100c, and 100d that are shown in FIGS. 1 to 8V.

As illustrated in FIGS. 9A and 9B, theft deterrent tag 100e is also designed to be mounted in the same mounting orientation as tag 100d. That is, tag 100e is also mounted on left side template 712 of eyewear 102, with cover assembly 106 oriented at inner side 714 of template 712, and hinge mechanism 126 oriented at bottom. It should be noted that although not shown, the optional benefit denial mechanism 200 illustrated in the previous embodiments may also be used in this non-limiting, exemplary embodiment.

As illustrated in FIGS. 9C to 9G, the overall shape of theft deterrent tag 100e has a tag body height 802 that progressively varies (or decreases) from unlock side 708 to lock side 706 for easier molding and manufacturing of tag 100e by eliminating the need for extended part 624 of housing assembly 214 of tags 100c and 100d, while retaining the same steep sloping gradient of the rail system of tags 100c and 100d. Further, in a fully closed and locked position, non-hinge side peripheral edges of cover assembly 106 of tag 100e are flush with non-hinge side peripheral edges of lock mechanism assembly 108. FIGS. 9H to 90 illustrate (using connecting broken lines) various contacting surfaces of the non-hinge side peripheral edges of cover assembly 106 and lock mechanism assembly 108 when tag 100e is fully closed and locked to thereby block and protect internal rail system from the reach of prying tools.

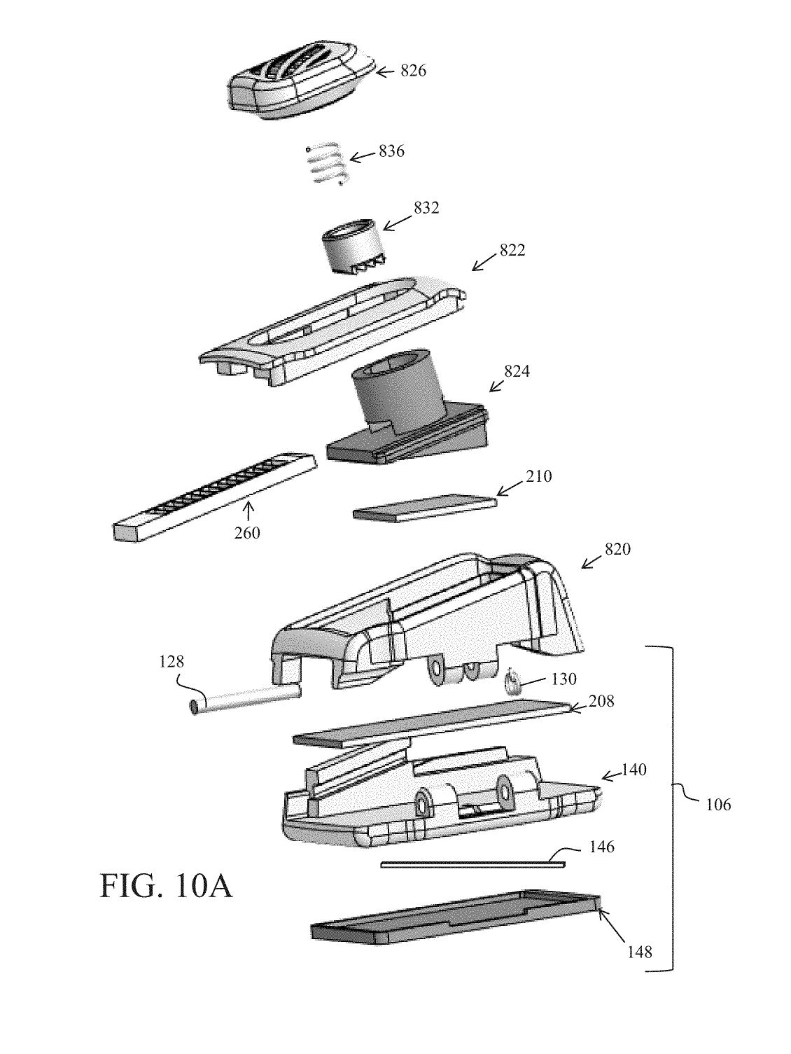

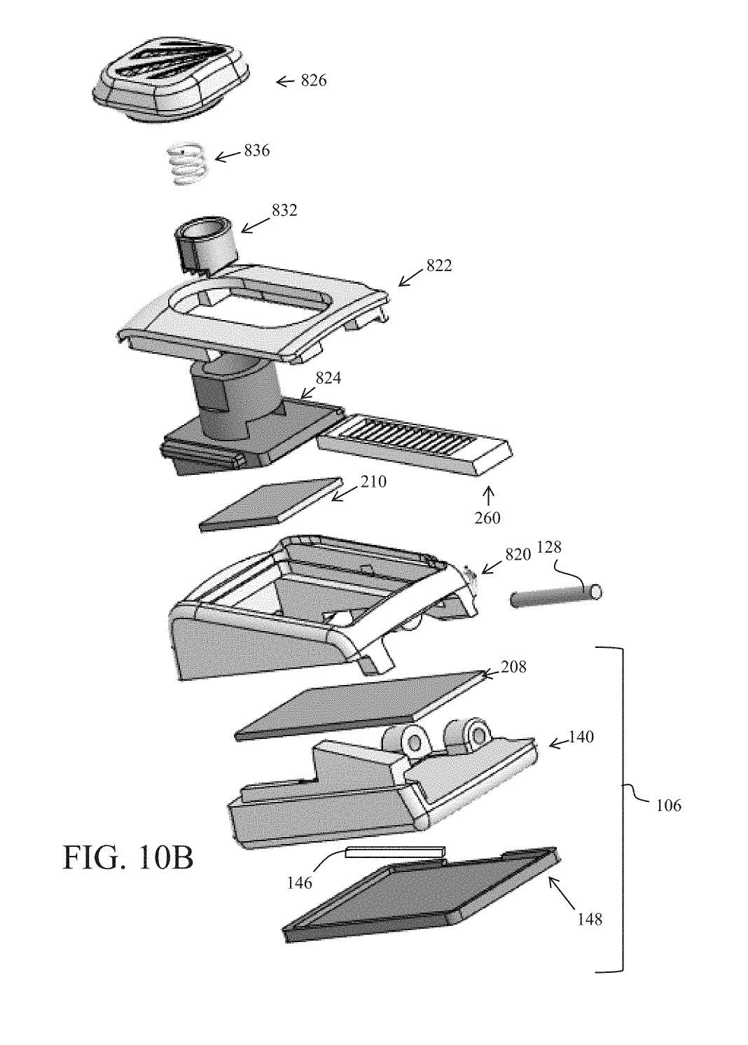

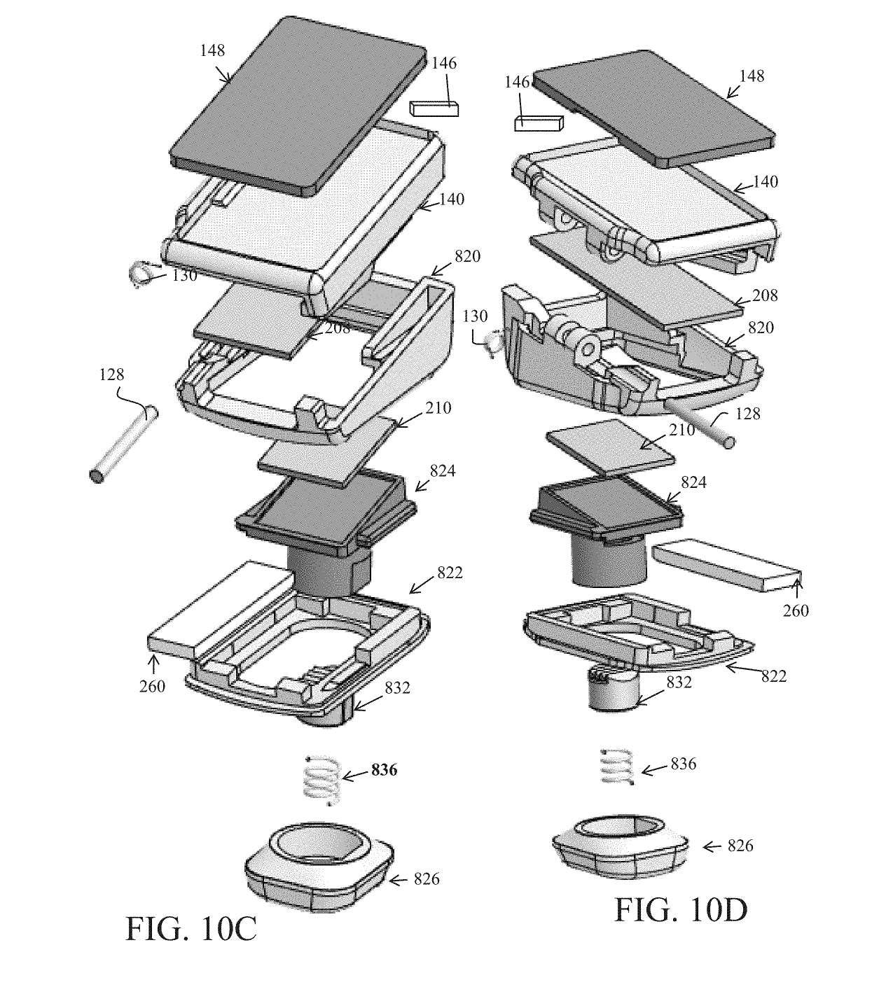

FIGS. 10A to 10D are non-limiting, exemplary illustrations of the isometric exploded views of the theft-deterrent tag 100e in accordance with one or more embodiments of the present invention. The exploded views shown in FIGS. 10A to 10D illustrate disassembled, separated components that show the cooperative working relationship, orientation, positioning, and an exemplary manner of assembly of the various components of theft deterrent tag 100e in accordance with one or more embodiments of the present invention.

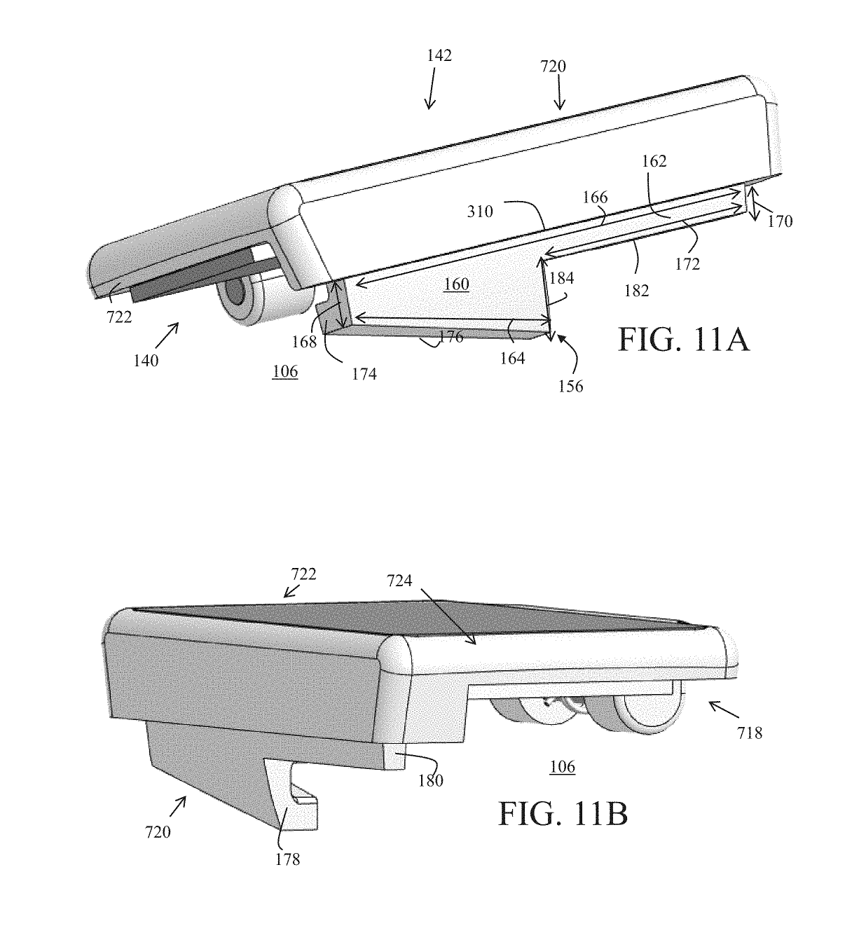

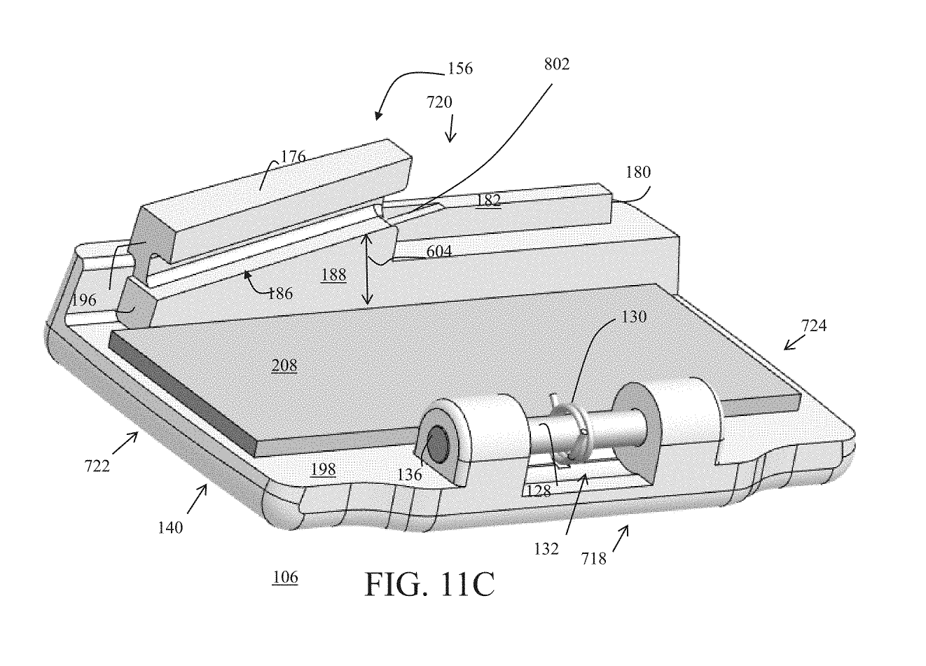

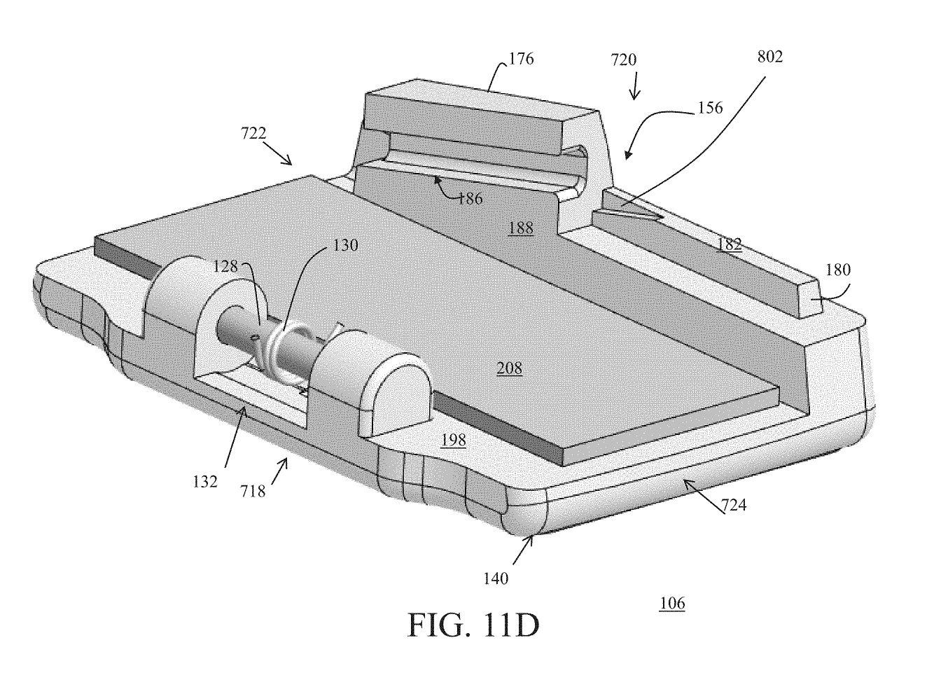

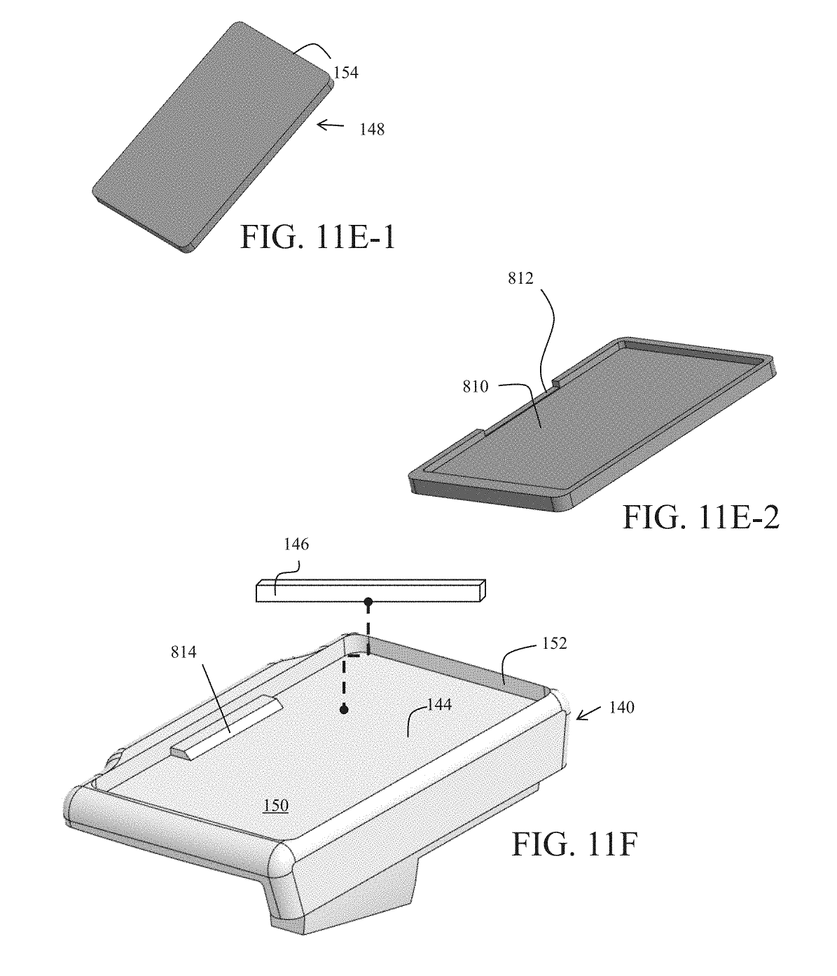

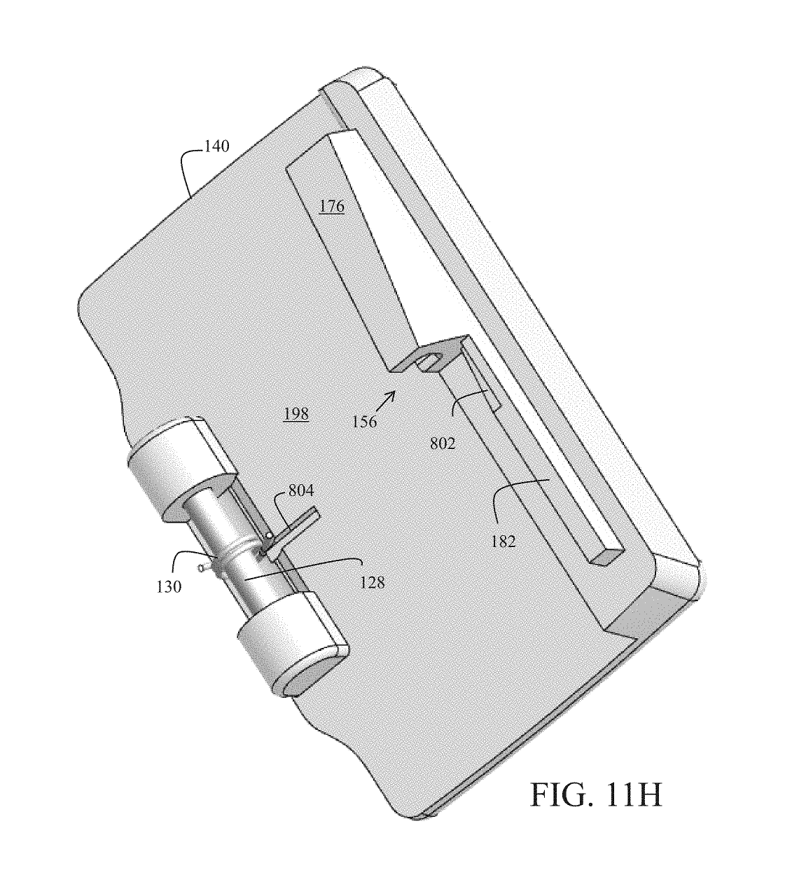

FIGS. 11A to 11H are non-limiting, exemplary illustrations of the various views of the cover assembly of tag 100e in accordance with one or more embodiments of the present invention. As illustrated, cover assembly 106 of tag 100e is comprised of a first (or hinge) side 718, a second or interlocking side 720, lock side 722, and unlock side 724, corresponding to first side 112, second side 158, lock side 706, and unlock side 708 of tag 100e, the same as tag 100d.

Cover assembly 106 of tag 100e further includes a first relief 802 that receives a corner portion 806 of rail structural support 816 of first set of support guide rails 224 when cover assembly 106 is closed and locked with lock mechanism assembly 108. First Relief 802 is part of interior portion of wall 182 of cover assembly 106.

As best illustrated in FIGS. 11E-1 to 11F, cover assembly 106 is comprised of a lid 140 that has a top side (i.e., the exterior facing side) 142 that includes a compartment 144, with one or more electronic modules (e.g., EAS, RFID, etc.) 146 that are housed within compartment 144. Cover assembly 106 further includes a cover 148 that covers over compartment 144 for protecting one or more electronic modules 146 so that the electronic modules 146 are not exposed and are hidden. In this non-limiting, exemplary embodiment, cover 148 of tag 100e includes a notch portion 812 at interior facing side 810 that mates (e.g., snaps) with a protruded portion 814 for securing one or more electronics modules 146. Cover assembly 106 of tag 100e further includes a second relief 804 (FIG. 11G) for receiving one end of resilient member 130.

As shown in FIGS. 11A to 11D and 11H, set of interlocking guide rails 186 of tag 100e provide the same functionality and operations as tags 100a, 100b, 100c, and 100d, but is comprised of groove or channel recessed within interior facing side 188 of interlocking portion 160 of engagement-wall 156 instead of two protruding parallel engagement bars for easier molding and manufacturing of tag 100e.

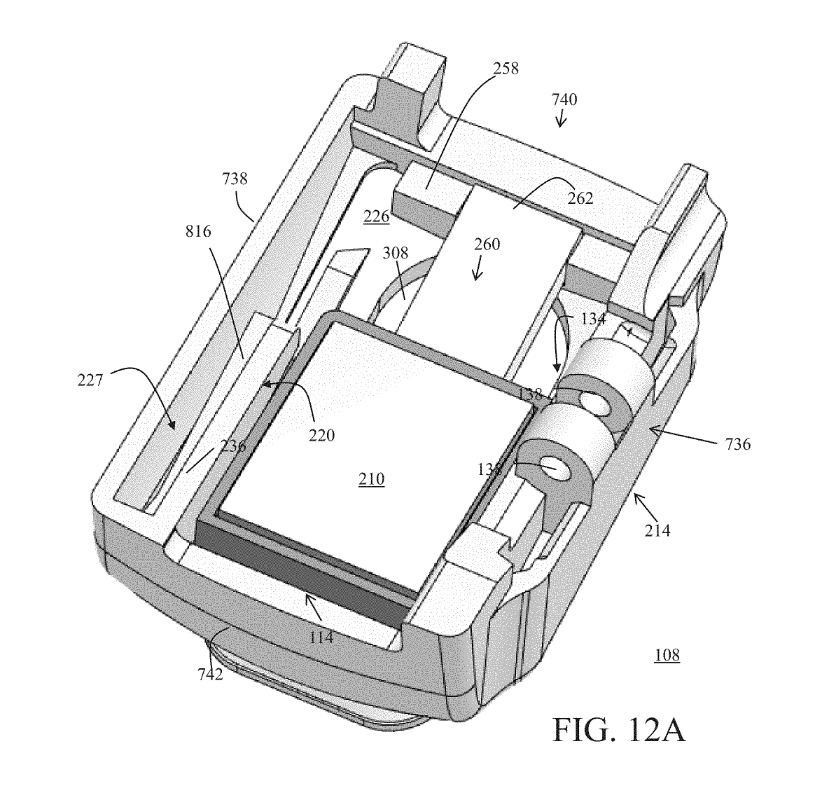

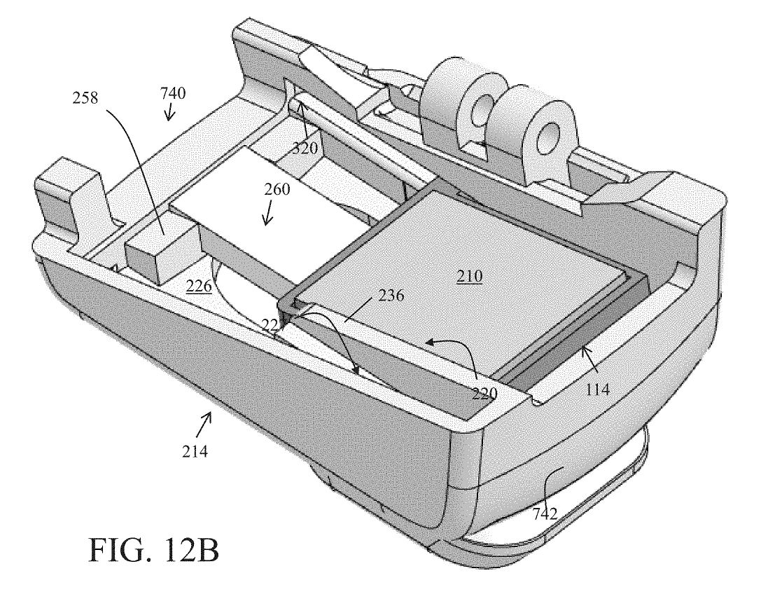

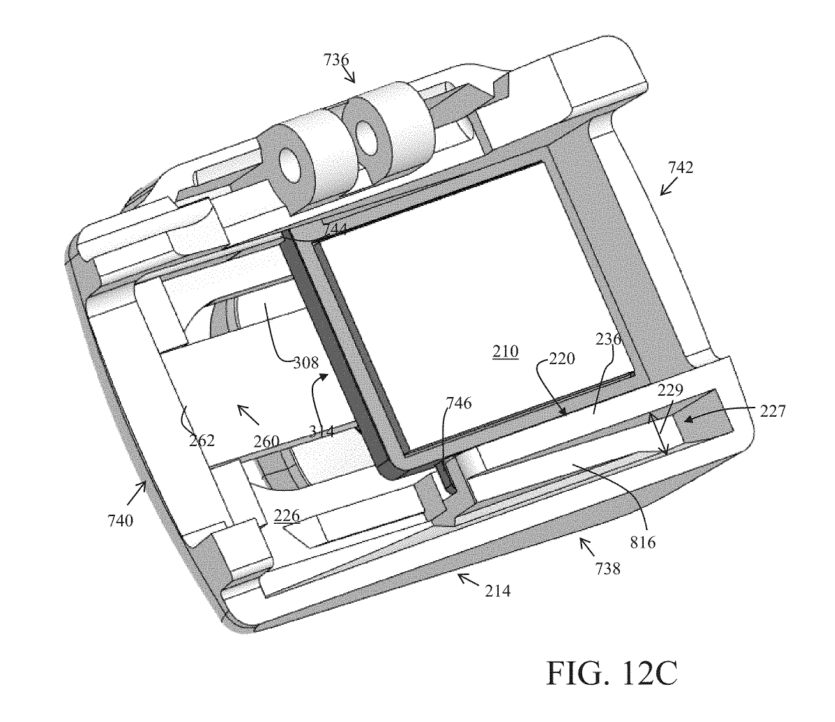

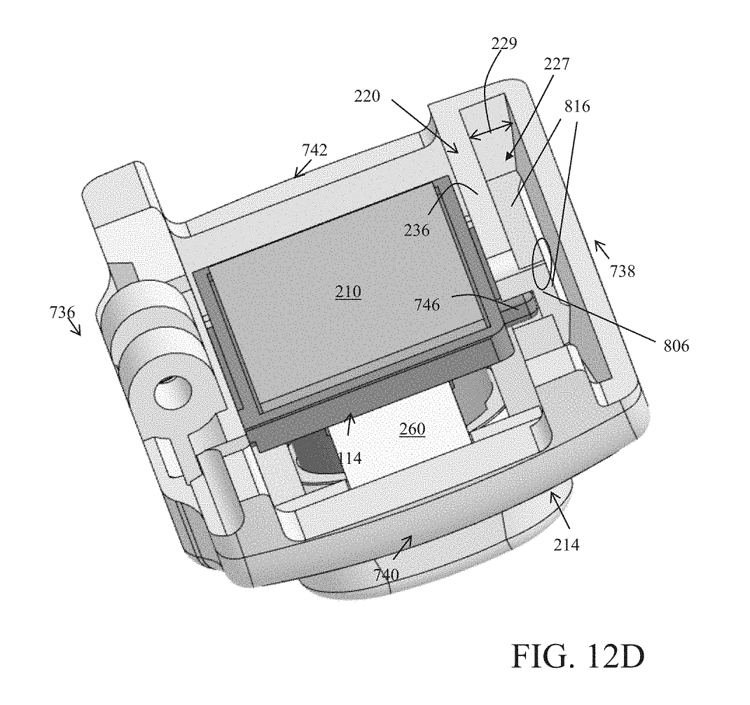

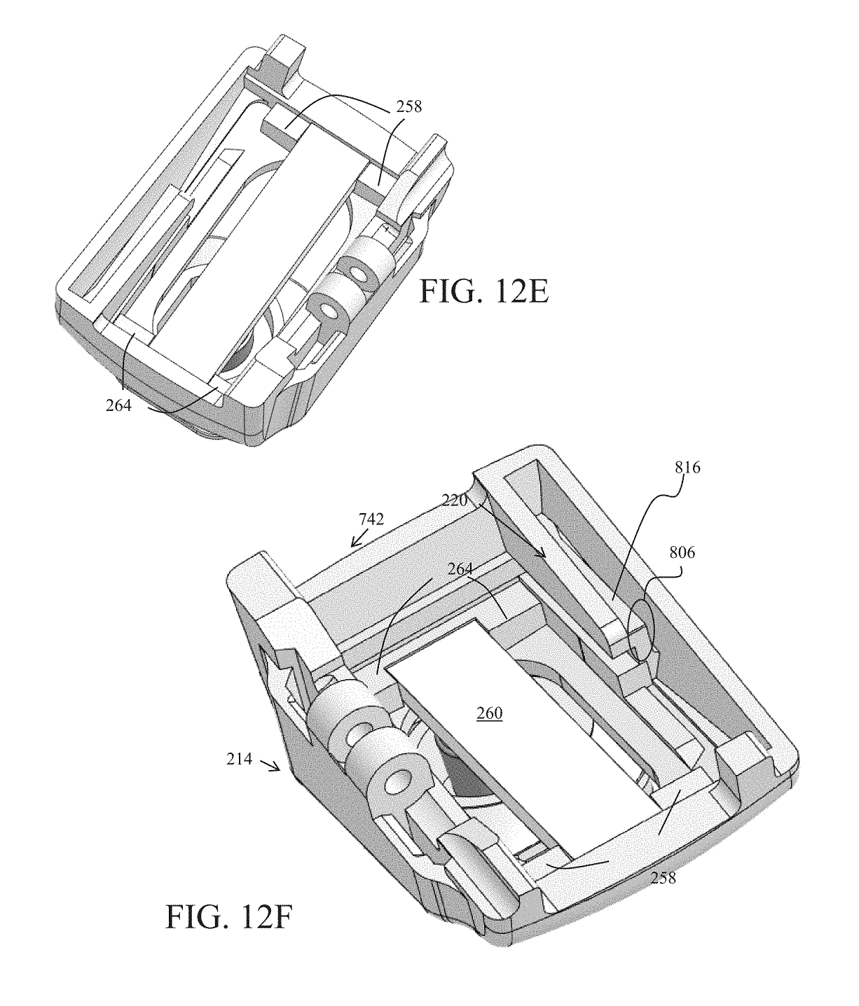

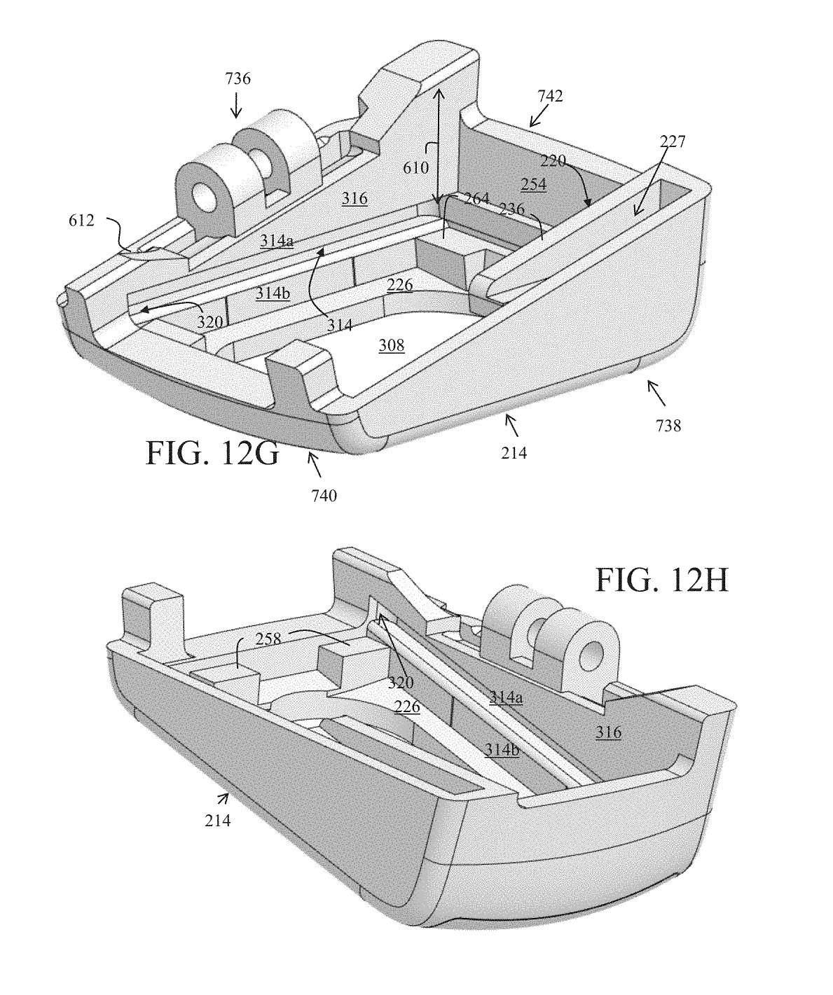

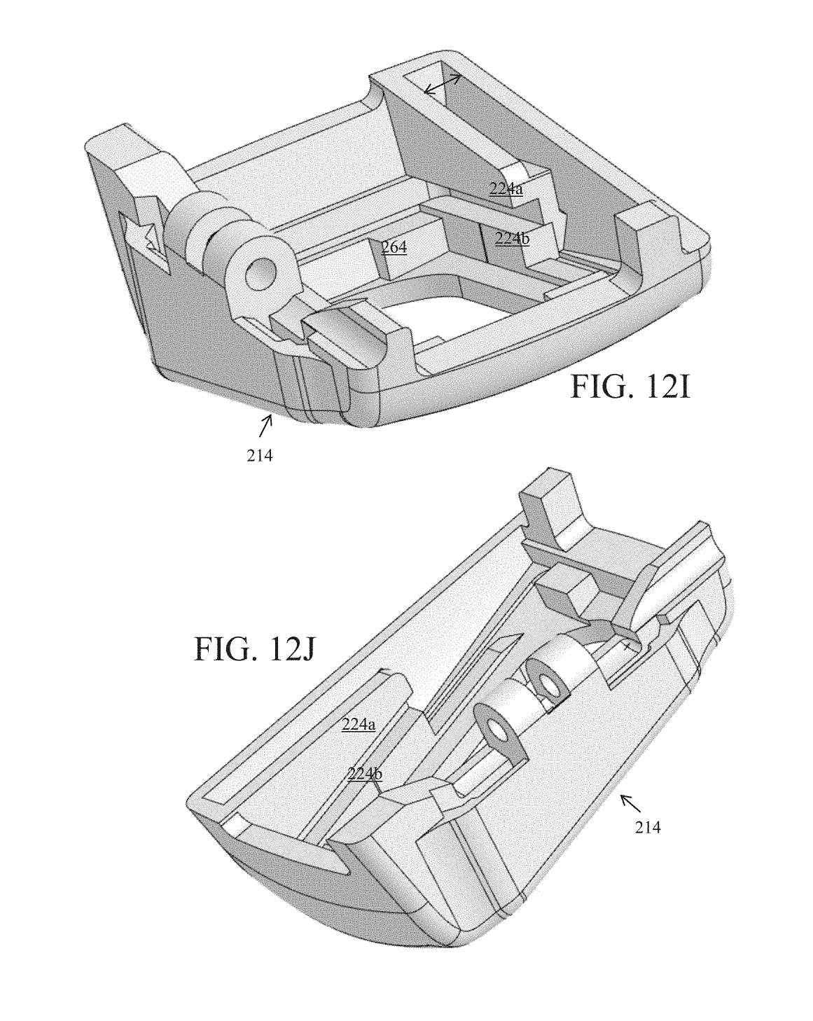

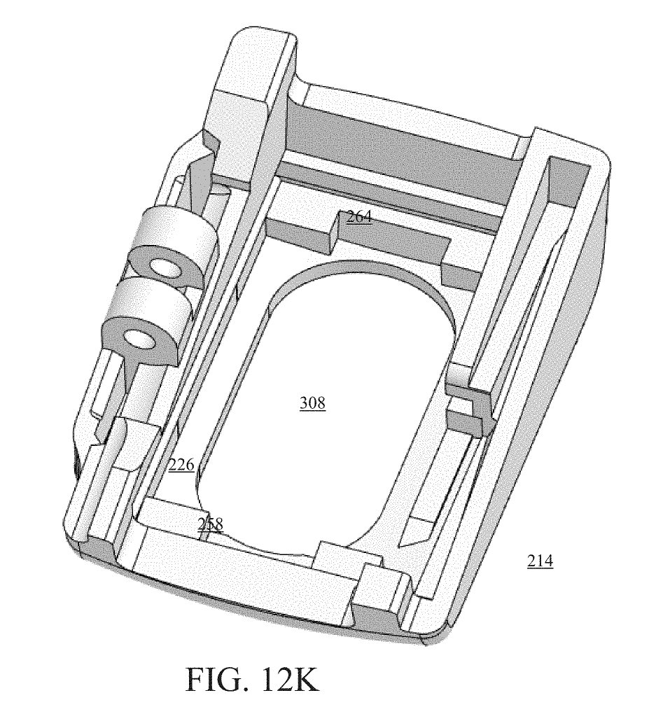

FIGS. 12A to 12K are non-limiting, exemplary illustrations of the various views of lock mechanism assembly of tag 100e in accordance with one or more embodiments of the present invention. In this non-limiting exemplary embodiment, first set of support guide rails 224 include rail structural support 816 within defined space 227 that runs parallel to sloping rail 224, improving structural integrity of rail 224 by increasing its strength through added bulk of rail structural support 816.

In this embodiment, flanges 620 and 622 of second piece 218 of housing assembly 214 of previously disclosed tags 100c and 100d are part of the first piece 820 of housing assembly 214 of tag 100e. In fact, for ease of molding, manufacturing, and assembly, housing assembly 214 of tag 100e is comprised of different set of first piece 820 and second piece 822 (detailed below).

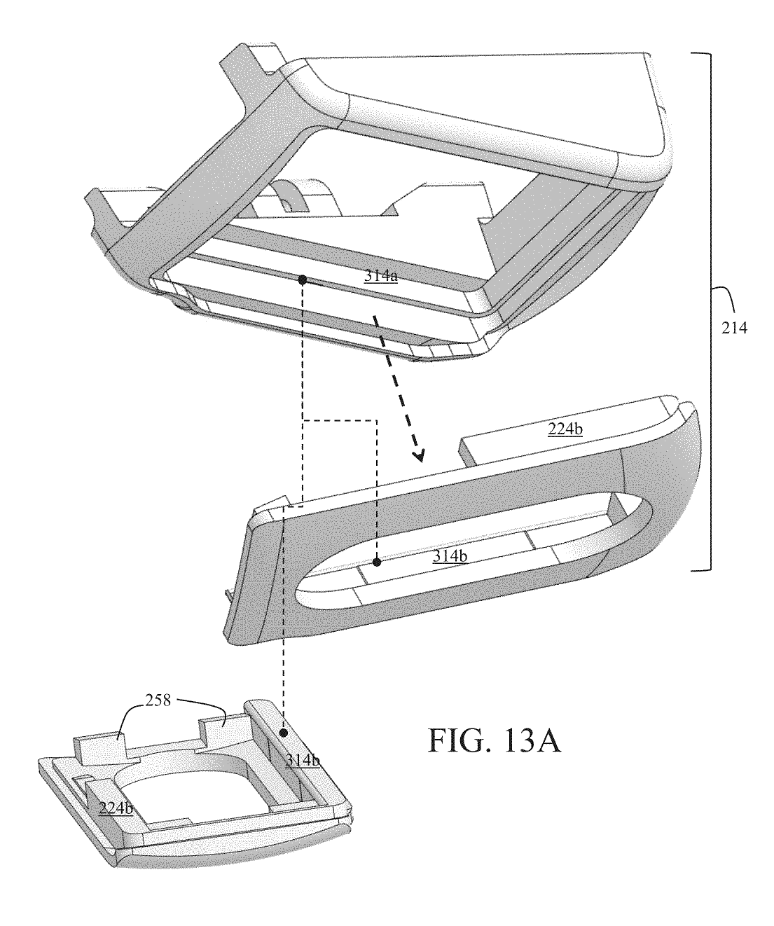

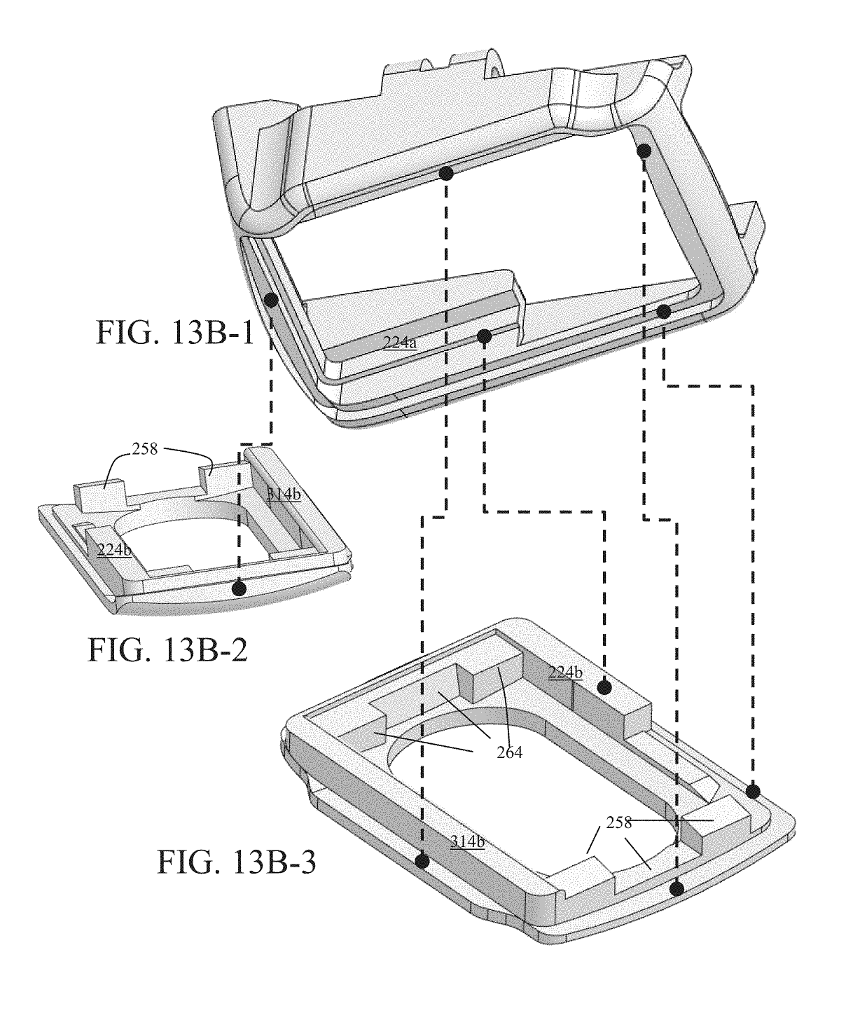

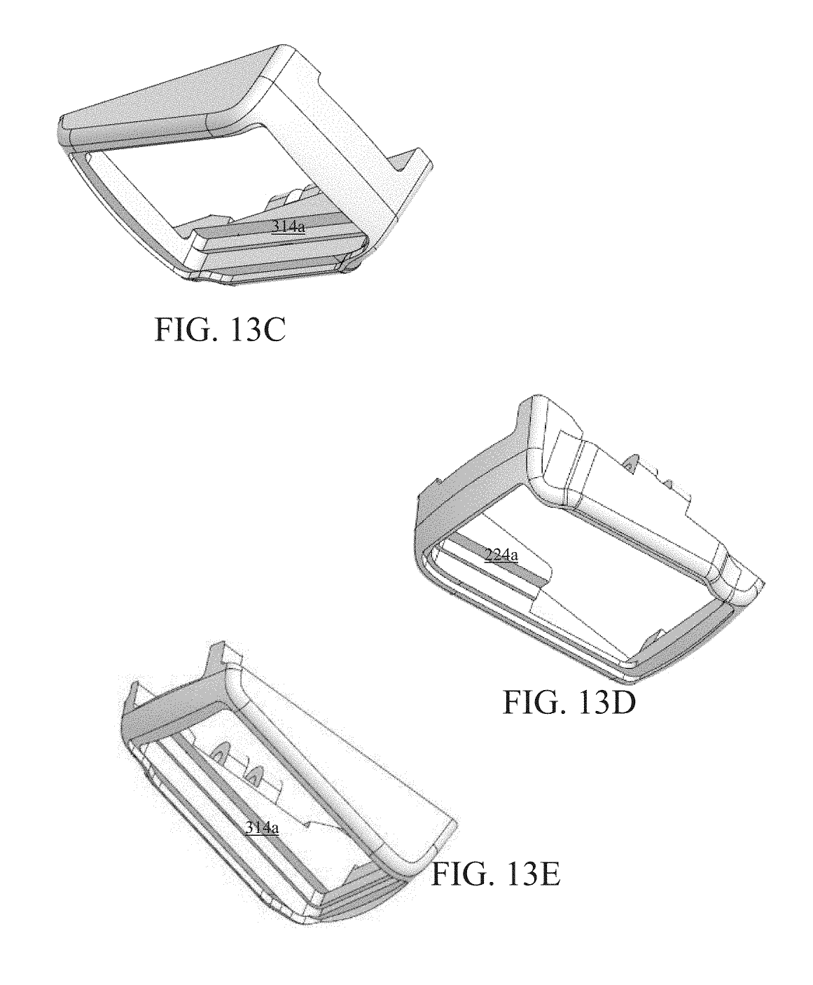

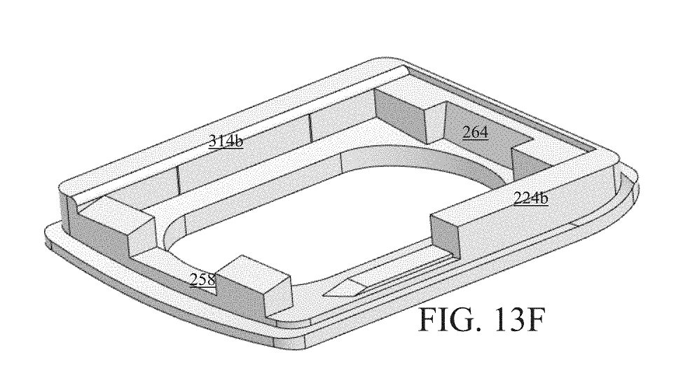

In the non-limiting exemplary embodiment illustrated in FIG. 12G and 12H, higher elevation end 320 of second set of support guide rails 314 are molded internal to within the first piece 820, while both first support structure 258 and second support structure 264 are molded as part of second piece 822 (FIGS. 13F to 13H). FIGS. 13A to 13B-3 illustrate (using connecting broken lines) various contacting surfaces of first piece 820 and second piece 822 of housing assembly 214 when connected (e.g., sonic welded). Both first set of support guide rails 224 and second set of support guide rails 314 are comprised of two longitudinally extending divided (or half) pieces 224a/224b and 314a/314b positioned between first piece 820 and second piece 822 of housing assembly 214 (best shown in FIGS. 13A and 13B by connecting broken lines).

FIGS. 13C to 13E are non-limiting, exemplary illustrations of the various views of first piece 820 of housing assembly while FIG. 13A to 13-B3 and 13F are views of second piece 822 thereof in accordance with one or more embodiments of the present invention. As illustrated, opening 308 and base 226 of tag 100e form parts of second piece 822.

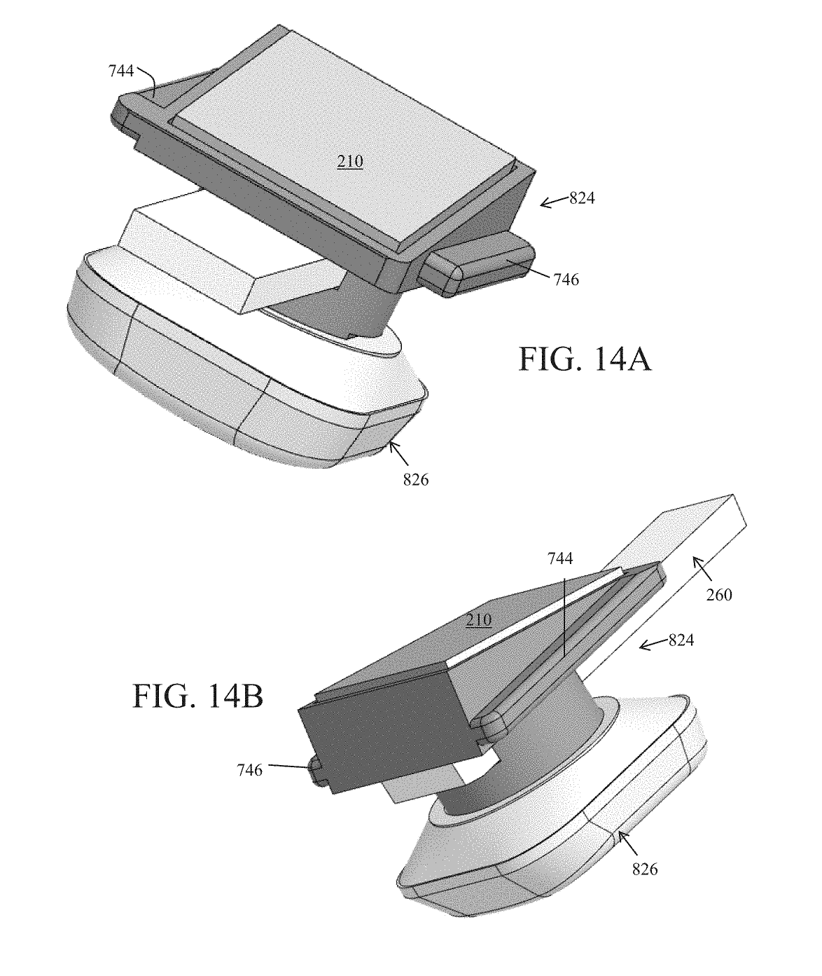

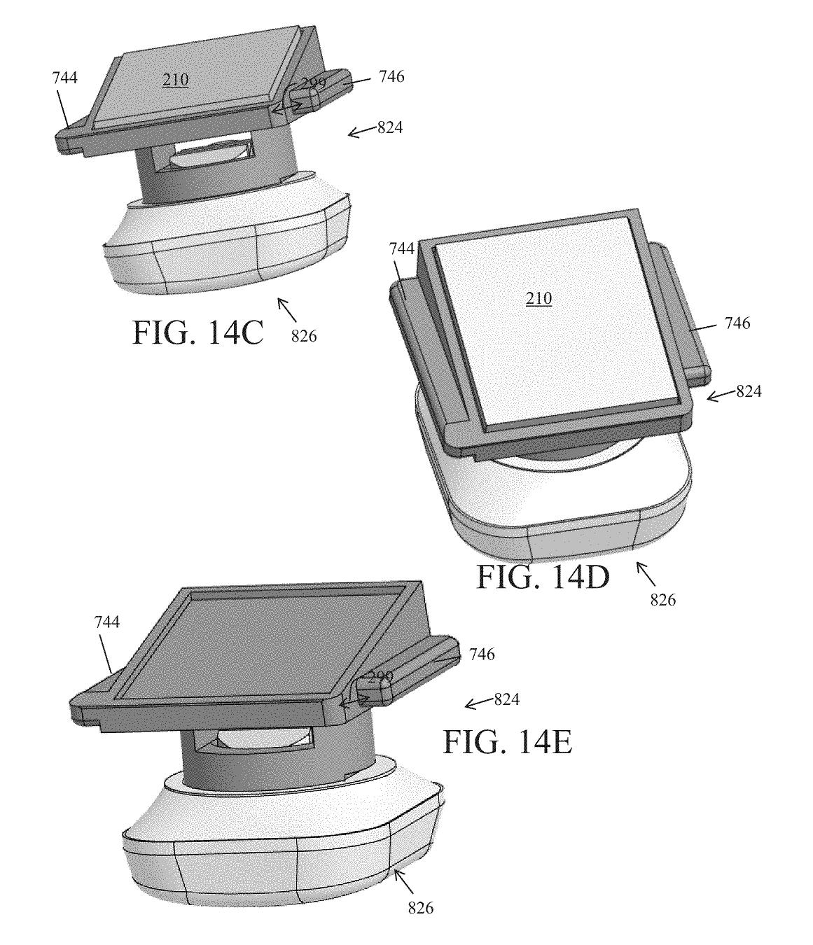

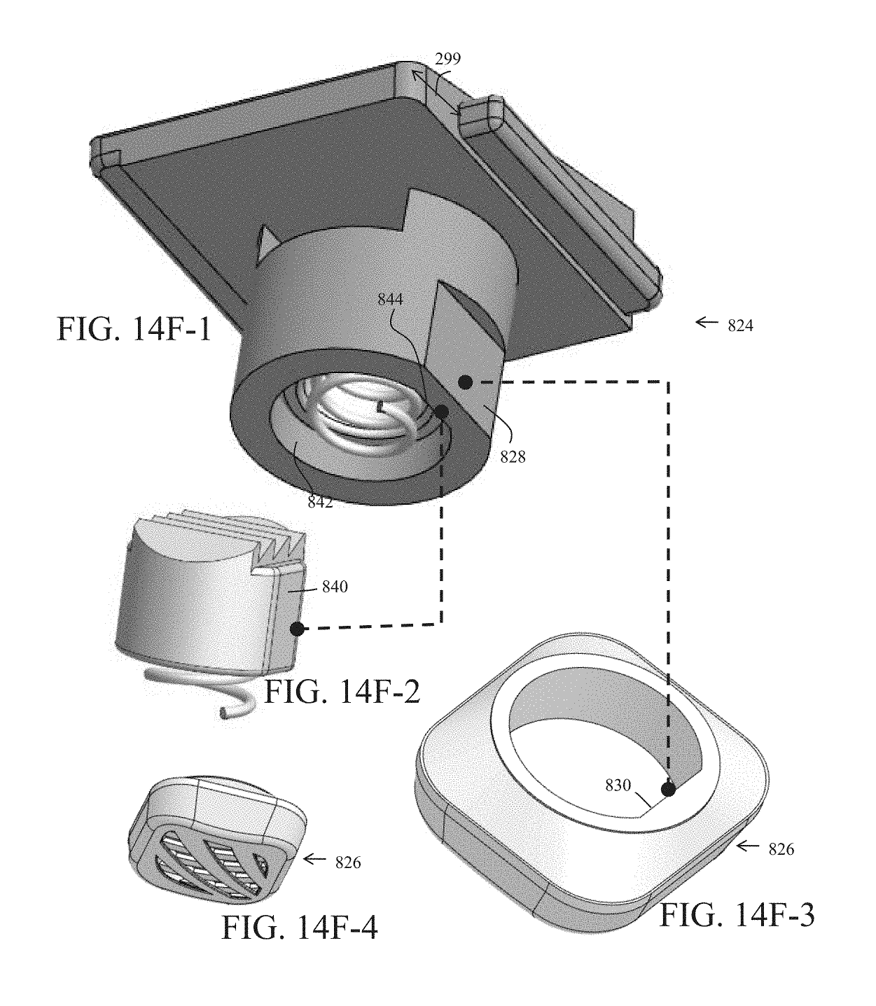

FIGS. 14A to 16E are non-limiting, exemplary illustrations of the various views of lock assembly and slider mechanism in accordance with one or more embodiments of the present invention. In this non-limiting exemplary embodiment, slider mechanism 114 of tag 100e is comprised of main piece 824 and a tactile piece or button 826 (for moving slider mechanism 114) with respective indexed features 828 and 830 for proper assembly and manufacturing.

As further illustrated, interlock clip 268 of previous embodiments is replaced with engagement member 832 comprised of metal that is influenced by a magnetic force from a well known detacher (not shown) to disengage serrations 834 of engagement member 832 from engagement elements 270 of lock member 260. Engagement member 832 is secured and biased to engagement position by a resilient member such as spring 836 within cavity 838 of engagement member 832 whereby serrations 834 faces serrations (or engagement elements) 270 of lock member 260. Engagement member 832 is also indexed 840 for proper assembly within opening 842 of main piece 824, matching index 844 of opening 842.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, inside, outside, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction, orientation, or position. Instead, they are used to reflect relative locations/positions and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A theft-deterrent tag, comprising:
a cover assembly that is mechanically moved from open, unlocked position to a closed position in relation to a lock mechanism assembly without use of tools, with the cover assembly locked with the lock mechanism assembly at an adjustable holding force.

2. The theft-deterrent tag as set forth in claim 1, wherein:
the cover assembly is locked with the lock mechanism assembly at the closed position when the lock assembly is moved from an unlock position to a lock position of a desired holding force.

3. The theft-deterrent tag as set forth in claim 2, wherein:
the desired holding force places a generally commensurate holding pressure on an article positioned in between the cover assembly and the lock mechanism assembly.

4. The theft-deterrent tag as set forth in claim 3, wherein:
a forced removal of the article from the theft deterrent tag moves lock assembly further towards a lock position of a greater holding force, which, in turn, places a generally commensurate greater holding pressure on the article positioned in between the cover assembly and the lock mechanism assembly.

5. The theft-deterrent tag as set forth in claim 3, wherein:
the holding force and the generally corresponding holding pressure increase as the lock assembly is continuously moved from the unlock position to the lock position.

6. The theft-deterrent tag as set forth in claim 3, wherein:
the holding force is maintained and is increased as the lock assembly is continuously moved in one direction from the unlock position to the lock position, with the holding force released by a key.

7. The theft-deterrent tag as set forth in claim 1, wherein:
the cover assembly is locked with the lock mechanism assembly at the closed position when the lock assembly is moved in a first direction from an unlock position to a lock position of the selected holding force, but cannot be moved back in a second direction, opposite the first direction.

8. The theft-deterrent tag as set forth in claim 1, wherein:
the holding force is released by a key, freeing the lock assembly to move in a second direction, from lock position to unlock position.

9. The theft-deterrent tag as set forth in claim 1, further comprising:
a benefit denial mechanism.

10. The theft deterrent tag as set forth in claim 1, wherein:
the cover assembly is mechanically unlocked from the lock mechanism assembly using a key.

11. The theft deterrent tag as set forth in claim 1, wherein:
the cover assembly is engaged with the lock mechanism assembly at a first side at open, closed, and locked positions.

12. The theft deterrent tag as set forth in claim 11, wherein:
the cover assembly is comprised of:
a lid that has a top side that includes a compartment;
one or more electronic modules that are housed within the compartment; and
a cover that covers over the compartment for protecting the one or more electronic modules.

13. The theft deterrent tag as set forth in claim 12, wherein:
the compartment is comprised of:
a recessed base surrounded by protruded periphery that extends perpendicular from the recessed base;
the protruded periphery define a continuous flange along a periphery of the top side of the lid, delimiting a perimeter of the recessed base.

14. The theft deterrent tag as set forth in claim 13, wherein:
periphery edges of the cover engage the protruded periphery of the top side of the lid.

15. The theft deterrent tag as set forth in claim 15, wherein:
the engagement-wall extends generally perpendicular from a second side of the lid of the cover assembly.

16. The theft deterrent tag as set forth in claim 16, wherein:
the engagement-wall is comprised:
a interlocking portion and a covering portion.

17. The theft deterrent tag as set forth in claim 16, wherein:
the interlocking portion has a first set of parallel engagement bars for locking the cover assembly with lock mechanism assembly.

18. The theft deterrent tag as set forth in claim 17, wherein:
the first set of parallel engagement bars are positioned on an interior facing side of the interlocking portion of the engagement-wall.

19. The theft deterrent tag as set forth in claim 18, wherein:
the first set of parallel engagement bars define a set of interlocking guide rails that are sloped at an angle, with a first end of the interlocking guide rails from an unlock end of the theft deterrent tag is at a lower elevation and a second end of the interlocking guide rails near the lock end of the theft deterrent tag is at a higher elevation.

20. The theft deterrent tag as set forth in claim 1, further comprising:
a benefit-denial mechanism that is positioned between cover assembly and lock mechanism assembly.

21. The theft deterrent tag as set forth in claim 1, wherein:
a benefit-denial mechanism is positioned at least on cover assembly.

22. The theft deterrent tag as set forth in claim 20, wherein:
the benefit-denial mechanism includes:
a set of protuberances with sharp edges collectively forming a serrated platform that damages the article if article is forcefully removed from the theft-deterrent tag.

23. The theft deterrent tag as set forth in claim 22, further comprising:
a first and a second protective member associated with respective cover assembly and lock mechanism assembly.

24. The theft deterrent tag as set forth in claim 23, wherein
the first protective member includes a piercing portion wherein added force to remove the article from the theft deterrent tag pushes serrated platform, penetrating and puncturing through piercing portion to thereby physically contact the article.

25. The theft deterrent tag as set forth in claim 11, wherein:
the cover assembly is engaged with the lock mechanism assembly at the first side at open, closed, and locked positions by a hinge mechanism.

26. The theft deterrent tag as set forth in claim 25, wherein:
the hinge mechanism is comprised of a pin and a resilient member associated with conver assembly hinge structure and lock mechanism hinge structure.

27. The theft deterrent tag as set forth in claim 25, wherein:
the resilient member is in a form of a torsion spring that biases the cover assembly to the open position.

28. The theft deterrent tag as set forth in claim 25, wherein:
the pin of the hinge mechanism is inserted into openings that define conver assembly hinge structure and lock mechanism hinge structure.

29. The theft deterrent tag as set forth in claim 1, wherein:
the lock mechanism assembly is comprised of a housing assembly that houses the lock assembly.

30. The theft deterrent tag as set forth in claim 29, wherein:
the housing assembly is comprised of:
a first piece and a second piece, with the first piece having:
a support structure within the first piece near an unlock end of the theft deterrent tag, near a second side of the theft-deterrent tag.

31. The theft deterrent tag as set forth in claim 30, wherein:
an interior facing side of the support structure includes a second set of parallel engagement bars for supporting a lock assembly.

32. The theft deterrent tag as set forth in claim 31, wherein:
the second set of parallel engagement bars define a first set of support guide rails that are sloped at an angle, with a first end of the support guide rails from the unlock end of the theft deterrent tag at a lower elevation and a second end of the support guide rails towards a lock end of the theft deterrent tag at a higher elevation.

33. The theft deterrent tag as set forth in claim 32, wherein:
a top periphery of the support structure engages a corner cut-out portion of the engagement-wall of the first member.

34. The theft deterrent tag as set forth in claim 18, wherein:
set of interlocking guide rails align with a first set of support guide rails of support structure form a continuous, upward sloping guide rail from an unlock end to a lock end of the theft deterrent tag at the second side of the theft-deterrent tag.

35. The theft deterrent tag as set forth in claim 10, wherein:
the housing assembly further includes a third set of parallel engagement bars defining a second set of support guide rails associated with an interior facing side of a first side wall of first piece of the housing assembly.

36. The theft deterrent tag as set forth in claim 10, wherein:
the second set of support guide rails are oriented parallel the first set of supporting guide rails and the interlocking guide rails.

37. The theft deterrent tag as set forth in claim 10, wherein:
the second set of support guide rails, the first set of supporting guide rails, and the interlocking guide rails define a guide rail system comprised of two sided guide rails that enable the lock assembly to slide along a linear reciprocating path between guide rails from unlock end to lock end.

38. The theft deterrent tag as set forth in claim 10, wherein:
an interior facing side of the second piece of the housing assembly includes a support structure projecting from the interior facing side that supports to hold a first distal end of a lock member of the lock assembly.

39. The theft deterrent tag as set forth in claim 10, wherein:
the lock assembly is comprised of:
a lock member;
a slider mechanism; and
a lock mechanism.

40. The theft deterrent tag as set forth in claim 10, wherein:
a lock member of the lock assembly is comprised of a set of serrations.

41. The theft deterrent tag as set forth in claim 10, wherein:
the second piece is sonic welded to the first piece to form the housing assembly.

42. The theft deterrent tag as set forth in claim 10, wherein:
the soft member is for protection and is sloped at an angle at an inverse to the slope of the railing, wherein the higher elevation is oriented at the unlock end and lower elevation (thinner part) is at locking end, which provides a flat top surface from unlock to lock end when mounted on housing assembly. This way, the temple of the eyewear lies flat.

43. The theft deterrent tag as set forth in claim 10, wherein:
the slider mechanism of the lock assembly includes:
a passage-opening that accommodates the lock member and enables the slider mechanism to slide along the lock member from the unlock end to lock end of the theft deterrent tag.

44. The theft deterrent tag as set forth in claim 10, wherein:
the slider mechanism further includes:
a compartment within the passage-opening that houses the lock mechanism that engages with serrations of the lock member.

45. The theft deterrent tag as set forth in claim 10, further comprising:
the slider mechanism is further comprised of:
a rail engagement portion that engage with the guide rail system of the theft deterrent tag by lateral flanges that protrude from a body of the rail engagement portion and extend longitudinally; and
a knob, a portion of which extends out of an opening of the first piece of the housing assembly for moving the slider mechanism.

46. The theft deterrent tag as set forth in claim 10, wherein:
the rail engagement portion is sloped at first angle, and a free end of the knob is sloped at a second angle.
